(19) United States
(12) Patent Application Publication
(10) Pub. No.: US 2005/0102173 A1
(43) Pub. Date: May 12, 2005

(54) Method and system for managing regulatory information

(76) Inventors: Lauren Nicole Barker, Decatur, IL (US); Michelle Lee Bublitz, Decatur, IL (US); Staci Lynn Bogue-Buchholz, Decatur, IL (US); Dean Michael Frommelt, Decatur, IL (US); Steven D. Khuu, Forsyth, IL (US); Patrick J. Langa, Springfield, IL (US); Bruce Allen Logan, Decatur, IL (US); Gregory Dale Michael, Decatur, IL (US)

Correspondence Address: STERNE, KESSLER, GOLDSTEIN & FOX PLLC, 1100 NEW YORK AVENUE, N.W., WASHINGTON, DC, 20005, US

(21) Appl. No.: 10/893,577

(22) Filed: Jul. 19, 2004

Related U.S. Application Data
(60) Provisional application No. 60/487,978, filed on Jul. 18, 2003.

(51) Int. Cl. G06F 17/60

(52) U.S. Cl. 705/8

(57) ABSTRACT

The present invention provides a method and system for managing regulatory information. In an embodiment, a regulatory information management system includes a facilities compliance manager and a permit manager. The facilities compliance manager enables a main screen to be displayed at the client. The main screen allows a user to manage the facility data stored in the database to ensure compliance of the facility with federal and state regulations including air, water, and waste regulations and associated permits. Menus and icons are provided for accessing Facility, Materials, Air, Waste, and Water management screens. The regulatory information management system can also include a message generator, a formula calculator, a regulatory form generator, and an environmental tool integrator.

### CROSS-REFERENCE TO RELATED APPLICATIONS

This application claims priority to U.S. Provisional Application No. 60/487,978, filed Jul. 18, 2003, titled “Method and System for Managing Regulatory Information,” incorporated herein by reference in its entirety.

### BACKGROUND OF THE INVENTION

1. Field of the Invention

The present invention relates to facility management and regulatory compliance.

2. Related Art

Operation of facilities requires compliance with in-house guidelines and/or regulations. Facilities, such as grain processing facilities, often must apply for and renew a variety of permits such as air permits, water permits and waste permits. Properly filling out such permits or completing required reports accurately can require the collection and management of large volumes of information at a facility. Because in-house guidelines and regulations can vary in different locations, the complexity of data management and collection increases when multiple facilities are involved over a large geographic area.

Attempts have been made to automate data collection and management. One example of an integrated approach for hazardous substance tracking and compliance uses a central relational database. See, U.S. Pat. No. 5,726,884 issued to Sturgeon.

### SUMMARY OF THE INVENTION

The present invention provides a method and system for managing regulatory information. In an embodiment, a regulatory information management system includes a facilities compliance manager and a permit manager. The regulatory information management system is coupled to a database. Clients can access the regulatory information management system over a network. The facilities compliance manager enables a main screen to be displayed at the client. The main screen allows a user to manage the facility data stored in the database. In particular, a user can manage the facility data to ensure compliance of the facility with federal and state regulations including air, water, and waste regulations and associated permits. In an embodiment, the main screen includes menus and icons for accessing Facility, Materials, Air, Waste, and Water management screens.

A permit manager enables a user to configure permit data parameters and input permit data for storage in the database accordingly. In one example, the permit manager provides a set of local templates to the user associated with a location of a facility to facilitate compliance with federal and state regulations governing the facility. A user can configure permit data parameters including setting limits for different types of permits at a facility, such as, air permits, water permits and/or waste permits. The permit manager also monitors permit events based on stored permit data for a facility, and generates permit event notifications relating to compliance with federal and state regulations.

In an embodiment, the regulatory information management system further includes a message generator that sends messages identifying the generated permit event notifications. Permit event notifications can include notifications of when a facility has emissions outside of an acceptable range or when a permit is up for renewal or overdue. In one example, the message generator distributes electronic mail messages (e-mail) to different individuals depending upon the particular permit event notification. The permit event notifications can include notifications of when a permit is due, past due and overdue. The message generator then sends a first e-mail to a primary individual when the permit is due, a second e-mail to the primary individual and a back up individual when the permit is past due, and a third e-mail to the primary and back up individuals and a manager when the permit is over due. This ensures proper notification is timely made while also providing redundancy and accountability.

According to a further feature, an Air management screen enables a user to access a variety of associated screens. An equipment inventory section on the Air management screen allows a user to manage equipment inventory and potential (What If) equipment inventory. Air control tabs allow a user to manage compliance with federal and state regulations pertaining to air. In an embodiment, a set of air control tabs allow a user to manage air loss configuration data, air loss calculations, configuration history and what-if (WIF) scenarios with respect to different pieces of equipment.

A formula calculator calculates air loss according to formulas based on user inputs at one or more air loss calculation screens. A user can select standard or customized formulas. In an embodiment, a first section on an air loss calculation screen is for setting up a calculation period, applying rounding, and calculating totals by pollutant. A second section is for displaying totals by pollutant. A third section is for displaying air emissions data including EU-ID, Month, Pollutant Name, Throughput, Calculation Method, EF, CE and Emission data. An Air Throughputs screen enables a user to select to show actual, PTE or WIF throughputs, and to set a calculation period. The Air Throughputs screen also displays air throughput data including Month, Material name, Group Description, Start Inventory, End Inventory, Throughput, Mode, Ash, Sulfur, HV and Units. Additional screens accessible through the Air management screen are the Emission Point (EP) Edit, Monitoring Equipment (ME) Edit, Control Equipment (CE) Edit, and Emission Unit (EU) Edit screens.

In an embodiment, the regulatory management information system is coupled to process historian and lab information managers provided at nodes at different facilities. Each process historian and lab information manager is coupled to distributed control systems (DCSs) at a respective facility. The process historian and lab information manager captures data from each DCS at a facility and stores the captured data in a local database.

In an embodiment, the regulatory management information system further includes a regulatory form generator that provides a set of templates associated with regulatory forms, and in response to a user selection for a completed regulatory form for a facility, queries appropriate facility data based on a template, and builds a document representing the completed regulatory form. Forms can be automatically generated and the data made more accurate through the configuration of an appropriate template tailored to a facility location.

In an embodiment, the regulatory management information system further includes an environmental tool integrator that enables a user to navigate between facility data in the database and data in external regulatory databases. The external regulatory databases can include any environmental reporter databases available to the regulatory management information system. Such integrated access to external reporter databases allows a user to manage regulatory information more effectively. Specific state or federal regulations on air, water or waste can be looked up to configure permit data and set formula calculations.

Further features, advantages, and embodiments are described below.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention. In the drawings:

FIG. 1 is a diagram that shows a regulatory management information system in a networking environment according to one embodiment of the present invention.

FIG. 2 is a diagram that shows the regulatory management information system of FIG. 1 in further detail.

FIG. 3 is a diagram that shows integration of the regulatory management information system of FIG. 1 with other databases and systems according to an embodiment of the present invention.

FIGS. 4A-4C are flowchart diagrams. FIG. 4A illustrates a routine for managing facility compliance with federal and/or state regulations according to an embodiment of the present invention. FIG. 4B illustrates a routine for tracking permit data according to an embodiment of the present invention. FIG. 4C illustrates a routine for enabling a user to configure permit data parameters according to an embodiment of the present invention.

FIG. 5 is a flowchart diagram of a routine for managing formula calculations in a regulatory management information system according to an embodiment of the present invention.

FIG. 6 is a flowchart diagram of a routine for integrating facility process data in a regulatory management information system according to an embodiment of the present invention.

FIG. 7 is a flowchart diagram of a routine for automated form generation in a regulatory management information system according to an embodiment of the present invention.

FIG. 8 is a flowchart diagram of a routine for integrating environmental tools in a regulatory management information system according to an embodiment of the present invention.

FIG. 9 is an example of an RMIS initiation screen, and in particular an authentication screen.

FIG. 10 is an example of the main RMIS screen.

FIG. 11 is an example of a Facility Selection screen.

FIGS. 12A-C are examples of screens associated with Administration.

FIGS. 13A-J are examples of screens associated with Facility management. FIG. 13A is the Facility Setup screen and FIGS. 13B-J are screens accessed via the Facility Setup screen.

FIGS. 14A-F are also examples of screens associated with Facility management. FIG. 14A is the Action Item screen and FIGS. 14B-F are screens accessed via the Action Item screen.

FIGS. 15A-J are examples of screens associated with Material management. FIG. 15A is the Materials screen and FIGS. 15B-J are screens accessed via the Materials screen.

FIGS. 16A-W are also examples of screens associated with Material management. FIG. 16A is the Regulatory Materials screen and FIGS. 16B-W are screens accessed via the Regulatory Materials screen.

FIGS. 17A-U are examples of screens associated with Air management.

FIGS. 18A-E are examples of screens associated with Contact management.

FIGS. 19A-D are examples of screens associated with Permit management.

FIGS. 20A-E are examples of screens associated with Incident management.

FIGS. 21A-C are examples of screens associated with Agency Visits.

FIGS. 22A-M are examples of screens associated with Air management.

FIGS. 23A-D are examples of screens associated with Throughput management and calculation screen.

FIGS. 24A-B are flowchart diagrams. FIG. 24A illustrates a routine for air losses calculation according to an embodiment of the present invention. FIG. 24B illustrates a routine for determining methods of air losses calculations according to an embodiment of the present invention.

FIG. 25 is a flowchart diagram of a routine for air throughputs calculations according to an embodiment of the present invention.

FIG. 26 is an example air emission report generated by RMIS printing function.

FIGS. 27A-U are examples of screens associated with Waste management.

FIGS. 28A-T are also examples of screens associated with Waste management

The present invention will now be described with reference to the accompanying drawings. In the drawings, like reference numbers indicate identical or functionally similar elements. Additionally, the left-most digit(s) of a reference number generally identifies the drawing in which the reference number first appears.

### DETAILED DESCRIPTION OF THE INVENTION

The present invention is directed to a system and method for collecting and managing facility and regulatory compliance information. Numerous embodiments of the present invention are presented herein.

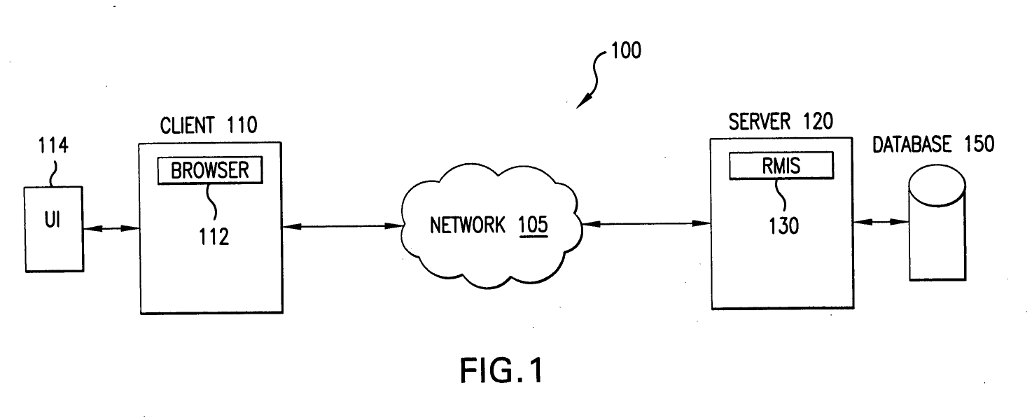

FIG. 1 is a diagram that shows a regulatory management information system 130 in the networking environment 100 according to an embodiment of the present invention. Environment 100 includes a client 110 coupled to a server 120 through network 105. Client 110 includes a browser 112 and user interface 114.

RMIS 130 allows users and administrators to manage regulatory information. In one embodiment, RMIS 130 is designed and developed to enable facilities to comply with federal state environmental regulations and/or in-house guidelines. RMIS 130 allows the user to manage facility data stored in the internal databases 270.

A user can use RMIS 130 to manage the facility data and ensure compliance of the facility with federal and state regulations including air, water, and waste regulations and associated permits. RMIS 130 provides series of screens to a user at user interface 114.

In an illustrative embodiment, regulatory management information system (RMIS) 130 is located at server 120. Server 120 is coupled to database 150. The environment depicted in FIG. 1 is illustrative and not intended to limit the present invention. Network 105 can be any type of communications network or combination of networks including but not limited to an intranet or the Internet. Client 110 can be any type of computing device including but not limited to a desktop computer, laptop computer, workstation, personal data assistance (PDA), a wireless phone or data device, or other electronic device capable of receiving and transmitting data. User interface 114 can be any type of user interface including but not limited to a graphical user interface made up of a display screen and mouse, keyboard, touch screen, voice recognition input device, or any other human interactive device. In one embodiment, client 110 includes a browser 112 for carrying out web based communications. For example, browser 112 can be an Internet Explorer, Netscape or other type of browser for displaying hypertext markup language (HTML) text and for supporting hypertext transport (HTTP) protocols or hypertext transport secure (HTTPS) protocols.

Server 120 can be any type of server. Server 120 can be software, firmware, hardware, or any combination thereof. In one implementation, RMIS network environment 100 is an environment according to a three tier architecture and RMIS 130 is a software application running on a server 120. In particular, RMIS 130 is implemented as an integrated WINDOWS based client server relational database application. For example, the three tier architecture can include a corporate module running in browser 112, an application server on server 120 that includes an application having RMIS 130, and a SQL database server for managing database 150. A distributed component object model (DCOM) can be used to integrate a Citrix client and application server. An objecting linking and imbedding database (OLEDB) can be used to couple the application server and SQL database server as would be apparent to a person skilled in the art given this description. This implementation is illustrative and not intended to limit the present invention. RMIS 130 can be implemented in other architectures as would be apparent to a person skilled in the art given this description.

Regulatory Management Information System

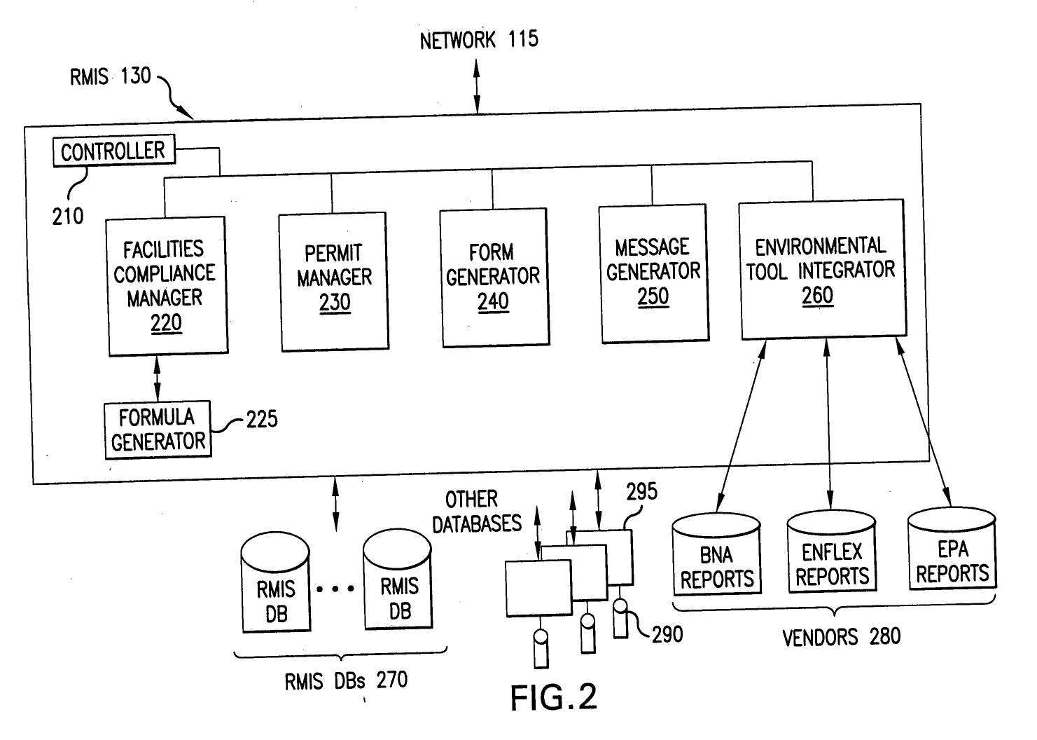

FIG. 2 is a diagram that shows RMIS 130 further detail. RMIS 130 includes a controller 210, facilities compliance manager 220, formula generator 225, permit manager 230, form generator 240, message generator 250, and environmental tool integrator 260. RMIS 130 is coupled between network 105 and internal databases RMIS DBs 270. RMIS 130 can also be coupled to other databases 290. RMIS 130 can also be coupled to external databases 280 such as those provided by vendors.

Controller 210 coordinates the control and operation of RMIS 130. In particular, controller 210 helps coordinate control and operation between RMIS 130 and clients 114, and the interoperation between the individual components 220, 230, 240, 250, 260, and 225 of RMIS 130.

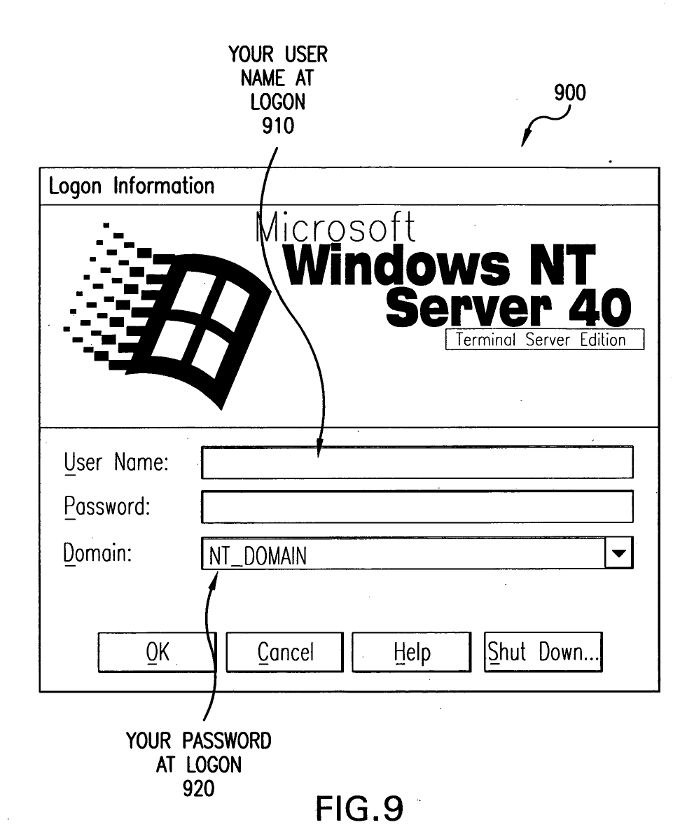

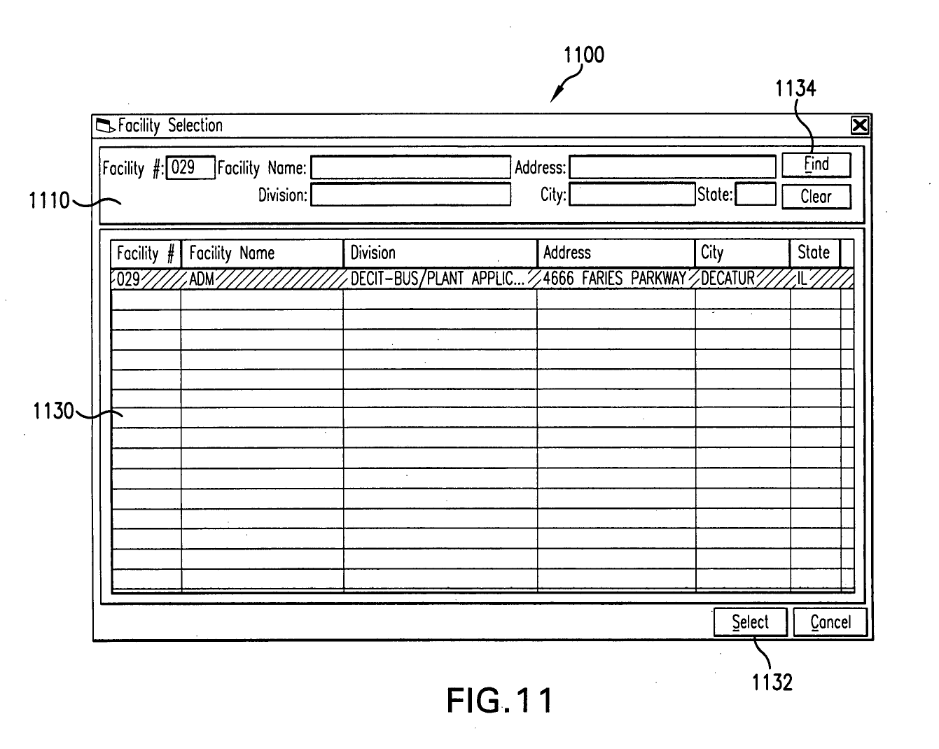

In an embodiment, facilities compliance manager 220 is responsible for providing data to enable browser 112 to display the appropriate screens. User can activate functions and link to other screens through user interface 114. The facilities compliance manager 220 delivers appropriate responses. A description of each of the screens generated by RMIS 130 and a particular facilities compliance manager 220, is provided in more detail below with respect to FIGS. 9-21.

Permit manager 230 enables a user to configure permit data parameters and input permit data for storage and database 270. In one example, permit manager 230 provides a set of local templates to a user associated with the location of the facility. A user can select an appropriate template to facilitate compliance with appropriate federal and state regulations governing a facility. User can configure permit data parameters including setting limits for different types of permits at a facility such as air permits, water permits and/or waste permits. Permit manager 230 also monitors permit events based on stored permit data for a facility. Permit manager 230 then generates permit event identifications related to compliance with federal and state regulations.

Message generator 250 sends messages identifying permit event notifications generated by permit manager 230. Such permit event notifications can include notifications that one of the facilities has emissions outside of an acceptable range or notifications when a permit is up for renewal or overdue. In one example, message generator 250 distributes e-mail to different individuals depending on the particular permit event notification. Different individuals are notified then when a permit is due, past due or overdue. In one embodiment, message generator 250 sends a first e-mail to a primary individual, such as an engineer, when the permit is due. A second e-mail is sent to the primary individual and a backup individual when the permit is past due. A third e-mail message is sent to the primary and backup individuals and a plant manager when the permit is overdue. In this way notifications are timely made, and redundancy and accountability are provided.

Form generator 240 provides a set of templates associated with regulatory forms. In response to a user selection for a completed regulatory form for a facility, form generator 240 queries appropriate facility data and RMIS databases 270 based on the selected template. Form generator 240 then builds a document representing the completed regulatory form. For increased accuracy, forms can automatically generate the data through the incorporation of appropriate templates tailored to a facility location.

Environmental tool integrator 260 enables a user to navigate between facility data and internal databases 270 and between data and external databases 280. External databases can include any environmental reporter databases available through RMIS 130. For example, environmental reporter databases can include but are not limited to Bureau of National Affair (BNA) reporters, Enflex reporters, and Environmental Protection Agency (EPA) reporters such as the clean air report. This integrated access to external reporter databases allows RMIS users to manage regulatory information and databases more effectively and accurately. Specific state or federal regulations on air, water or waste can be looked up to configure permit data and set formula calculations.

Formula generator 225 calculates formulas to support the management of regulatory information in RMIS 130. In one embodiment, formula generator 225 calculates air loss according to formulas based on user inputs on air loss calculation screen 1780 described below. A user can select standard or customized formulas through the associated air loss calculation screens. These calculations are described further below with respect to the air management screen.

Process historian and lab information manager 295 is coupled to distributed control systems (DCSs) (not shown) at a facility. The DCSs can be any type of distributed control system that sense and monitor processes including, but not limited to, manufacturing processes, chemical processing processes, production processes or any type of automated process. DCSs capture data and provide raw or real time data indicative of the sensed conditions and performance of the processes being monitored. Such data can include emissions data, chemical data, and waste data. Such captured raw or real-time data can be stored in database(s) 290. Process historian and lab information manager 295 then forwards data captured by DCSs at a facility to RMIS 130 for storage in RMIS internal databases 270. RMIS 130 (e.g., facilities compliance manager 220 or permit manager 230) can further monitor process events based on the captured data in RMIS 270, and generate additional process event notifications.

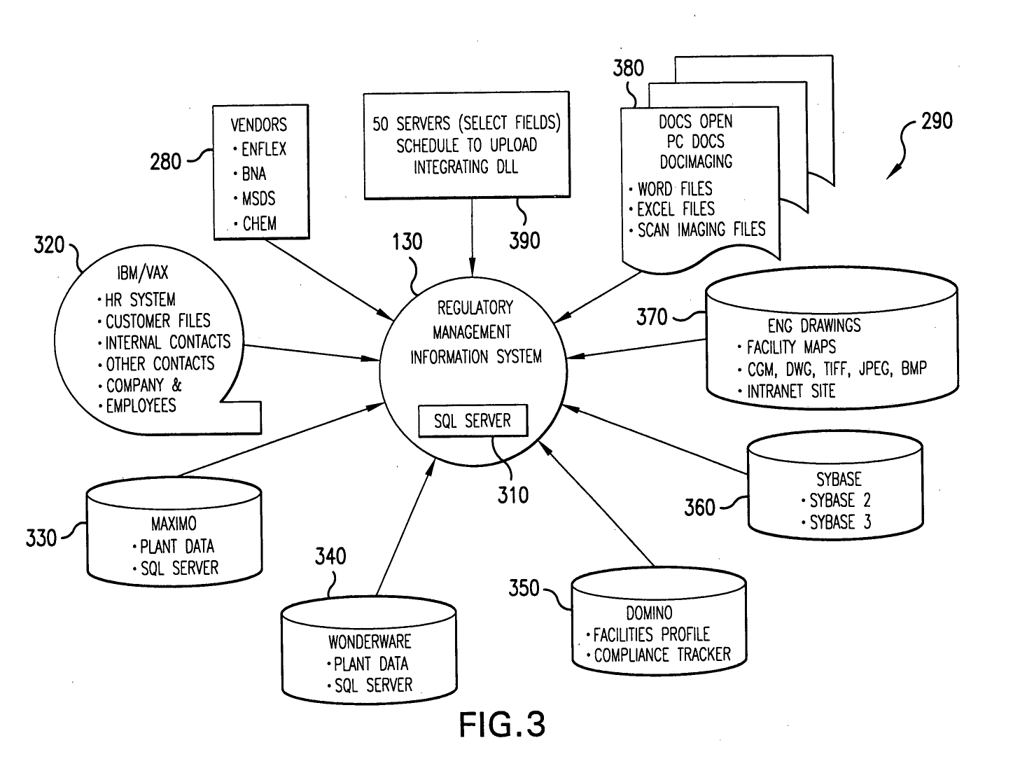

FIG. 3 is a diagram that shows the integration of RMIS 130 with other databases and systems according to example of the present invention. This example is illustrative and not intended to limit the present invention. As shown in FIG. 3, RMIS 130 is coupled to a SQL server 310. RMIS 130 is also coupled to other existing or legacy databases having a variety of different types of data information. For instance, RMIS 130 could be coupled to receive data from an IBM/VAX mainframe computer 320 having human resources data, customer files, internal contacts, other contacts, company employee data and other types of in-house company data. A MAXIMO database 330 and WONDERWARE database 340 can also be coupled to RMIS 130. Each of these databases can include plant data and SQL server functionality to deliver data to RMIS 130. A DOMINO database 350 having facilities profile data and compliance tracker data can also be coupled to RMIS 130. A SYBASE database 360 including data in Sybase form can be coupled to RMIS 130. ENG Drawings database 370 having engineering drawings such as facility maps, image files (CGM, DWG, TIFF, JPEG, BMP) images and intranet site web content can also be coupled to RMIS 130. Open documents 380 such as imaging documents, work files, excel files, scanned images and other types of data managed by a document management system such as PC DOCs can also be input to RMIS 130. A process historian and lab information management information system (PLIMS) 390 can also be coupled to RMIS 130. For example, PLIMS 390 can be coupled to distributed control systems that monitor ongoing processes at facilities. In one example, PLIMS 390 can be made up of 50 servers in selected fields with schedules to upload data to RMIS 130. PLIMS 390 forwards data to RMIS databases 270. The system shown in FIG. 3 is illustrative and not intended to limit the present invention. As it would be apparent to a person skilled in the art given this description other types of data and documents and existing or legacy systems can be coupled to RMIS 130 or new or extended system can be coupled to RMIS 130.

Routines for Managing Regulatory Information

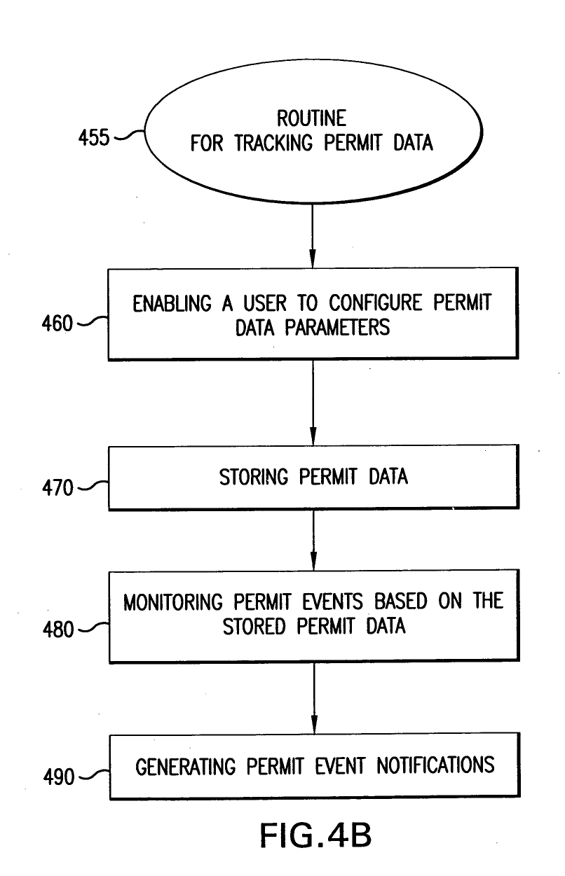

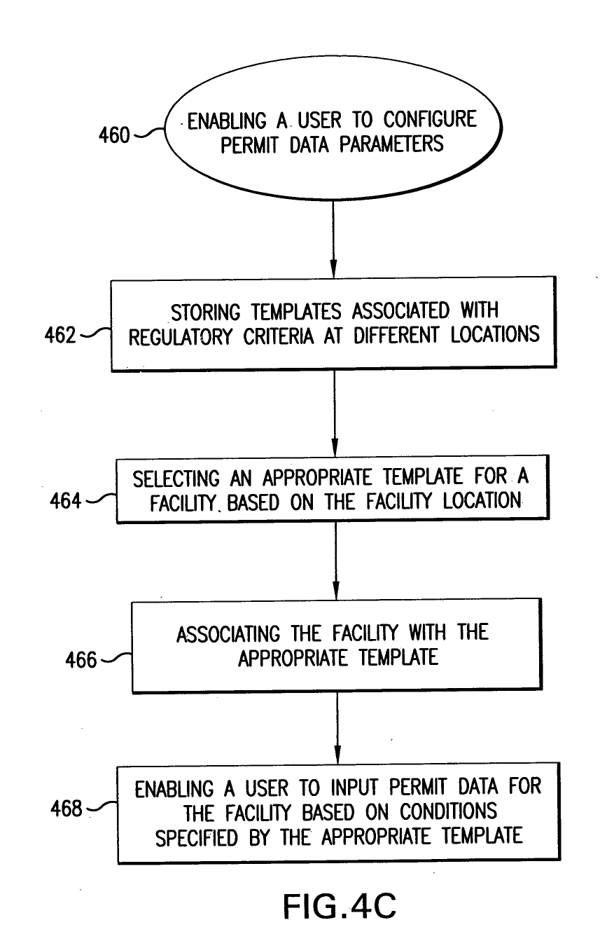

FIGS. 4A-8 illustrate routines carried out by RMIS 130. In the interest of brevity, routines 400 to 800 in FIGS. 4A-8 are described with respect to components in RMIS 130 however these routines are not necessarily intended to be limited to the specific structure of RMIS 130.

FIG. 4A illustrates routine 400 for managing facility compliance with federal and/or state regulations. Routine 400 includes steps 410-450. In step 410, data is stored in one or more RMIS databases 270 that relate to managing facility compliance with federal and/or state regulations. In step 420, a user is presented with a series of screens to enable navigation through RMIS databases 270 at user interface 114.

In step 430, a main menu is provided including Facility, Material, Air, Water, Waste, Tools and Administrative menus and icons. Examples of the menus and associated screens that be accessed through the main menu are described in further detail below in relation to FIGS. 9-21. In step 440, additional screens are provided to a user in response to user selections. In step 450, RMIS database 270 is updated in response to user inputs made and saved in the provided screens.

In FIG. 4B, a routine 455 for tracking permit data is shown (steps 460-490). In step 460, the routine enables a user to configure data parameters. For example, a template is provided to the user. This template enables the user to configure permit data parameters for a particular facility. Preferably, the template includes information needed to facilitate setting permit limits, ranges and other aids to compliance with in-house guidelines and/or federal and/or state regulations. In step 470, permit data entered by the users is stored in RMIS database 270. In step 480, permit manager 230 monitors permit events based on the stored permit data. In step 490, message generator 250 generates permit event notifications and distributes messages including permit event notifications to appropriate individuals.

FIG. 4C shows step 460 in further detail according to an embodiment of the present invention. In step 462, templates are stored associated with regulatory criteria different locations. For example, a set of templates can be stored. Each of these templates can be associated with different locations having different in-house guidelines and/or federal and state regulations. Also, a single set of templates can be made available to all facilities at many different locations. In step 464, an appropriate template is selected for a facility based on the facility location. For example, a facility in Illinois may be associated with an Illinois template. The Illinois template will assist the user in setting appropriate types of permit needs, limits, due dates, etc. The selected template (step 466) is forwarded to a user at user interface 114. This enables a user to input permit data for the facility based on the conditions specified by the appropriate template (step 468).

Formula Calculations

FIG. 5 is a diagram that shows a routine 500 for managing formula calculations in RMIS 130 (steps 510-530). In step 510, predetermined formulas for air, water, waste and/or use are stored in RMIS database 270. In step 520, a user is enabled to configure formulas for air, water, waste and/or use. For example, screens or templates can be provided to enable a user to specify formula parameters or specific formula calculations required to ensure compliance with federal and state regulations and/or in-house guidelines. In step 530, RMIS 130 manages facility compliance with federal and state regulations based on the configured formulas. In particular, facilities compliance manager 220 communicates with formula generator 225 and user interface 114 and browser 112 to ensure that facility compliance is managed based on appropriate configured formulas.

Facility Process Data Integration

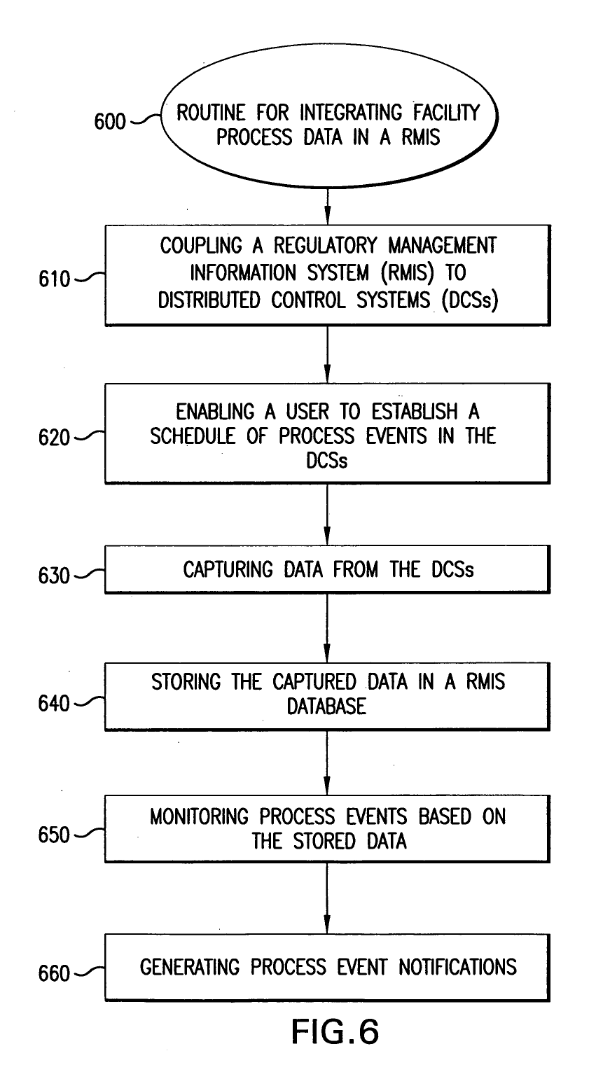

FIG. 6 is a diagram of routine 600 for integrating facility process data in RMIS 130 (step 610-660). In step 610, RMIS 130 is coupled to process historian and lab information managers (PLIMS) 295 which are in turn coupled to distributive control systems (DCSs). Process historian and lab information managers (PLIMS) 295 can store captured data from DCSs in databases 290. In step 620, process historian and lab information manager(s) 295 enable a user to establish a schedule of process events in the DCSs. For example, process historian and lab information manager 295 can forward appropriate screens to RMIS 130 (or to a local node at facility) to enable the user to select and identify a schedule of process events.

In step 630, raw data or real time data is captured by the distributed control systems. In step 640, the captured data is forwarded to and stored in RMIS database 270. In step 650, RMIS 130 monitors process events based on the stored data and generates process event notifications (step 660). In this way, RMIS 130 working with PLIMS 295 integrates facility process data generated directly by distributed control systems with the facility data in RMIS database 270. Raw or real time data from actual facility processes, such as manufacturing processes and chemical processing processes, can be captured and integrated to support regulatory information management.

Automated Form Generation

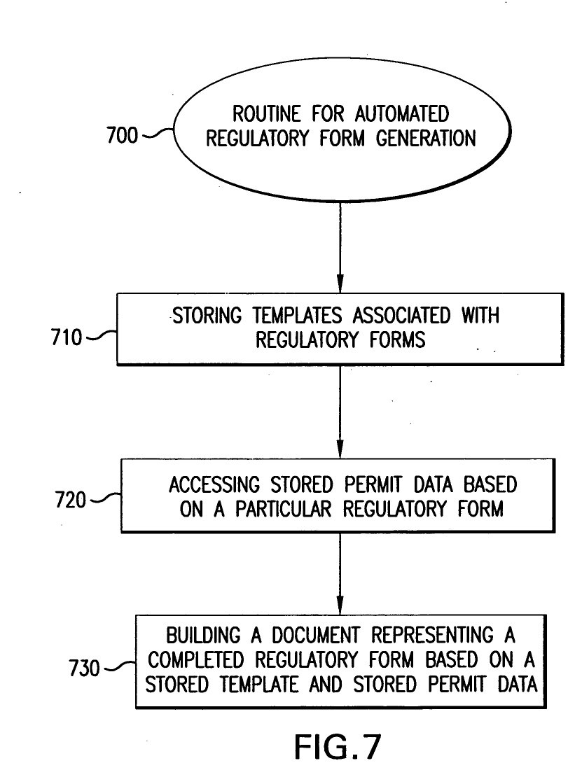

FIG. 7 is a diagram of routine 700 for automated regulatory form generation (steps 710-730). In one embodiment, routine 700 is carried out by form generator 240. In step 710, form generator 240 stores templates associated with regulatory forms required by different regulatory agencies and entities. Examples of such forms are Tier I, Tier II, Form A, Form R, and Title V forms and Annual Emission Inventory Reports. In step 720, form generator 240 accesses stored permit data based on a particular regulatory form. For example, a user through browser 112 can select a particular regulatory form associated with a particular facility. Form generator 240 then accesses stored permit data from RMIS database 270. In step 730, a document is built representing a stored regulatory form based on the stored template and the stored permit generator. Form generator 240 then builds a document representing the completed forms selected by a user based on the template and permit data stored in the actual RMIS database 270. In this way, a user of the facility can easily generate and submit proper regulatory forms accurately and efficiently.

Environmental Tool Integration

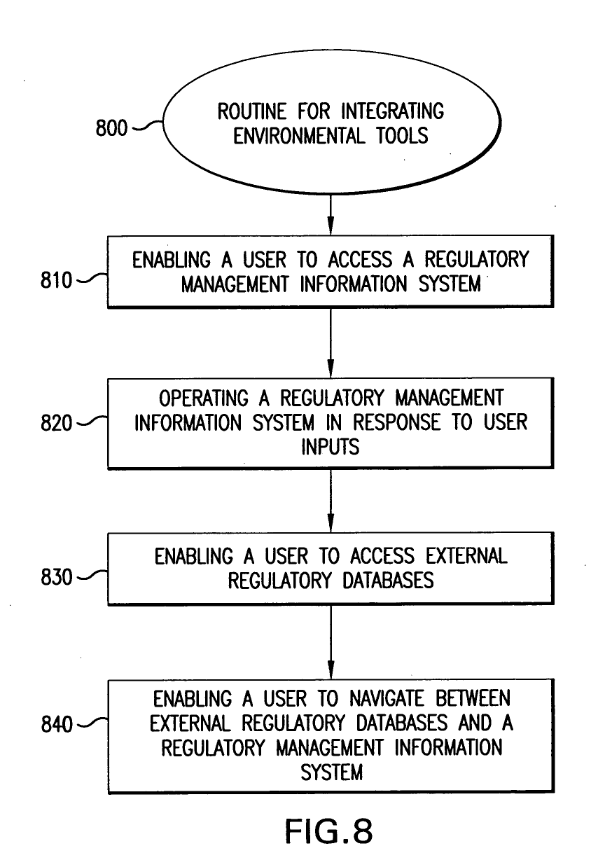

FIG. 8 is a diagram of a routine 800 for integrating environmental tools (steps 810-840). In one embodiment, routine 800 is carried out by environmental tool integrator 260. In step 810, environmental tool integrator 260 enables a user to access RMIS 130. Environmental tool integrator 260 may be a web page providing links to external vendor web sites that provide access to external databases. In step 820, environmental tool integrator 260 operates RMIS 130 in response to user inputs. A user is enabled to access external regulatory databases when the user selects through browser 112 a link to external web sites granting access to regulatory databases (step 830). In step 840, environmental tool integrator 260 enables users to navigate between the external regulatory databases 280 and RMIS information system and a particular data in RMIS database 270.

RMIS Screens

The RMIS user initiates RMIS 130 by selecting RMIS from a menu or by activating a link or icon displayed on the user's screen. Upon initiating RMIS 130, a user authentication screen may be presented to the user. An illustrative user authentication screen 900 is shown in FIG. 9. Through this screen, the user is prompted to enter a user name in an identification text box 910 and a password in a password text box 920. When the user activates the OK button, RMIS 130 authenticates the user and determines whether to allow the user to access RMIS 130. FIG. 9 illustrates an exemplary method for authenticating an end user. Alternative methods for user authentication could be implemented with the present invention as would be apparent to one skilled in the art. The authentication screen 900 would present different data collection fields to the user based on the method of authentication implemented. After successful user authentication, an information screen may be presented to the user to display news and information. A user can initiate an action such as hitting a key on the keyboard or activating a button or link to proceed to the next screen.

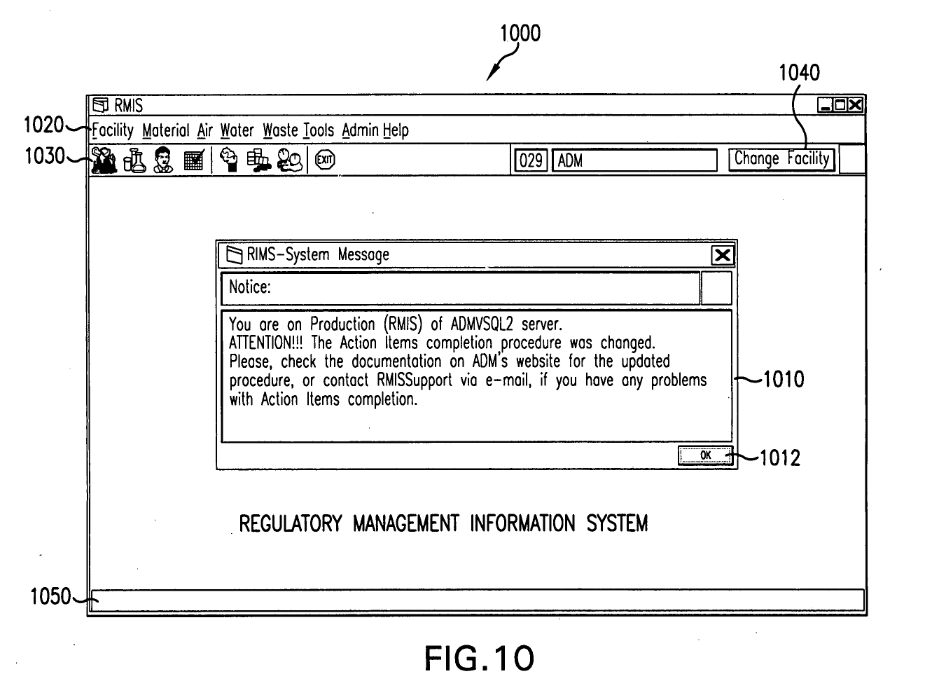

After the user exits screen 900 and any information screens, the RMIS main screen 1000, shown in FIG. 10, is displayed to the user. In an alternative embodiment of the present invention, the user authentication screen 900 and information screens are not displayed to the user. In this embodiment, when the user initiates RMIS 130, the user proceeds immediately to the RMIS main screen 1000.

Unless otherwise noted in the following description, RMIS 130 uses the following conventions for the screens described herein. On all RMIS screens, the standard WINDOWS conventions for minimizing, restoring, and closing an opened screen/window are followed. When presented, an Add button or a New button adds an item to the associated list or data field. An Apply button saves all changes on the current screen. A Cancel button closes the current screen without saving any changes made on the screen. A Clear button, used in conjunction with filtering or searching functions, clears the last search or filter command. A Close button closes the screen. A Delete button deletes an item from the associated list or data field. An Edit button edits an item in the associated list or data field. An OK button saves all changes entered into the current screen. A Remove button removes an item from the associated list or data filed. A View button allows viewing of details associated with a selected item. Double-clicking a line item for a selection will, in most cases, open the Edit/Update screen associated with the selected item. When a user is performing a filter, find, or search function, the user can apply standard wild card conventions such as entering an asterisk (*) in the associated text box.

The description follows the standard convention for editing text. If the background of a text box is white, the user can add information to or edit information in the text box. If the background of a text box is shaded, the user can only view the information. Unless specifically stated, information displayed in text boxes and information fields can be viewed and edited by the user. In addition, unless specifically stated, the user may add information to text boxes or information fields.

Upon entering the main screen 1000, a second informational screen 1010 may be displayed to announce RMIS specific news and information. The system informational screen 1010 may be implemented as a separate smaller window displayed on top of the RMIS main screen or as a frame within the main screen 1000. The message displayed on the system informational screen 1010 may be changed periodically. If the system informational screen is displayed, the user will be required to initiate a procedure to close the screen such as activating an acknowledge button 1012.

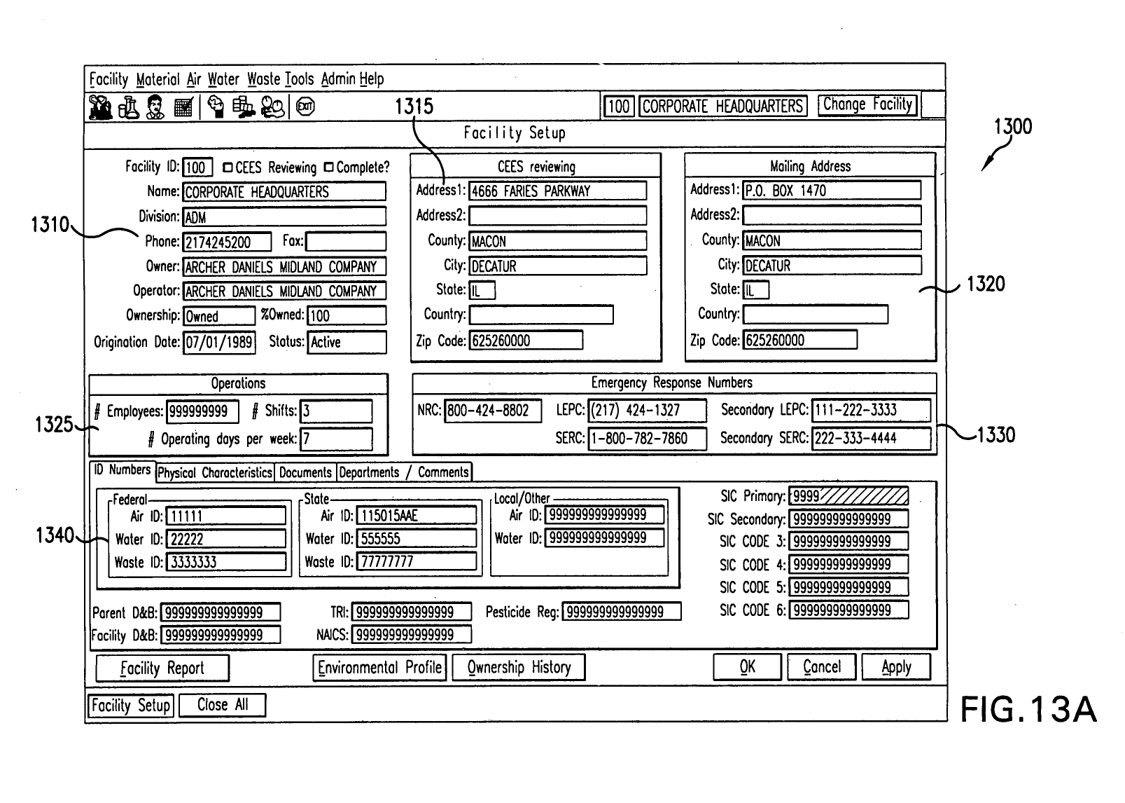

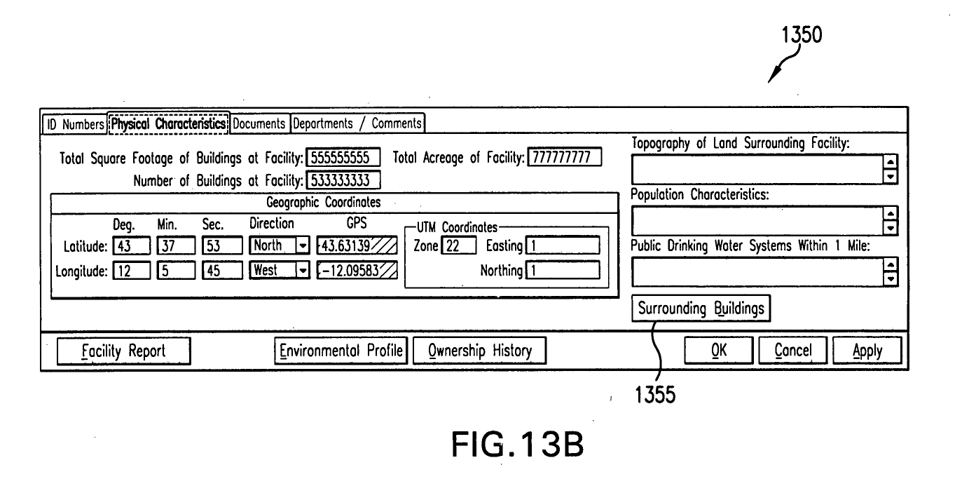

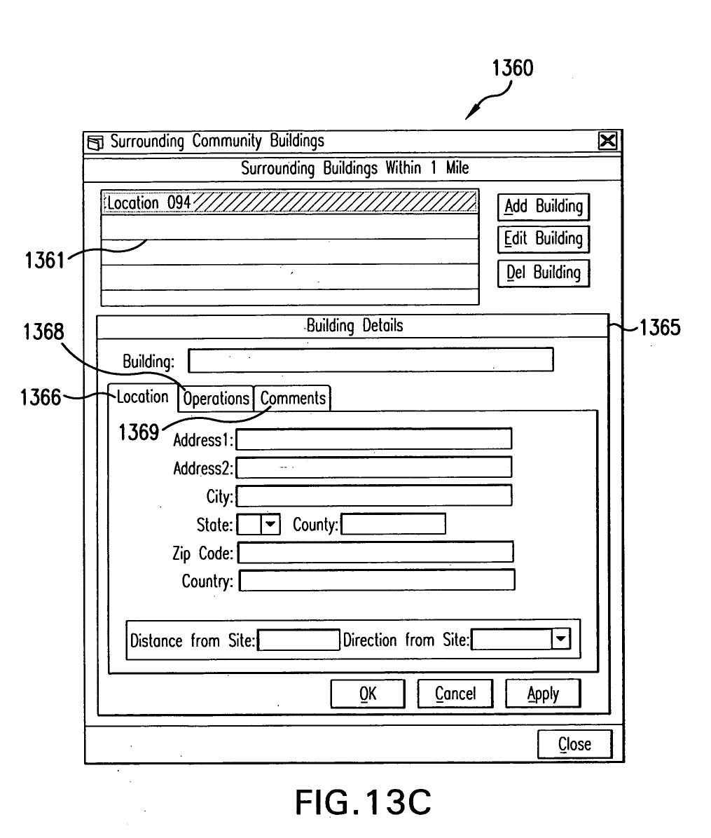

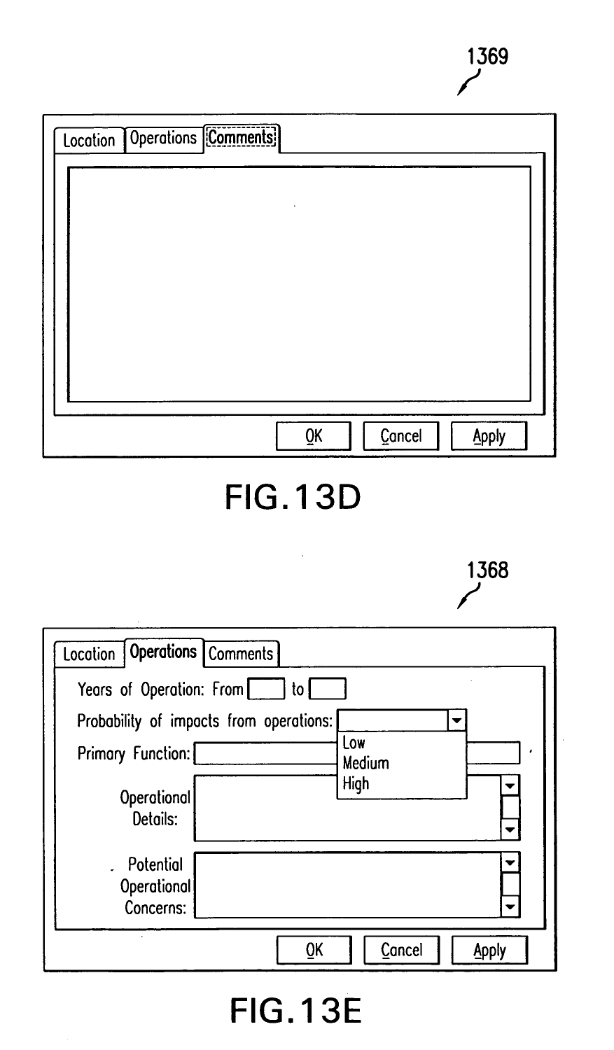

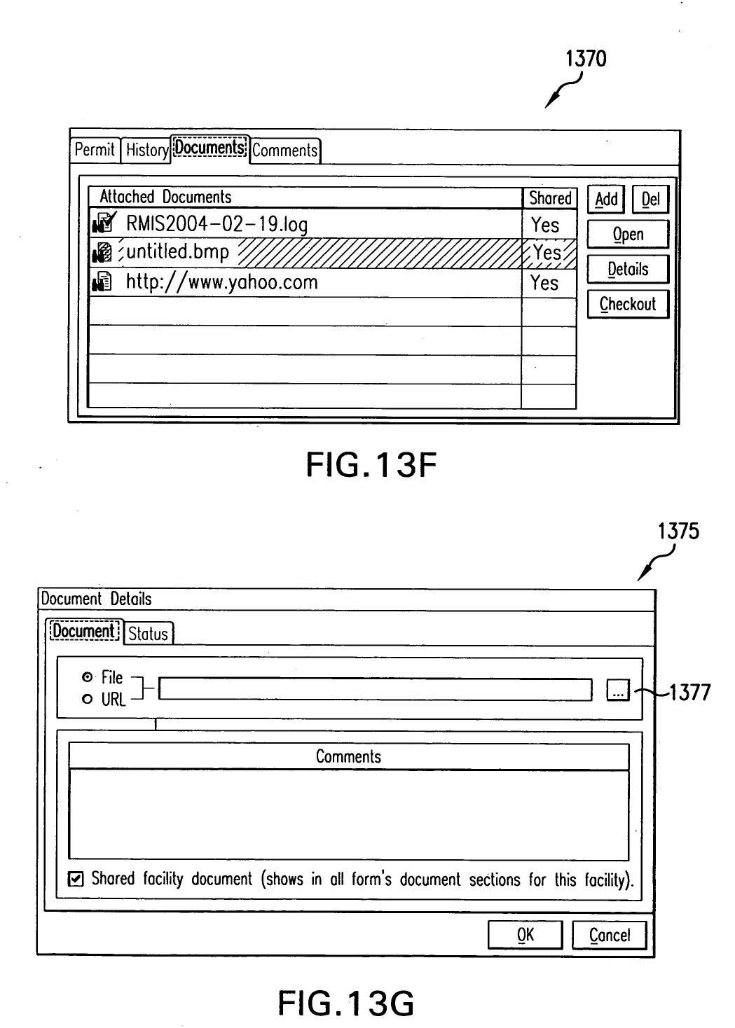

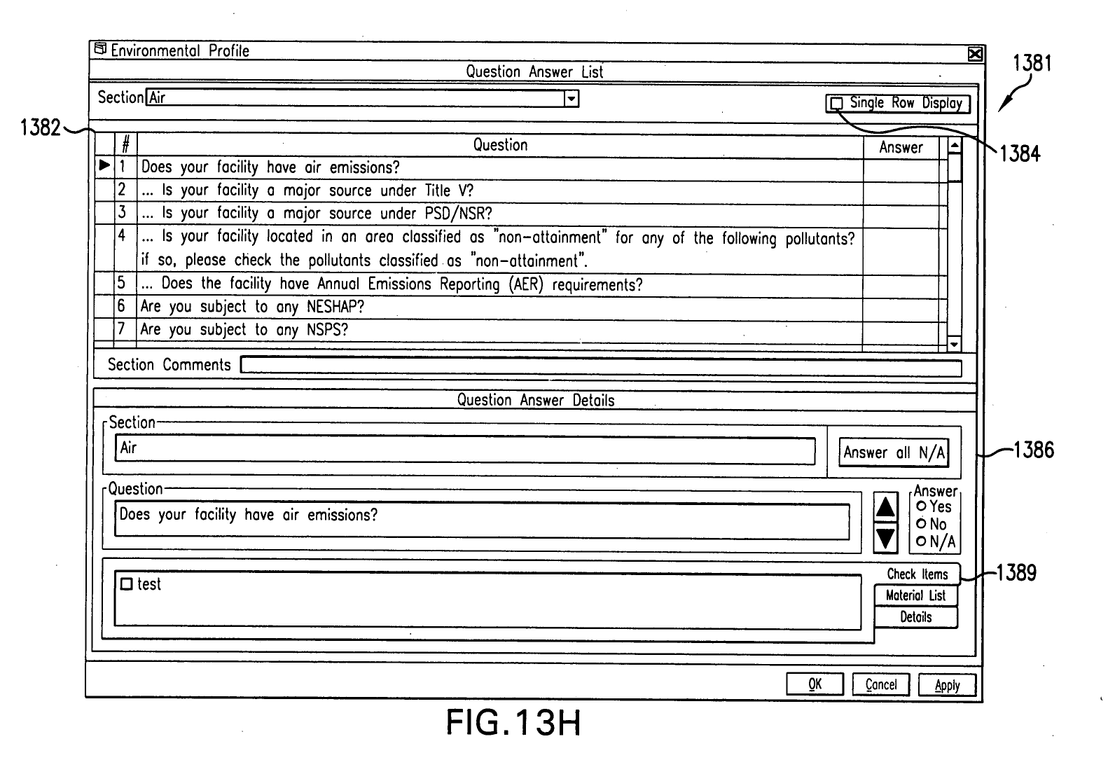

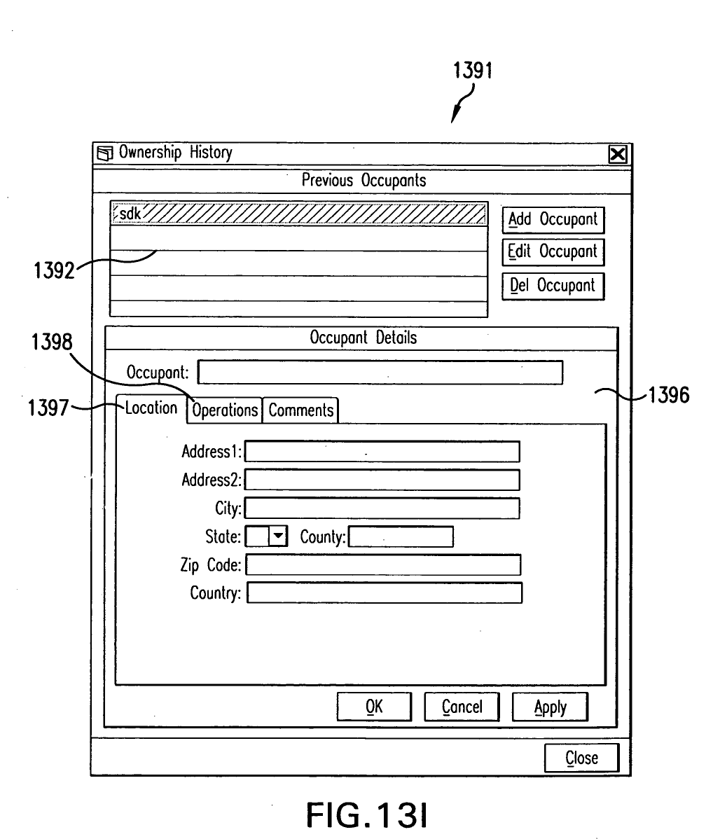

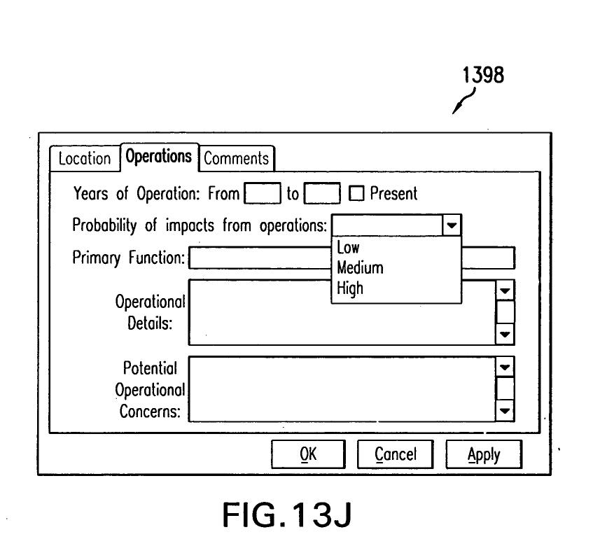

In the main screen 1000 shown in FIG. 10, the user can navigate to an application screen by selecting the item associated with the screen from a menu on the menu bar 1020 or by activating an icon on the toolbar 1030. In addition to RMIS specific screens and commands, the standard WINDOWS tools (e.g., cut, copy and paste) can be accessed from the menu bar 1020. The toolbar 1030 provides short cuts to frequently accessed screens and commands. The form navigation bar 1050 is located across the bottom of the main screen and displays buttons associated with the currently opened screens. The form navigation bar 1050 provides the user with a method to quickly switch between open forms by activating the button associated with the form. When one or more forms are open, a Close All button appears in the form navigation bar 1050. This button allows the user to close all open forms. FIG. 13A illustrates the operation of the navigation bar in connection with the opened Facility Setup screen. If a form contains unsaved changes, a prompt will be displayed to the user asking whether the user wishes to save the changes before closing the form.

Facility Selection Screen

The Name and Number of the Current Facility being accessed by RMIS 130 are displayed in text boxes next to the Change Facility button 1040 on the main screen 1000. A user can change the current facility by activating the Change Facility button 1040. When the user activates the Change Facility button, the user proceeds to the Facility Selection screen 1100 shown in FIG. 111. The Facility Selection screen allows the user to select the current facility being accessed by RMIS 130. The Facility Selection screen 1100 contains a Facility Search section 1110. The Facility Search section 1110 includes various text boxes for defining the facility search. For example, the user may enter a facility number, a facility site name, a facility address, a city, a state, or any combination of these items. After the desired search criteria are entered by the user, the user activates the Find button 1134 to perform the search. Facilities meeting the search criteria are displayed in the Facility list 1130. Each Facility list entry includes the Facility number, name, division, address, city and state.

The user can change facilities by highlighting an entry from the Facility list 1130 and activating the Select button 1132. When the Select button is activated, RMIS 130 will close all open screens associated with the former facility. If a screen contains unsaved changes, a prompt will be displayed to the user asking whether the user wishes to save the changes before closing the screen. The selected facility is populated in the Name and Number of Current Facility text boxes on main screen 1000.

Administration Menu

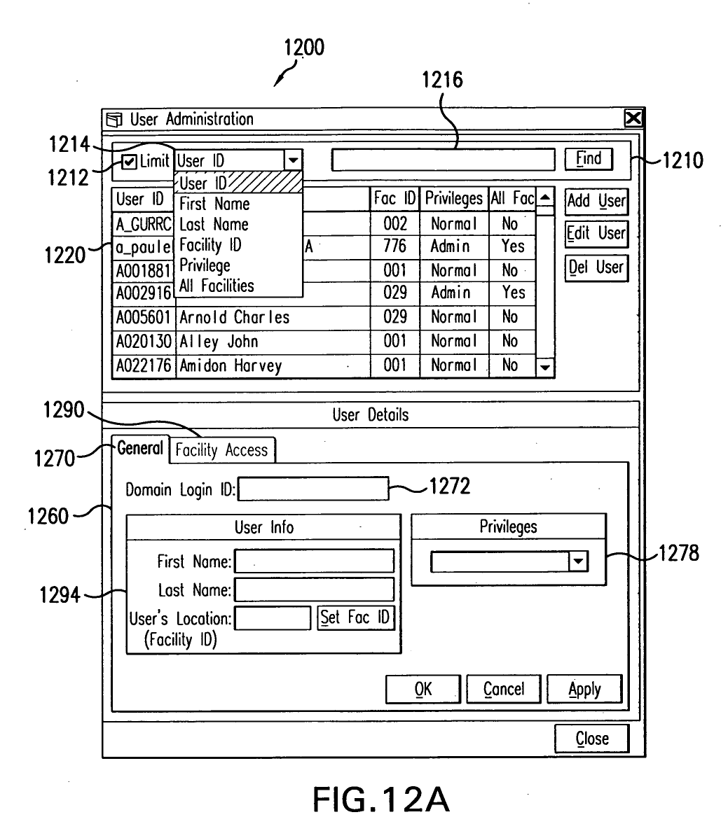

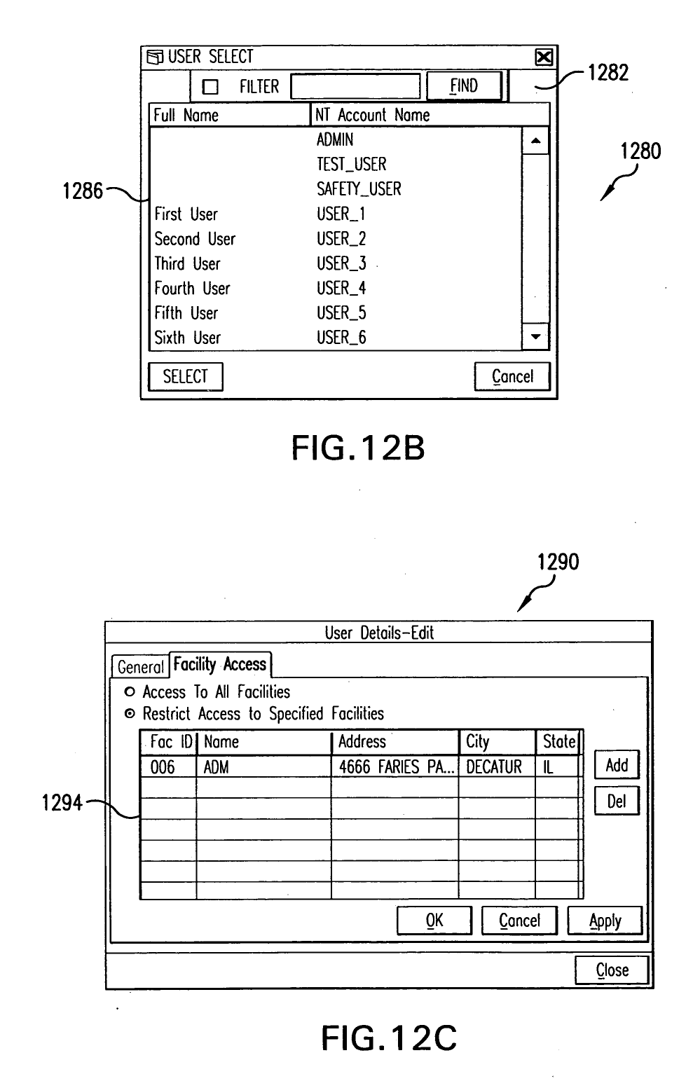

When the user selects the User Administration item from Admin menu on the main screen 1000, the user proceeds to the User Administration Screen 1200 shown in FIG. 12A. The User Administration Screen may be displayed as a separate screen or as a frame within the main screen 1000. The User Administration Screen 1200 allows a user to administer data about RMIS application users. When the User Administration Screen 1200 is first displayed, the User list 1220 includes all RMIS application users. Each user entry on the list contains a User ID, Name, Facility ID, Privileges, and All Facilities status associated with the user.

A user can limit the entries that are displayed in the User list by activating the Filter function. The List Filter bar 1210 contains text boxes and fields for defining a filter to be applied to the list. Initially, the Filter menu 1214 and the Filter text box 1216 are shaded and inaccessible to the user. When the limit check box 1212 is selected by clicking in the box, the Filter menu and Filter text box become accessible. The user selects a filter category by highlighting an entry in the Filter menu 1214. Possible filter categories include User ID, First Name, Last Name, Facility ID, Privilege, and All Facilities. The user can type information pertaining to the selected item in the Filter text box 1216. When the Find button is activated, RMIS 130 performs the defined filter and displays the result in the User list 1220.

The user selects a specific user by highlighting that user's entry in the User list 1220. When a specific user entry is highlighted, the user can edit the specific user's information by activating the Edit User button or delete the selected user by activating the Del User button. To add a user to the list, the user activates the Add User button. When the user activates either the Edit User button or the Add User button, the User Details section 1260 becomes unshaded and accessible to the user. If the user selected a specific user entry from the User Display section 1220, the User Details section 1260 displays information specific to that user. The user can then edit, add or delete the specific user's data. If the user is adding a new user, the fields in the User Details section are blank.

The User Details section 1260 includes a General tab 1270 and a Facility Access Tab 1290. In the General tab 1270, the user can view, add, or update information about a specific user. The Domain Login ID text box 1272 displays domain login ID assigned to a particular user. The user can enter data directly into the Domain Login ID text box 1272.

In an alternative embodiment, the user can populate the text box by using the look-up button. When the look-up button is activated, the user proceeds to the User Select screen 1280 show in FIG. 12B. The User Select screen includes a Filter bar 1282 and a Domain Login ID list 1286. The Filter bar 1282 allows the user to limit the entries displayed in the Domain Login ID list. To use the filter feature, the user must select the filter checkbox by clicking in the box. When the checkbox is selected, the user can type information in the text box. When the Find button is activated, RMIS 130 performs the defined filter and displays the result in the Domain Login ID list 1286. The list 1286 includes the full name and NT Account name for each entry. The user can highlight an entry and activate the Select button. The selected entry will then be populated in the Domain Login ID text box 1272 on the General tab 1270.

The General tab 1270 contains a User Information section 1274 that includes First Name, Last Name, and User's Location text boxes. A user's location could be entered, for example, as a facility identification. If the user does not know the specific user's facility identification, the user can activate the Set Fac ID button to select from a current list of facility identifications. The General tab 1270 also contains a Privileges menu 1278. The Privileges menu 1278 allows the user to select a privilege status (e.g., Admin, Normal, or Read-Only) for the specific user.

The Facility Access tab 1290, shown in FIG. 12C, displays facility access control data for each user. If the selected user is allowed to access all facilities, the Access to All Facilities radial button is turned on. If the selected user's access is restricted, the Restrict Access to Specified Facilities radial button is turned on. The Facility list 1294 contains a list of facilities that the selected user is allowed to access. The user can add additional facilities to the list by activating the Add button. The user can remove facilities by highlighting one or more facilities and activating the Del button.

Facility Menu

The Facility menu on the main screen 1000 contains a list of screens associated with RMIS Facility functionality. From this menu, the user can navigate to the Facility Setup screen or Action Items screen.

Facility Setup

From the main screen 1000, the user can access the Facility Setup screen 1300 shown in FIG. 13A by selecting the Facility Setup item from the Facility menu or by clicking on the Facility Setup icon on the toolbar 1030. The Facility Setup icon contains a stylized representation of an industrial facility. The icon is illustrated on main screen 1000 as the first button on the left side of the toolbar 1030. The Facility Setup screen 1300 may be displayed as a standalone screen or as a frame within the main screen 1000. The Facility Setup screen 1300 allows for updates to current facility data. The screen includes a general information section 1310, a physical address section 1315 and a mailing address section 1320. These sections display information for reference purposes only and are inaccessible to the user.

The general information section 1310 contains a CEES Reviewing checkbox and a Complete checkbox. A check in the CEES Reviewing checkbox indicates that the facility's profile is being reviewed by CEES. A check in the Complete checkbox indicates that the facility's profile is complete. The physical address section 1315 includes address data associated with the physical location of the facility. The mailing address section 1320 includes mailing address data.

The Facility Setup screen 1300 also includes an Operations section 1325 and an Emergency Response Numbers section 1330. The Operations section 1325 contains a Number of Employees text box that displays the number of employees located at the facility. The Number of Shifts text box displays the number of shifts at the facility. The Number of Operating Days Per Week text box displays the number of days the facility operates each week.

The Emergency Response Numbers section 1330 displays the phone numbers for the primary and secondary Local Emergency Planning Committee (LEPC) for the facility in the LEPC text box and the Secondary LEPC text box, respectively. Phone numbers for the primary and secondary State Emergency Response Commission (SERC) for the facility are displayed in the SERC text box and Secondary SERC text box, respectively.

The ID Numbers tab 1340 contains the federal, state, and local identification numbers that pertain to the facility. The ID Numbers tab 1340 also includes text boxes for fields imported into RMIS 130 from outside sources. Examples of these fields include fields for parent and facility Dunn & Bradstreet codes and fields for various SIC codes. Additional fields associated with the facility can be added as needed. Some of these imported text boxes may be made inaccessible to the user.

The Physical Characteristics tab 1350 is shown in FIG. 13B. This tab displays physical information related to the facility such as the square footage of the facility, number of buildings at the facility, total acreage, longitude and latitude, and USGS coordinates. The GPS text boxes are populated by RMIS 130 and are inaccessible to the user. The RMIS system calculates the GPS coordinates as follows:
For N: −Latitude Deg+(Latitude Mins/60)+(Latitude Sec/3600)
For S: Latitude Deg+(Latitude Mins/60)+(Latitude Sec/3600)
For E: Longitude Deg+(Longitude Mins/60)+(Longitude Sec/3600)
For W: −Longitude Deg+(Longitude Mins/60)+(Longitude Sec/3600)

The Topography of Land Surrounding Facility text box displays a description of the topography of the land around the facility. The Population Characteristic text box displays a description of the population patterns surrounding the facility. The Public Drinking Water Systems Within 1 Mile text box lists any public drinking water systems within one mile of the facility.

When the user activates the Surrounding Buildings button 1355 on the Physical Characteristics tab 1350, the user proceeds to the Surrounding Community Buildings screen 1360, shown in FIG. 13C. This screen displays information about the surrounding community. The Surrounding Buildings list 1361 list buildings surrounding the current facility. When a building from the list is highlighted, the Building Details section 1365 displays detailed information about the selected building. When the user activates the Edit Building button, the user can edit data fields in the Building Details section 1365. Similarly, when the user activates the Add Building button, the user can add information associated with the newly added surrounding building into data fields in the Building Details section 1365. The Del Building button allows the user to delete the selected building. A confirmation prompt will be displayed to the user before any action is taken to delete the building.

The Building Details section 1365 includes a Location tab 1366, an Operations tab 1368, and a Comments tab 1369. A Comments tab is a standard tab used on various RMIS screens. When presented to the user, the Comments tab 1369, shown in FIG. 13D, provides a text box for entering any additional comments related to the associated screen or data field. The Location tab 1366, shown in FIG. 13C, displays address and location information about the surrounding building. The Distance from Site text box displays how far the building is from the current facility in distance and units. The Direction from Site field displays which direction the building is from the current facility.

The Operations tab 1368, illustrated in FIG. 13E, displays operational information associated with the selected building. The Years of Operation text boxes contain the four digit year that the nearby building began operations in the From box and the four digit year that the building ceased operation, if applicable, in the To box. If the Present checkbox is marked, operation of the nearby building is current. The Operations tab 1368 also contains a menu for displaying the probability that the selected building's operations will affect the current facility. The primary function of the selected building is displayed in the Primary Function text box. The Operational Details text box displays a description of the activities of the nearby building. In the Potential Operational Concerns text box, a description of any potential concerns with the operational practices of the nearby building can be displayed.

The Documents tab 1370 on the Facilities Setup screen 1300 is a standard tab used on various RMIS application screens. The following description of the Documents tab applies to all uses of a Document tab throughout RMIS 130 unless specifically stated.

An illustrative Documents tab is shown in FIG. 13F. When presented to the user, the Document tab 1370 displays document files or Web links associated with the facility. After a document file or Web link has been added (checked-in), RMIS 130 will store the file or link on the RMIS document server so that the file or Web link can be shared among RMIS application users. The types of files that can be checked-in to the RMIS document server using the Documents tab 1370 can be any type of documentation file including Microsoft Word documents, Microsoft Excel spreadsheets, Microsoft Visio diagrams, PDF files, BMP, JPG files, etc. The user can save any file to the RMIS document file server that the user deems appropriate for facility documentation.

The Document tab 1370 includes a Document list. The Document list contains a document name, update date and time information, and a global status for each document entry. When a user wishes to add or check-in a document or Web link, the user selects the Add button or the CheckIn button, respectively. In an alternative embodiment, the Add button performs both add and check-in functions. When either the add or check-in functions is activated, RMIS 130 copies the source document file to the RMIS document server. In an alternative embodiment not illustrated, the Documents tab 1370 may also include an Edit button.

When the Edit button or the Add button is activated, the Document Details screen 1375, shown in FIG. 13G, is displayed. A user may enter information in the File Name text box or use the lookup button 1377 to populate the field. The lookup button 1377 links the user to a listing of document files. The URL button links a user to a listing of Web site addresses. When checked, the Global checkbox indicates the file or Web link is globally accessible. The Comments text box displays comments about the selected document or Web link. When the user activates the Edit button from the Documents tab 1370, only the Global checkbox and Comments text box can be accessed by the user.

A document file or Web link can be deleted from the RMIS document server by highlighting the document file or Web link and activating the Del button. In an alternative embodiment not illustrated, the Documents tab 1370 includes an Open button. The Open button opens a document file or Web site. If a document file is being opened, the associated application for the document file type must be on the user's workstation. The user can check-in and out a document file but is unable to view the file without the appropriate software. The Undo button undoes the check out function.

Creating a document file or Web link using the Documents tab 1370 links the document file or Web link to the facility being accessed by RMIS 130 (as indicated in the Name and Number of Current Facility text boxes displayed on main screen 1000), the RMIS screen being accessed by the user, and possibly one or more data fields within the RMIS screen. For example, a user selects the Documents tab to check-in a file called RMIS.doc. If the user were in Facility 001 using the Incidents screen to create a new Incident with an Incident-ID of 123, the RMIS.doc file would be linked to Facility 001, Incidents, and Incident 123. This link holds true, except for a document file or Web link marked as Global. A Global document file or Web link can be used or viewed across the facility and in any Documents tab regardless of the RMIS screen presenting the Documents tab.

The Facility Setup Screen 1300 also contains an Environmental Profile Button. When a user activates this button, the Environmental Profile screen 1381 is displayed as illustrated in FIG. 13H. The Environment Profile screen includes a Question Answer list 1382 and a Question Answer Details section 1386. The Question Answer list includes a Section dropdown menu that indicates with which section the questions displayed are associated. When checked, the Single Row Display checkbox 1384 indicates that the questions are displayed in single row format instead of multiple line form. Each question entry in the Question Answer list 1382 contains a number, the text of the question, and the answer. The Question Answer list 1382 also includes a Section Comments text box for displaying any additional comments related to the section.

The Question Answer Details section 1386 displays details associated with a question selected from the Question Answer list 1382. The question displayed in the Question text box corresponds to the question highlighted by a right facing arrow in the Question Answer list 1382. The Section and Question text boxes are for viewing only and cannot be accessed by the user. The Answer all N/A button allows the user to answer not applicable (N/A) for all the questions displayed in the Question Answer list 1382. The Up and Down Arrows provide a method to move up or down one question in the Question Answer list 1382. The Answer section 1389 displays the answer (as indicated by the Yes, No or N/A radial buttons) to the selected question. The Details text box contains additional data regarding the question or answer entered by the user.

The Facility Setup Screen 1300 contains an Ownership History button. When the user activates this button, the Ownership History screen 1391, as shown in FIG. 131, is displayed. The screen includes a Previous Occupants list 1392. When an occupant from the list is highlighted, the Occupant Details section 1396 displays detailed information about the occupant. When the user activates the Edit Occupant button, the user can edit data fields in the Occupant Details section 1396. Similarly, when the user activates the Add Occupant button, the user can add information associated with the newly added occupant into the data fields contained in the Occupant Details section 1396. An occupant is deleted by highlighting the occupant and activating the Del Occupant button. A confirmation prompt will be displayed to the user before any action is taken to delete the occupant.

The Occupant Details section 1396 includes a Location tab 1397, an Operations tab 1398, and a Comments tab. The Location tab 1397 displays address and location information associated with the selected occupant. The Operations tab 1398, illustrated in FIG. 13J, displays operational information associated with the selected occupant. The Years of Operation text boxes contain the four digit year that the occupant began operations in the From box and the four digit year that the occupant ceased operation, if applicable, in the To box. The Operations tab also contains a dropdown menu for displaying the probability that the occupant's operations will affect the identified facility. The Primary Function text box contains a description of what the occupant does. The Operational Details text box displays a description of the activities of the occupant. The Potential Operational Concerns text box contains any potential concerns with the operational practices of the occupant.

The Facility Setup Screen 1300 contains a Facility Report button.

Action Item Screen

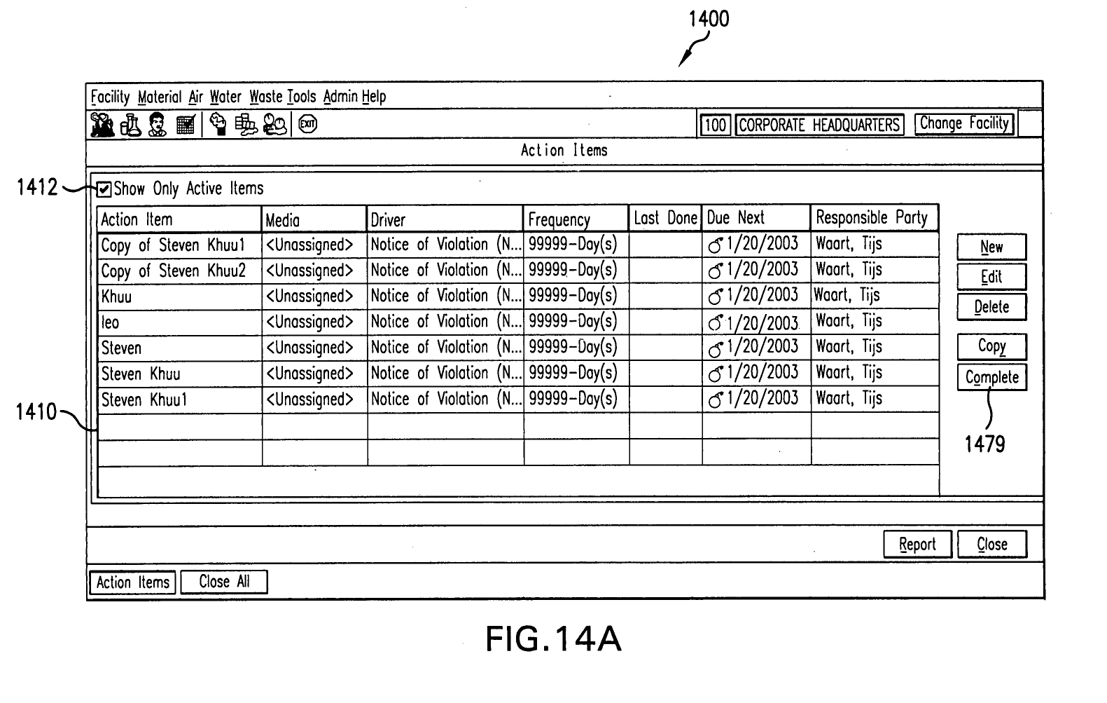

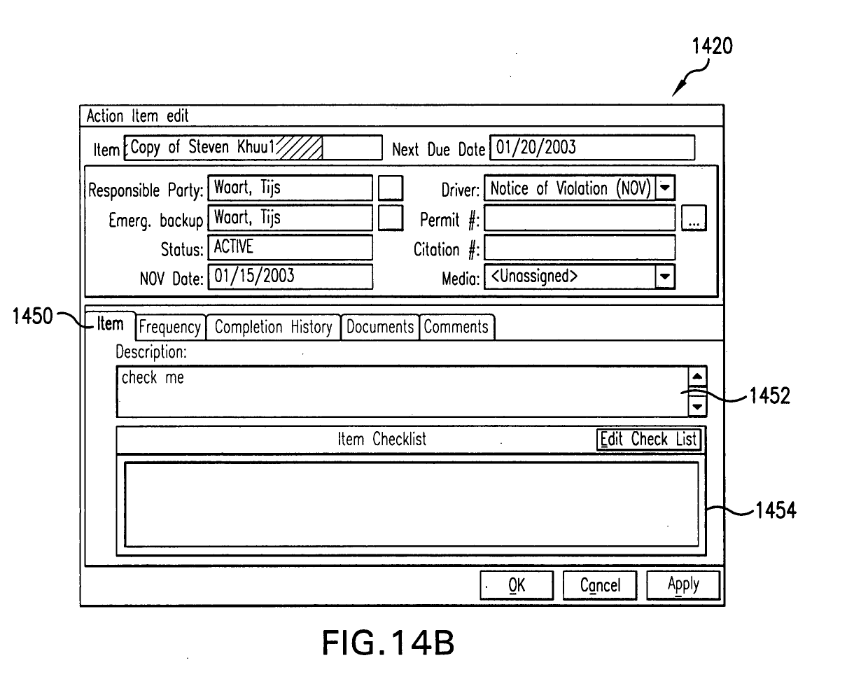

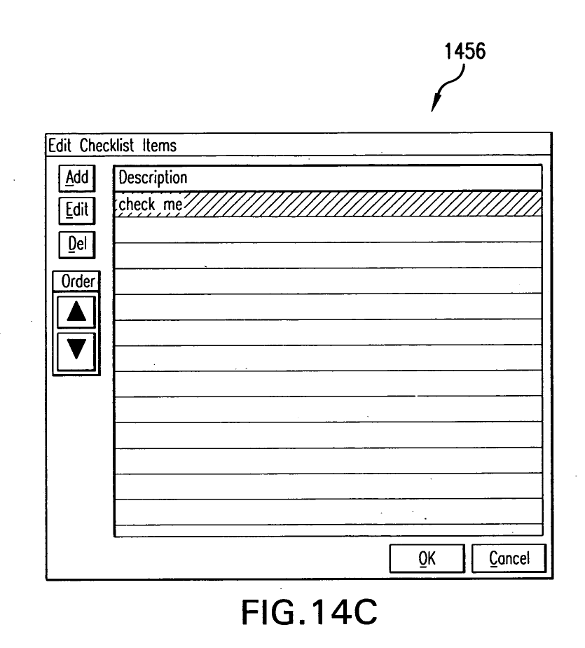

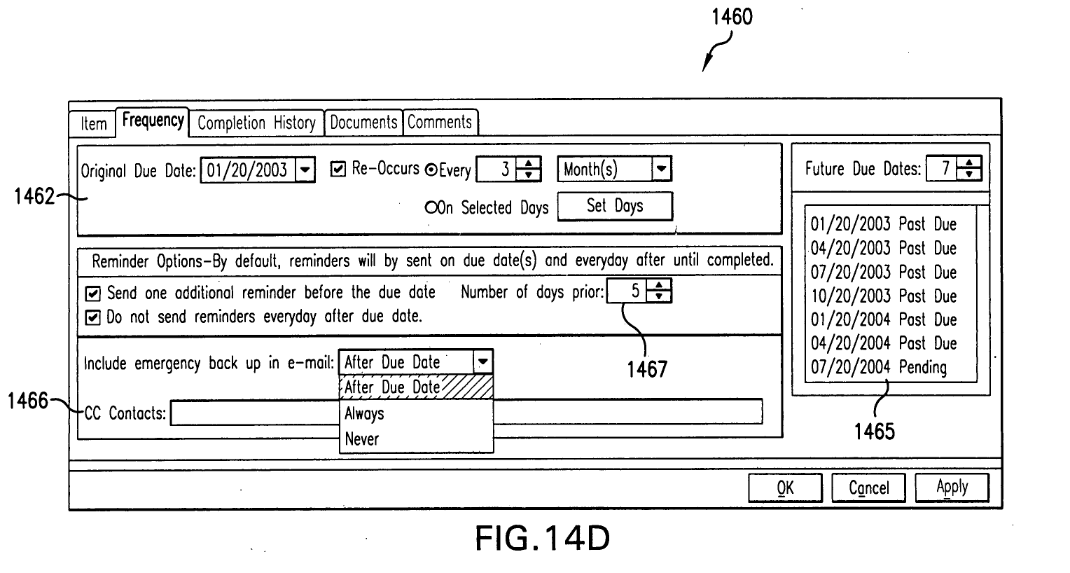

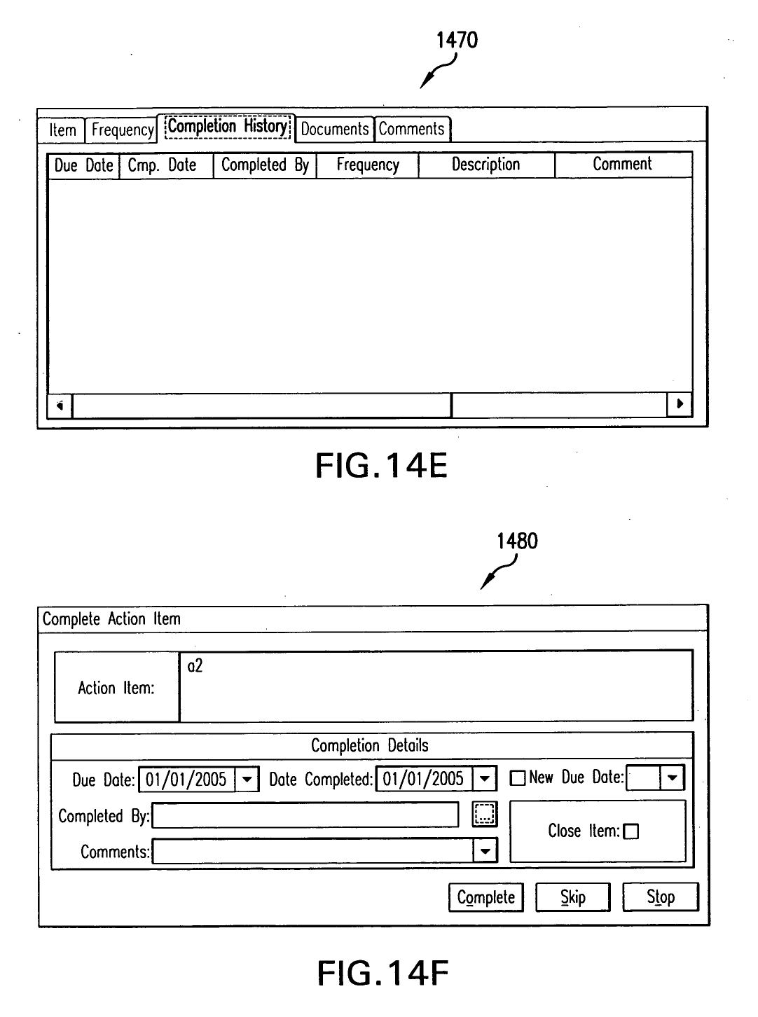

The user can access the Action Item screen 1400 shown in FIG. 14A from the main screen 1000 by either selecting the Action Item entry from the Facility menu or by clicking the Action Item icon on the toolbar 1030. The Action Item icon contains a stylized representation of a calendar with a checkmark and is illustrated on main screen 1000 as the fourth icon from the left side of the toolbar 1030. On certain RMIS screens the user can navigate to the Action Item screen 1400 by activating a Create Action Item button. The Action Item screen 1400 may be displayed as a standalone screen or as a frame within the main screen 1000. The Action Item screen 1400 is used to enter, schedule, and maintain action items.

The Action Item list 1410 contains title, media, driver, frequency, due next, last done, and responsible party fields for each action item entry. When the Show Only Active Items checkbox 1412 is checked, only active action items are displayed in the Action Item list 1410.

The user can edit action items by highlighting the action item in the Action Item list 1410 and activating the Edit Item button. The user can also add a new action item by activating the Add Item button. An action item can be deleted by highlighting the action item and activating the Del Item button. The Copy Action Item button duplicates the action item highlighted by the user. When the user selects either the Edit Item button or the Add Item button, the user proceeds to the Action Item Detail screen 1420.

The Action Item Detail screen 1420, shown in FIG. 14B, displays details about an action item. Several text boxes on this screen must be populated before the action item can be saved. The Item text box is a required field and contains a short description of the action item. The Next Due Date text box is read only. The value populated in this field is calculated based on data entered on the Action Item Edit screen 1420. The Responsible Party text box is a required field and contains the primary responsible party for the action item. The Emergency Backup text box is a required field and contains the party who will be the backup responsible party for the action item. Both the Responsible Party and Emergency Backup text boxes can be populated by using the lookup button located to the right of each text box. The Status text box is read-only and refers to work in progress.

The Driver field is required and contains the compliance driver associated with the action item. The user populates this field by selecting a driver from the associated menu. Compliance drivers include Permits, Incidents, Agency Visits, or None. If None is selected, the action item is not related to a compliance driver item. The Permit text box displays the permit number for the action item. The Citation text box displays the citation number for the action item. The Media field indicates the media associated with the action item.

The Item tab 1450 contains a description text box 1452 and an Item Checklist 1454. The description text box 1452 includes a more complete description of the action item. The Action Item Checklist 1454 contains a list of tasks that must be done in order to complete the action item. The user can add to the list or edit items on the list by activating the Edit button. When the Edit button is activated, the Edit Checklist Items screen 1456 shown in FIG. 14C, is displayed. The screen allows the user to add, edit, delete, and change the order of checklist items displayed. When the user activates the Add or Edit button, an Add Checklist Item To Action Item screen is displayed. In this screen, the user enters a description of the checklist item. When the user has finished updating the checklist, the user selects the OK button (or alternatively the Cancel button) on the Edit Checklist Item screen 1456 and is returned to the Action Item Detail screen 1420.

The Frequency tab 1460, shown in FIG. 14D, includes a scheduling section 1462 for scheduling how often and when an action item needs to be completed. The Frequency tab also includes an E-Mail Reminder section 1466 for setting up e-mail reminders. Frequency information cannot be edited upon saving. In order to save an active action item, the user must provide valid frequency, responsible party including a valid email, and action item name data. An inactive action item can be saved without providing valid information.

The Due Date field, in scheduling section 1462, displays the date when an action item is due. The down arrow button in the corner of the field brings up a calendar from which the user can select a date by highlighting and clicking. The due date cannot be edited upon saving. The Occurs Every text box combined with information from the associated dropdown menu tells how often the action item occurs (e.g., 2 Months). The text box displays a number and the dropdown menu contains a time period such as weeks, months, quarters, years, etc.

The E-Mail Reminder section 1466 contains information related to e-mail reminder preferences. The Number of days warning needed text box 1467 specifies how many days prior to the due date that RMIS 130 sends the responsible party an e-mail reminder. The E-Mail Reminder section 1466 can also contain a Remind Daily checkbox (not illustrated) which indicates whether the responsible party should receive an e-mail reminder every day, beginning after the first reminder is mailed, until the action item is complete. The E-Mail Reminder section 1466 can also contain a checkbox indicating whether the responsible party should be reminded past the due date. The Don't Remind Daily checkbox allows the user to indicate that e-mail should be received once on the warning day and once on the due date. The Include Emergency Backup In E-mail field indicates whether the emergency contact or contacts should also be sent the e-mail reminders. The co-copy text box displays a contact or contacts for copying the e-mail reminders.

The Future Due Dates list 1465 is populated with due dates in the future calculated based on the occurrence pattern entered in scheduling section 1462. The Number to Show text box allows the user to specify the number of future due dates that will appear in the list.

The Completion History tab 1470, shown in FIG. 14E, lists the due date, completion date, and person who have completed the action item in the past. From the Action Item screen 1400, the user can select the Complete button 1419. This button is only enabled when the action item is within an appropriate range of the due date. When the user selects the Complete button 1419, the Complete Action screen 1480, shown in FIG. 14F, is displayed. The Complete Action screen 1480 includes a Date Completed text box that contains the date when the action item was completed. The default for this date will always be the current date. If the item was completed two days before the current date, the date completed value should be changed to reflect that fact. The down arrow button in the corner brings up a calendar from which the user can select a completion date. The Completed By text box is a required field and contains the name of the individual who completed the action item. This individual may be the Responsible Party, the Emergency Backup, or another facility level contact who may complete the item. The Close Item checkbox refers to closing the action item permanently. An action item must be either complete for the most recent occurrence of the due date or it must be a Reminder Only item. Once an item is marked done, it will no longer appear in the action items list. It will not be accessible through any other part of the RMIS system.

Materials Menu

The Material menu on the main screen 1000 contains a list of screens associated with RMIS Material functionality. From this menu, the user can navigate to the Materials screen or the Regulatory Materials screen.

Materials Screen

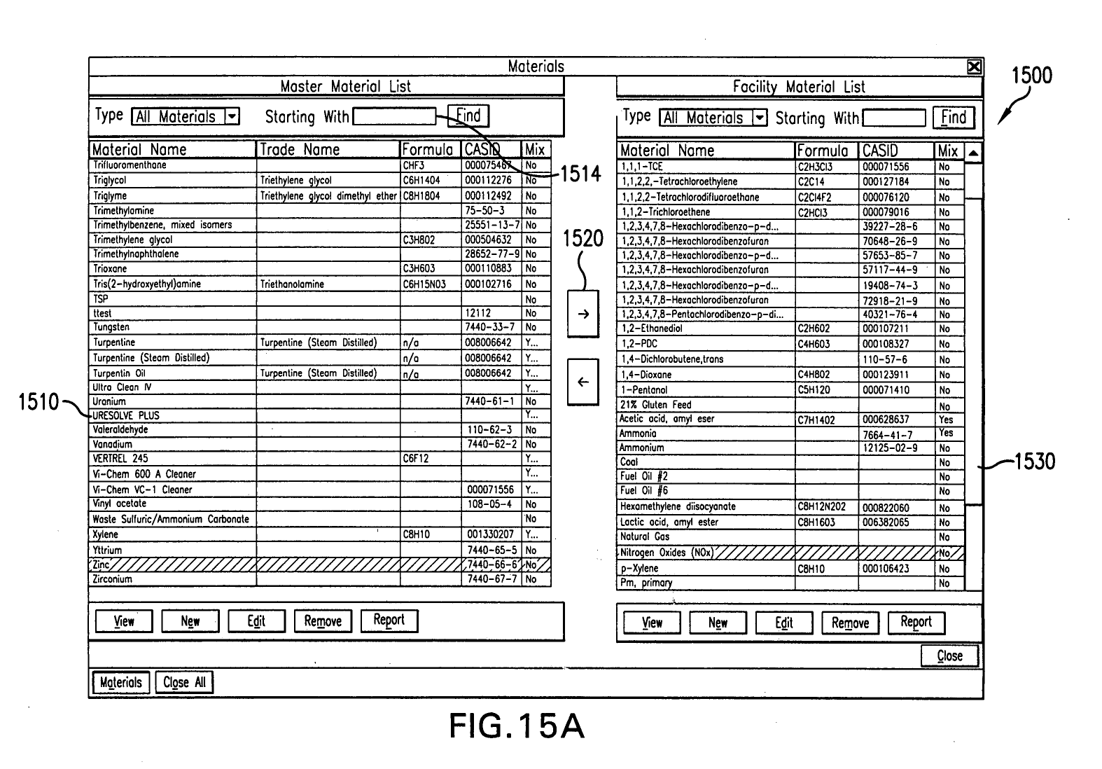

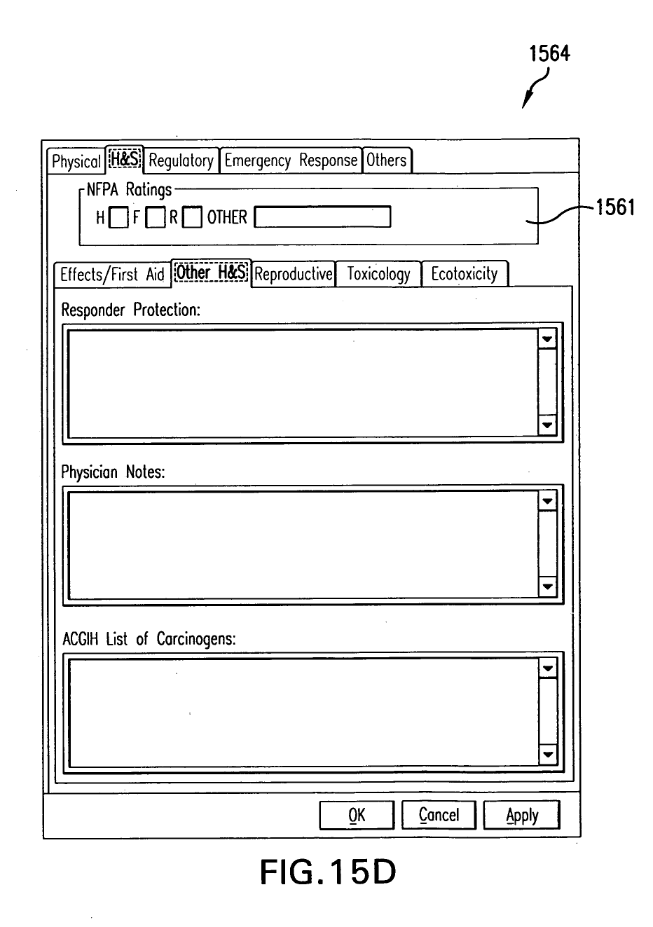

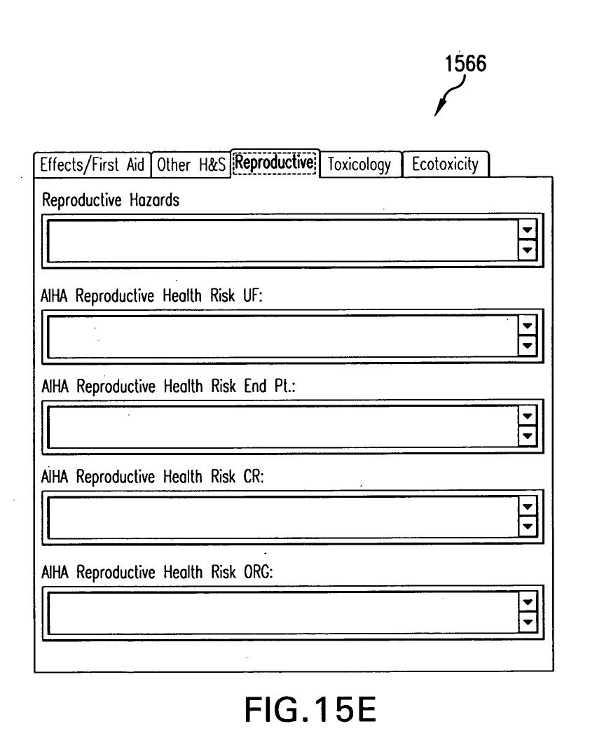

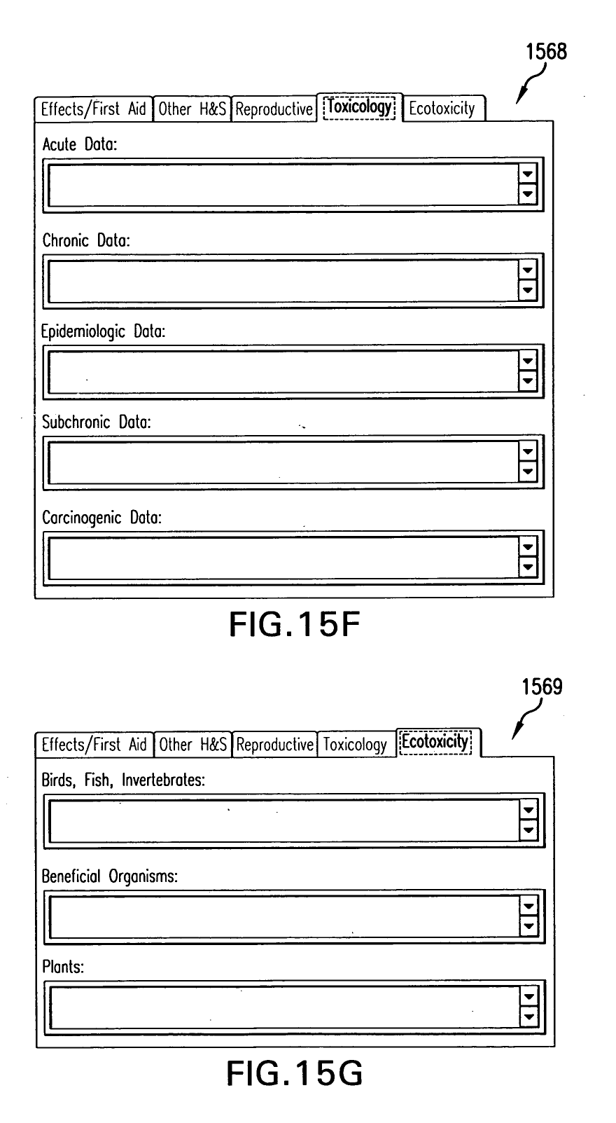

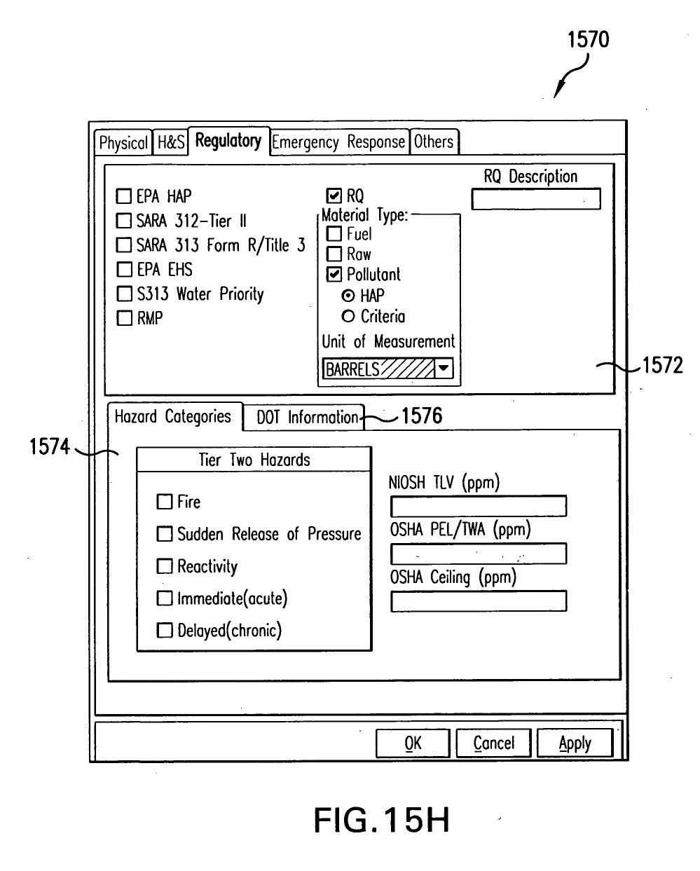

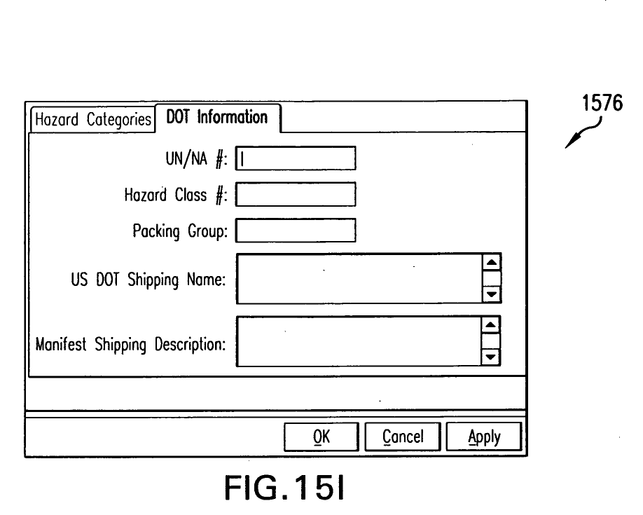

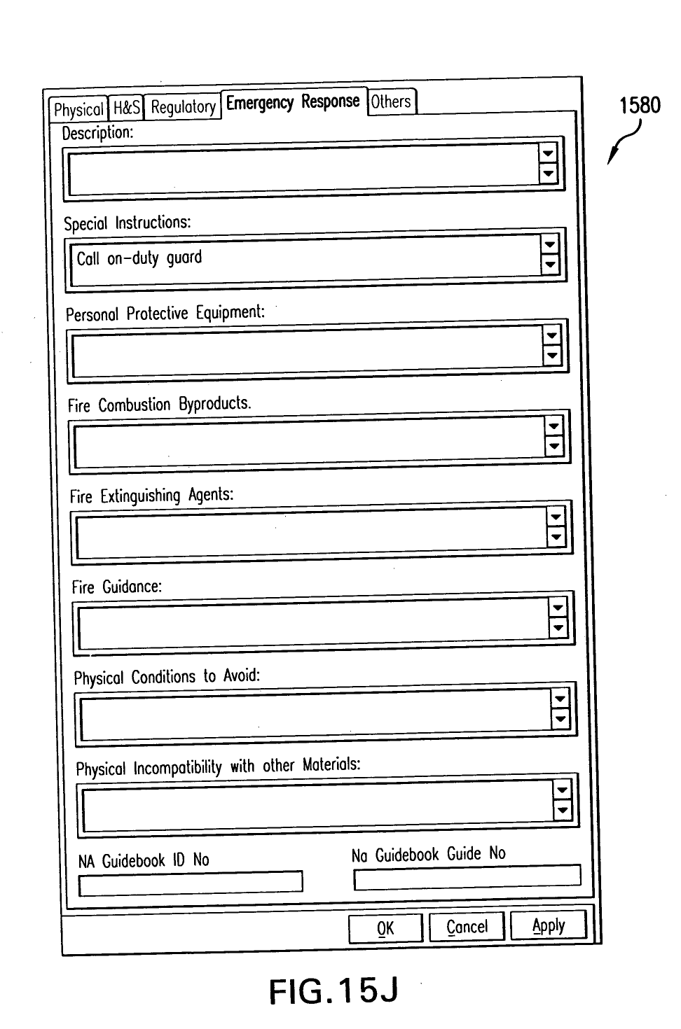

The user can access the Materials screen 1500 shown in FIG. 15A from the main screen 1000 by selecting the Materials item from the Material menu. The Materials screen 1500 allows the user to manage facility materials. The Materials screen 1500 includes a Master Material List 1510 and a Facility Material List 1530. The Master Material List 1510 can only be viewed and not edited by the user. Each entry in the Master Material List 1510 includes the material name, trade name, formula, CASID, and mix indicator. When the Materials screen is first displayed, the Master Material List 1510 contains all materials associated with RMIS 130. The user can filter the list by entering text in the filter text box 1514. When the user activates the Find button, RMIS 130 filters the list based on the data entered. The result of the search is displayed in the Master Material List 1510. When the user highlights a material from the Master Material List 1510 and activates the View button, the user proceeds to the Master Material screen 1540 described below.

The Facility Material List 1530 lists materials associated with the current facility. The filter function operates in the same manner as described above for the Master Material List 1510. The Facility Material List 1530 includes the material name, formula, CASID, and mix indicator for each entry. Additional information about a material in the Master Material List or Facility List could be displayed depending on the requirements of the RMIS user community. A material from the Master Material List 1510 can be copied to the Facility Material List 1530 by highlighting the material in the Master Material List and selecting the copy button 1520.

The user can edit materials listed in the Facility Material List 1530 by activating the Edit button. The user can add a new material to the Facility Material List 1530 by activating the New button. A material is removed by highlighting the material and activating the Remove button. When the user activates either the Edit button or the New button, the user proceeds to the Master Material screen 1540.

The Master Material screen 1540 is illustrated in FIG. 15B. The Master Material screen displays details of the material selected on the Materials screen 1500. If the material was selected from the Master Material List 1510, the material details can only be viewed and cannot be edited by the user. Certain data items on the Master Material screen will be populated from external databases such as a chemical database called Solve DB. As required by the needs of RMIS 130 user community, these items may be made inaccessible to the user.

The Master Material screen 1540 contains Pure and Mixture radial buttons 1542. These radial buttons indicate whether the user is viewing pure, mixture, or both types of materials. The material detail section 1544 includes CAS (chemical abstract service) number, Formula, Internal Trade Secret, and Waste data field. If the Waste field is marked, the user can access a waste profile by activating the Waste Profile button. The Synonym box 1546 displays synonyms for the material and provides a mechanism for the user to add additional synonyms. The Chemical Groups box 1548 displays the chemical groups associated with the material. The groups are selected from a list by clicking on a box next to the list entry.

The Physical tab 1550 displays the Material Safety Data Sheet associated with the material. The State section 1552 indicates whether a material is a solid, liquid or gas. The general information section 1554 displays stability, appearance, odor, specific gravity, M.W., Vapor Pressure, and Vapor Density information. The temperature section 1556 displays the boiling point and melting point in either Celsius or Fahrenheit. The material characteristic section 1558 indicates whether the material is flammable, combustible, corrosive or reactive.

The H&S tab 1560, shown in FIG. 15C, includes an NFPA ratings box 1561, as shown in FIG. 15D, an Effects/First Aid sub tab 1562, an Other H&S sub tab 1564, a Reproductive sub tab 1566, a Toxicology sub tab 1568, and an Ecotoxicity sub tab 1569. The Effects/First Aid sub tab 1562 includes a description of the effects of the material on the eyes, skin, ingestion, inhalation, combination, and other organs or biological functions. An associated First Aid text box is provided for each effect text box to describe relevant first aid information.

The Other H&S sub tab 1564, shown in FIG. 15D, includes text boxes for displaying, adding and editing information related to Responder Protection, Physician Notes, and ACGIH List of Carcinogens. The Reproductive sub tab 1566, shown in FIG. 15E, includes text boxes for displaying, adding, and editing information related to Reproductive Hazards, AIHA Reproductive Health Risk UF, AIHA Reproductive Health Risk End Pt, AIHA Reproductive Health Risk CR, and AIHA Reproductive Health Risk ORG. The Toxicology Sub Tab 1568, shown in FIG. 15F, includes text boxes for displaying, adding and editing acute, chronic, epidemiologic, subchronic, and carcinogenic data. The Ecotoxicity sub tab 1569, shown in FIG. 15G, includes text boxes for displaying, adding, and editing information related to birds, fish, invertebrates, beneficial organisms, and plants.

From the Master Material Screen 1540 the user can select the Regulatory tab 1570. The Regulatory tab 1570, as illustrated in FIG. 15H, includes a Mixture section 1572 for displaying mixture details. The Regulatory tab also includes a Hazard Category sub tab 1574 and a DOT Information sub tab 1576. The Hazard Category sub tab includes a Tier Two Hazards box and NIOSH TLV, OSHA PEL/TWA, and OSHA Ceiling text boxes. The DOT Information sub tab 1576, shown in FIG. 151, includes UNINA Number, Hazard Class Number, Packing Group, U.S. DOT Shipping Name, and Manifest Shipping Description text boxes.

From the Master Material Screen 1540, the user can select the Emergency Response tab 1580. The Emergency Response tab 1580, shown in FIG. 15J, contains descriptions, special instruction, personal protective equipment details, fire combustion byproducts, fire extinguishing agents, fire guidance, physical conditions to avoid, physical incompatibility with other materials, NA Guidebook ID Number, and NA Guidebook Guide Number text boxes.

Regulatory Material

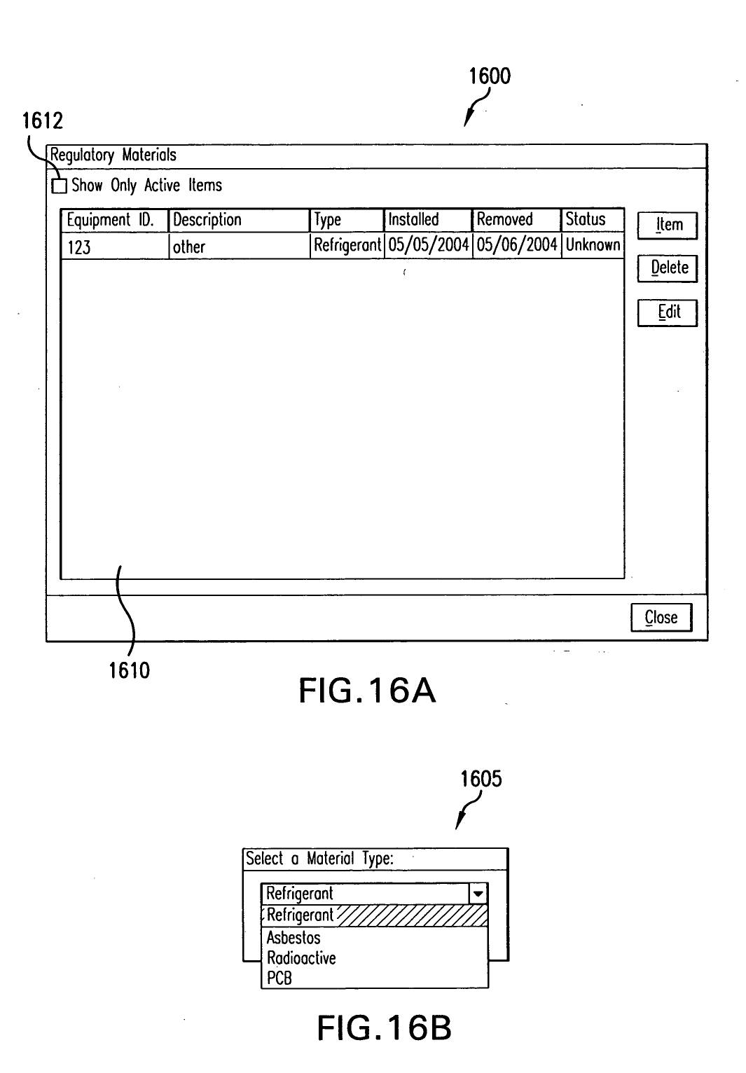

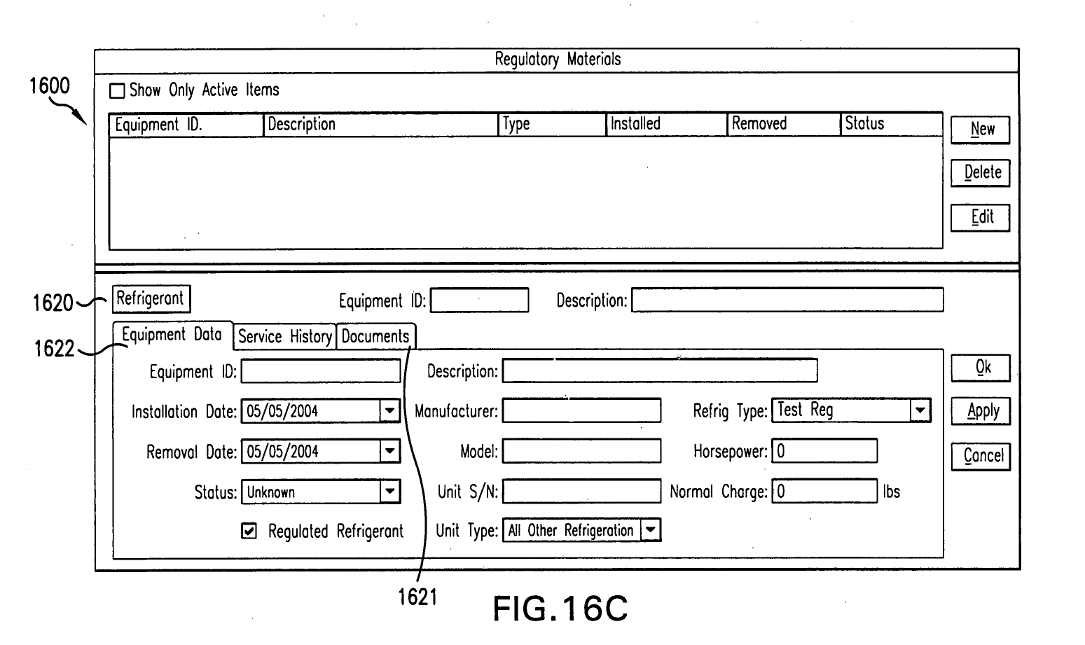

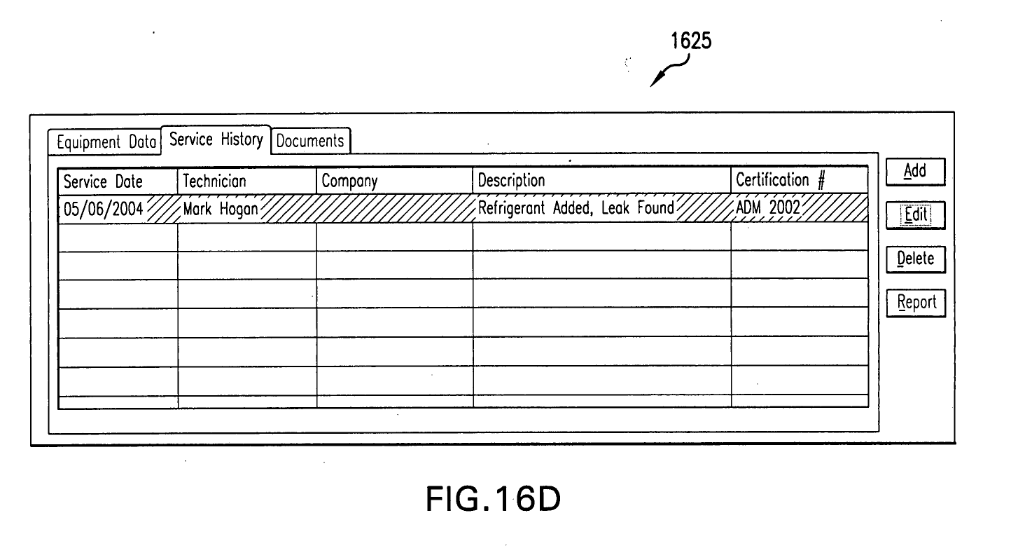

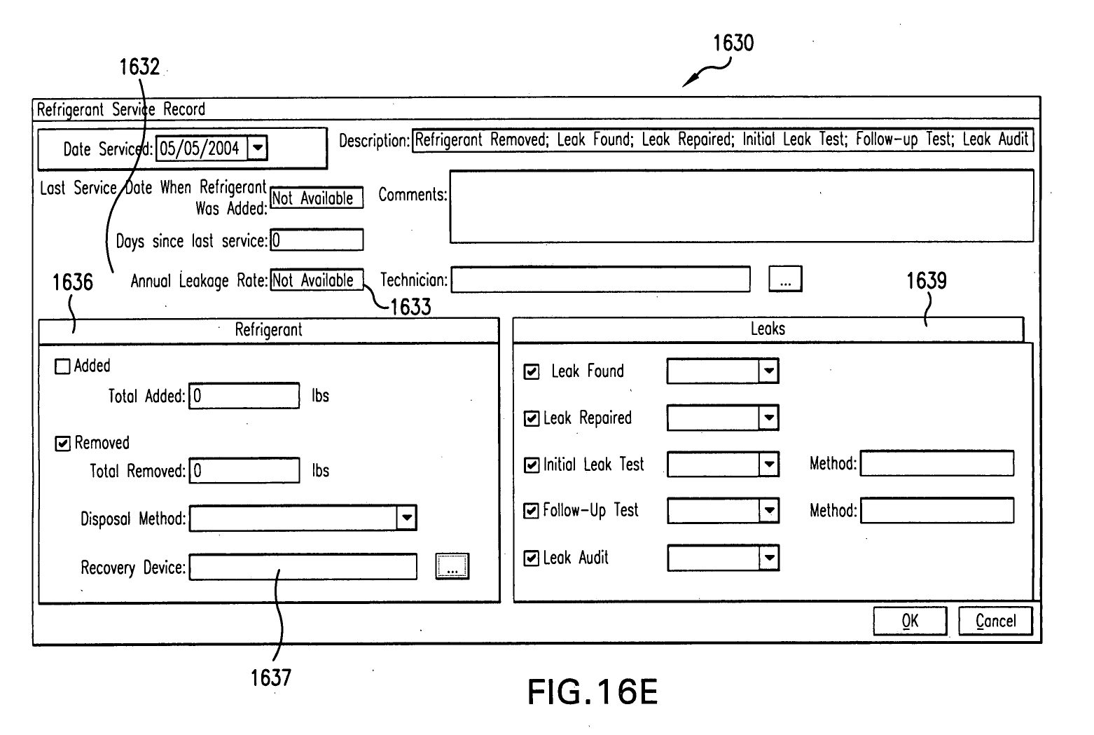

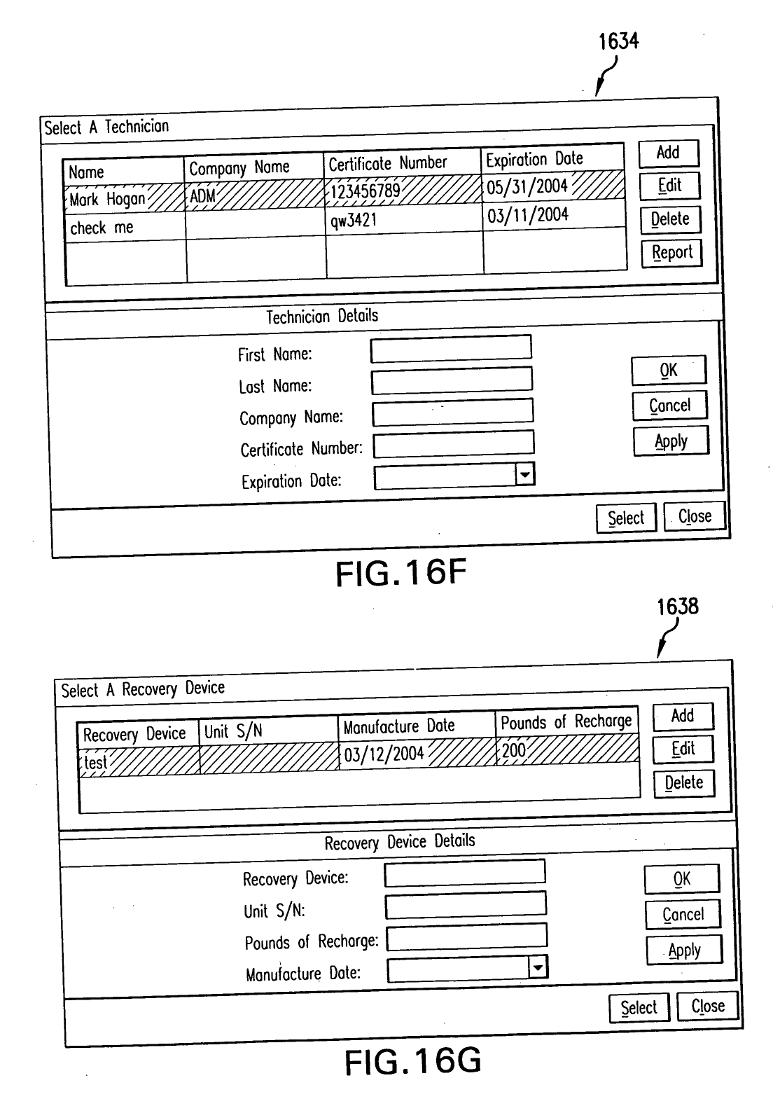

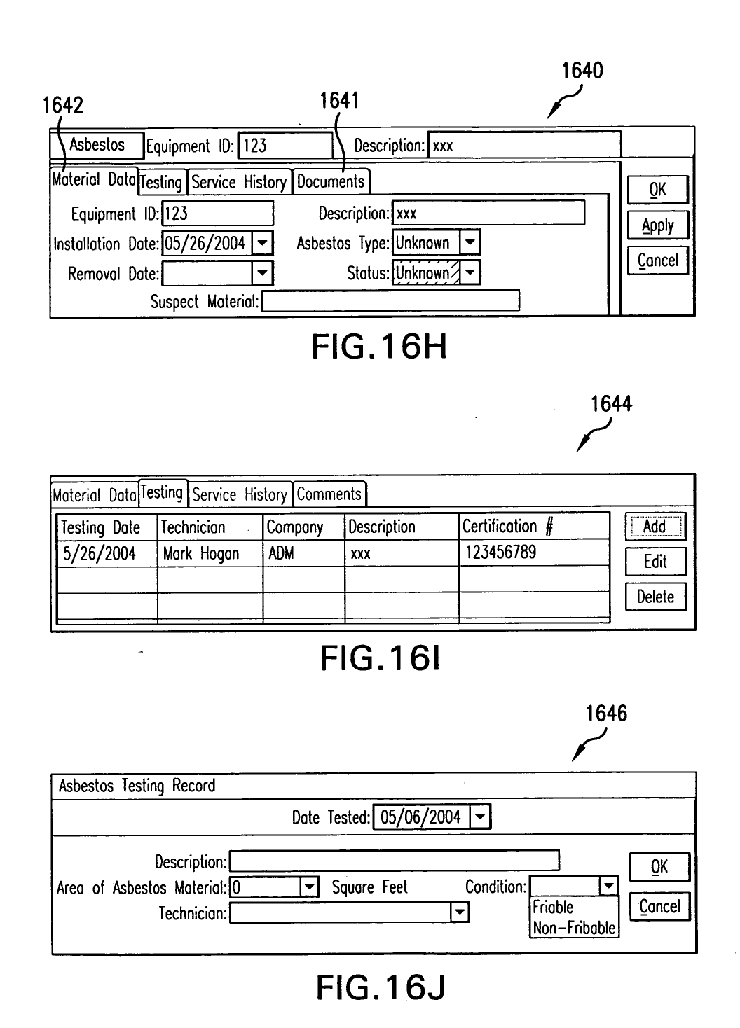

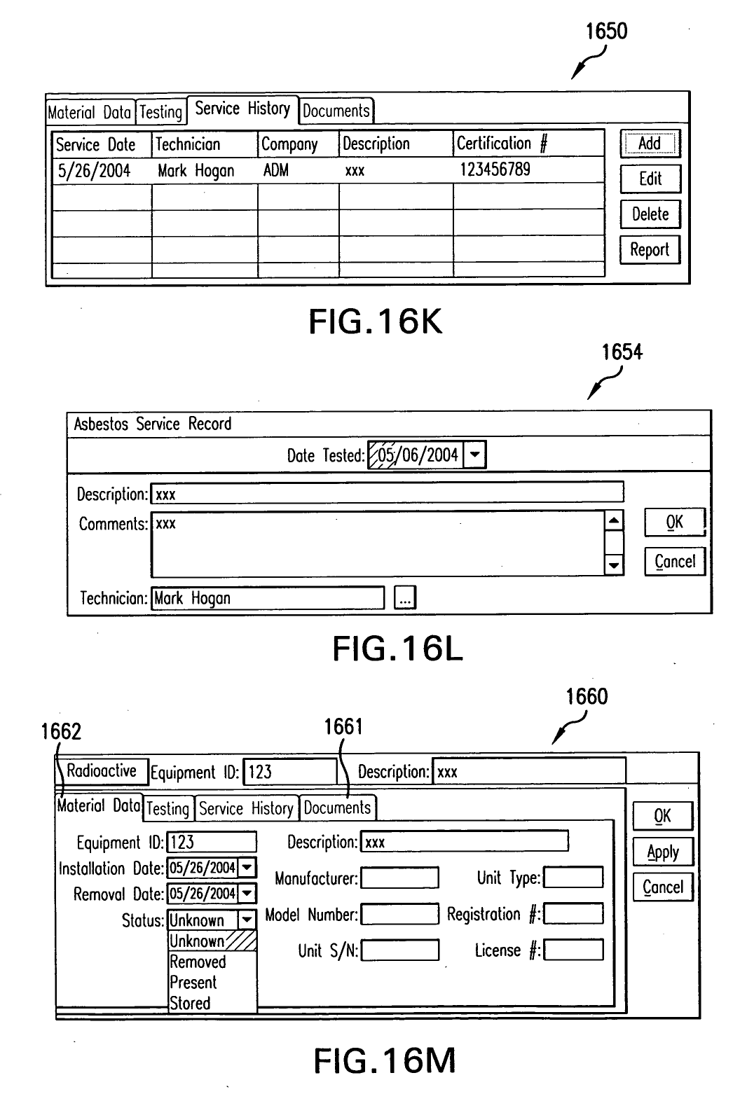

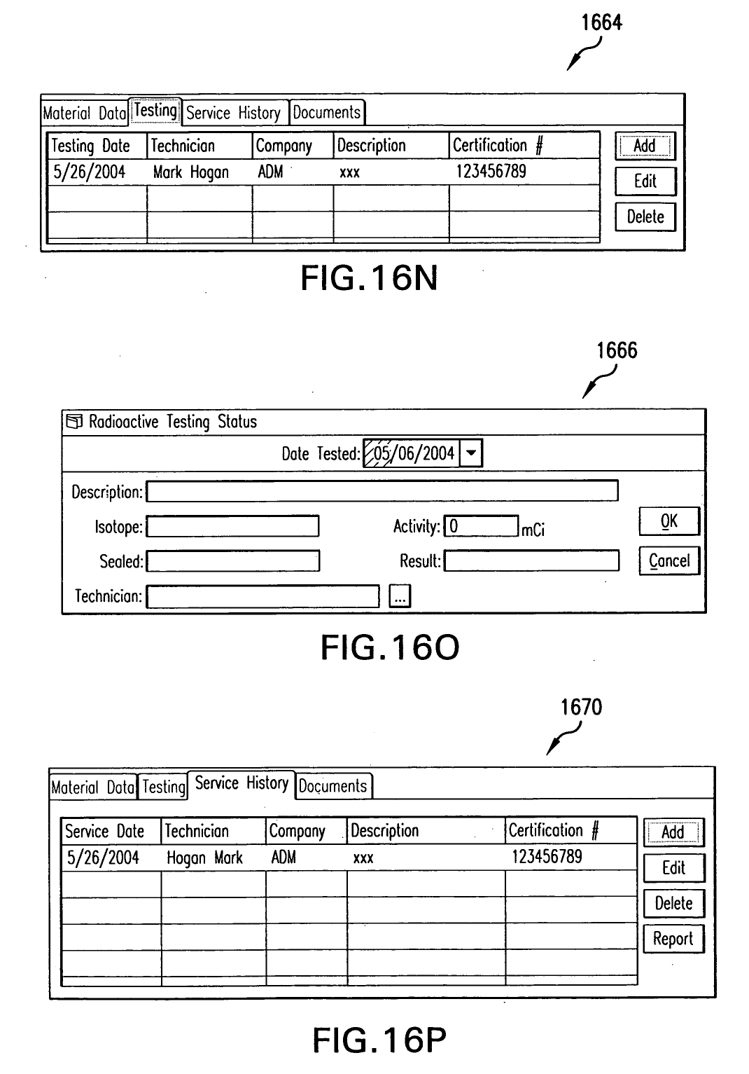

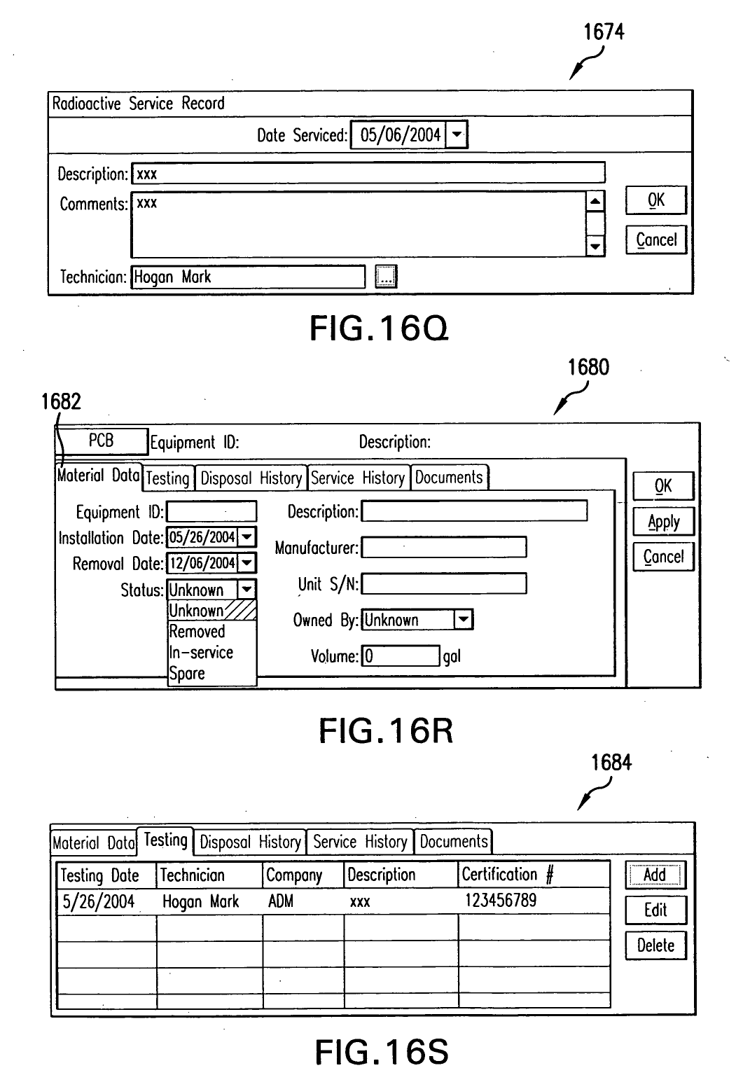

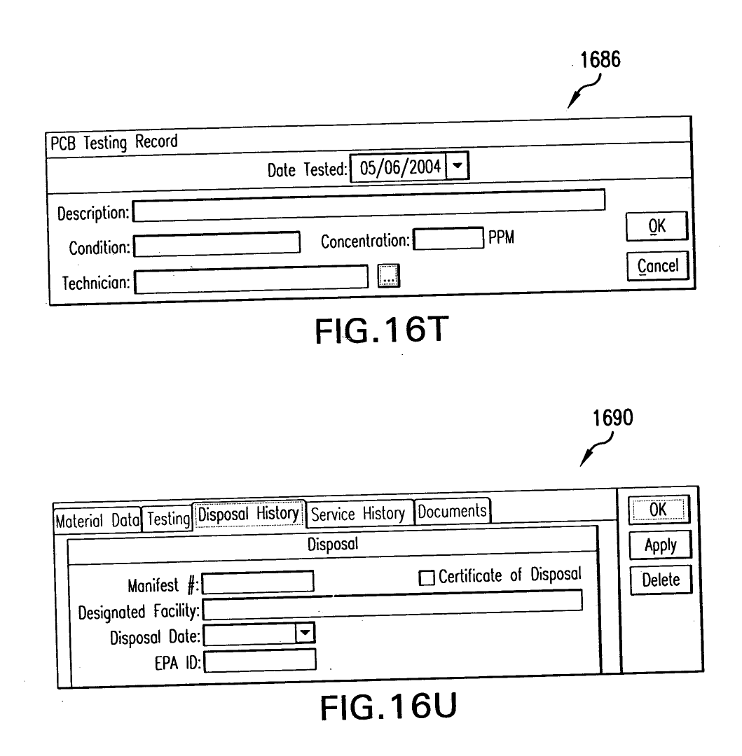

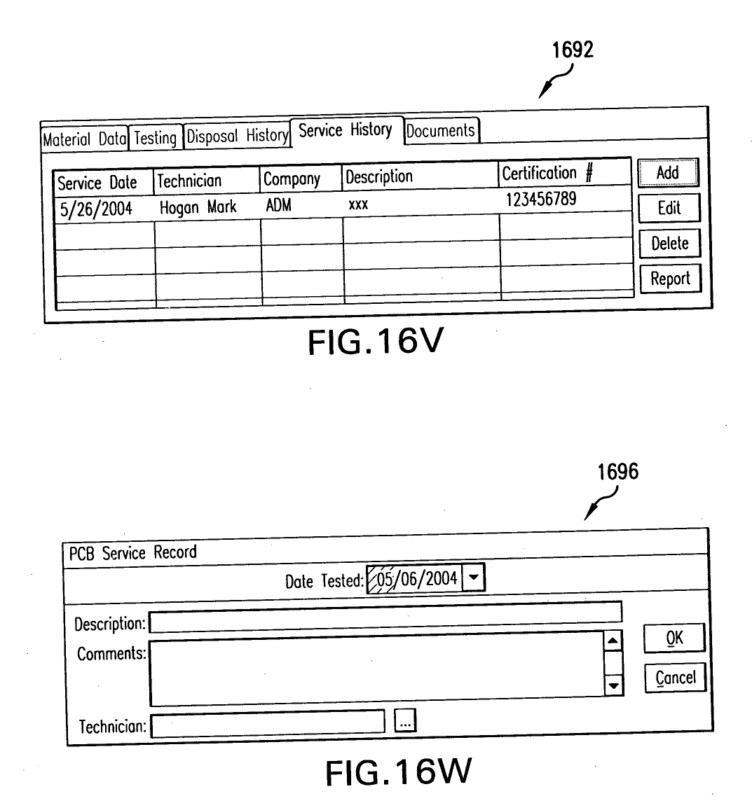

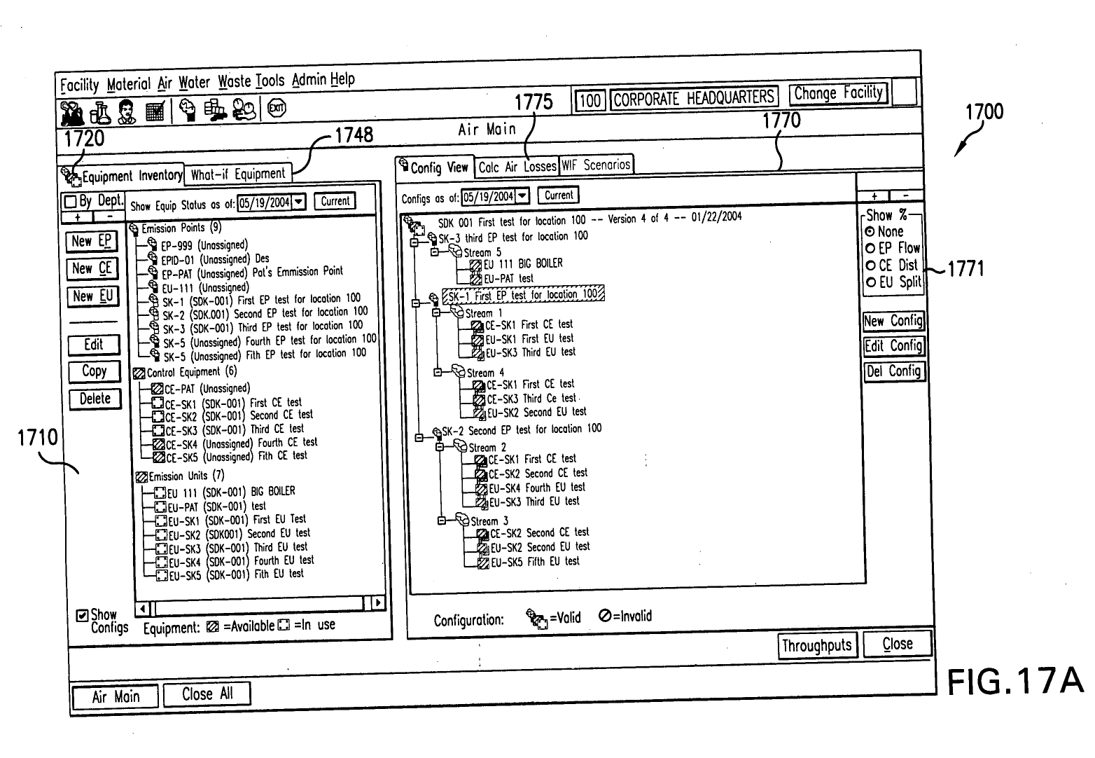

The user can access the Regulatory Material Tracking screen 1600 shown in FIG. 16A from the main screen 1000 by selecting the Regulatory Material item from the Material menu. The Regulatory Material Tracking screen 1600 contains previously entered regulatory information for the facility chosen.

The Regulatory list 1610 contains equipment ID, description, material type, installation date, removal date, and status for each list entry. When the Show Only Active Items checkbox 1612 is checked, only active items are displayed in the list 1610. When the user selects the New button, a Select a Material Type screen 1605 appears as illustrated in FIG. 16B. Before proceeding, the user must select a material type from the list.

If the user selects Refrigerant, a Refrigerant section 1620 is displayed as a frame in the Regulatory Material Tracking screen 1600. An illustrative Refrigerant section 1620 is shown in FIG. 16C. The Refrigerant section 1620 displays a Refrigerant record. In order to save a valid Refrigerant record, the Equipment ID, Installation Date, Status Description, Unit Type, Refrigerant Type and Normal Charger text boxes must be populated.

The Refrigerant section 1620 includes three tabs. The Documents tab 1621 is identical to the Documents tab described above in connection with the Facilities Setup screen. The Equipment Tab 1622 contains data related to the equipment including the Equipment ID, Description, Installation Date, Removal Date, if applicable, Manufacturer, Model, Unit Serial Number, Horsepower, and Normal Charge. The Status menu indicates the operational status of the equipment such as whether the equipment is in-service or removed. If the refrigerant is regulated, the Regulated Refrigerant checkbox should be marked. In the Unit Type menu, the user must select from Unknown, Industrial Process Refrigeration, or All Other Refrigeration. The entries in the Refrigerant Type menu include unknown, R-12, R-122, and R-134.

The Service History tab 1625, shown if FIG. 16D, lists the service date, technician, company, description, and certification number associated with each service record entry. A service record can be added to the list by activating the Add button. The user can edit an existing service record by activating the Edit button. The user can delete a service record by highlighting the entry and activating the Delete button. When the user selects either the Add or the Edit button, the Service Record screen 1630, shown in FIG. 16E, is displayed.

To add a new service record or save an edited service record, the user must populate the Technician field in the Service Record screen 1630. The Service Record screen 1630 contains a service information section 1632, a refrigerant section 1636, and a Leaks section 1639. The Leaks section 1639 contains information related to leaks. In the service information section, the Date Serviced, Days Since Last Service, and Annual Leakage Rate 1633 data fields are populated each time the user enters the Service Record. The Annual Leakage Rate 1633 is calculated using the following:

$$\frac{Pounds of Refrigerant in Normal Full Charge}{\begin{matrix}( Number of Days Since Refrigerant \\ was Last Added ) / 365\end{matrix}} \times 100$$

If the Annual Leakage Rate 1633 is greater than the trigger rate, a message appears in the service information section 1632. The trigger rate for the Industrial Process Refrigeration Unit Type is 35%. The trigger rate for the All Other Refrigeration Unit Type is 15%. An example message that may be displayed is “The Annual Leakage Rate is greater than the trigger rate . . . Please repair, retrofit or retire the system.”

The service information section 1632 also includes a Technician text box and associated Add, Edit, and Delete buttons. When the user selects either the Add or Edit button, the Select a Technician screen 1634 is displayed as illustrated in FIG. 16F. When the user first enters this screen for a facility, data fields on the screen are empty. To add a new technician or save an edit to an existing technician, the user must populate the First Name, Last Name, Certificate Number and Expiration Date fields. The user may also enter the company name on this screen. If the technician's certificate is expired, RMIS 130 will not permit the user to select that particular technician.

The Refrigerant section 1636 of the Service Record screen 1630, shown in FIG. 16E, contains details about the refrigerant including whether refrigerant was added or removed and the amount. When the user removes refrigerant, the Recovery Device 1637 becomes a required field. The Create/Edit a Recovery Device screen 1638, shown in FIG. 16G, is displayed when the user selects the Add or Edit button associated with the Recovery Device field 1637. When the user first enters this screen for a facility, data fields on the screen are empty. To add a recovery device or save edits to an existing recovery device, the user must populate the Recovery Device, Manufacture Date, and Pounds of Recharge data fields. The user may also enter the Unit Serial Number.

If the user selects Asbestos from the Select a Material Screen 1605 shown in FIG. 16B, an Asbestos section 1640 is displayed as a frame on the Regulatory Material Tracking screen 1600. An illustrative Asbestos section 1640 is shown in FIG. 16H. The Asbestos section 1640 includes four tabs. The Documents tab 1641 is identical to the Documents tab described above in connection with the Facilities Setup screen.

The Material Data tab 1642 includes Equipment ID, Description, Installation Date, Removal Date, if applicable, Asbestos Type, Suspect Material and Status data fields. The available Asbestos types are Unknown, Amosite, Chrysotile, and Crocidolite. The available Status types are Unknown, Removed, Present, Encased, and Encapsulated.

The Testing tab 1644, shown in FIG. 161, lists the testing date, technician, company, description, and certification number associated with each testing history entry. A testing history record is added by activating the Add button. An existing testing history record can be edited by activating the Edit button. A testing history record is removed by highlighting the entry and activating the Delete button. When either the Add or the Edit button is activated, the Asbestos Testing Record screen 1646, shown in FIG. 16J, is displayed.

The Asbestos Testing Record screen 1646 includes Date Tested, Description, Area of Asbestos Material, and Condition text boxes. In addition, this screen also includes a Technician text box and associated Add, Edit, and Delete buttons. The operation of the Technician text box is described above in relation to the Refrigerant section.

The Service History tab 1650, shown in FIG. 16K, lists the service date, technician, company, description, and certification number associated with each Asbestos service record entry. The user can add a new service record by activating the Add button. The user can edit a service record by activating the Edit button. The user can delete a service record by highlighting the entry and activating the Delete button. When the user selects either the Add or the Edit button, the Asbestos Service Record screen 1654, shown in FIG. 16L, is displayed.

The Asbestos Service Record screen 1654 includes Date Serviced, Description, and Comments text boxes. In addition, this screen also includes a Technician text box and associated Add, Edit, and Delete buttons. The operation of the Technician text box and associated buttons is described above in relation to the Refrigerant section.

If the user selects Radioactive from the Select a Material screen 1605 shown in FIG. 16B, an Radioactive section 1660 is displayed as a frame on the Regulatory Material Tracking screen 1600. An illustrative Radioactive section 1660 is shown in FIG. 16M. The Radioactive section 1660 includes four tabs. The Documents tab 1661 is identical to the Documents tab described above in connection with the Facilities Setup screen.

The Material Data tab 1662 includes the Equipment ID, Description, Installation Date, Removal Date, if applicable, Manufacturer, Unit Type, Model Number, Registration Number, Unit Serial Number, License Number and Status fields. The available Status types are Unknown, Removed, Present, and Stored. The Testing tab 1664, shown in FIG. 16N, lists the testing date, technician, company, description, and certification number associated with each testing history entry. The user can add a testing history record by activating the Add button. The user can edit a testing history record by activating the Edit button. The user can delete a testing history record by highlighting the entry and activating the Delete button. When the user selects either the Add or the Edit button, the Radioactive Testing Record screen 1666, shown in FIG. 160, is displayed.

The Radioactive Testing Record screen 1666 contains Date Serviced, Description, Isotope, Activity, Sealed, and Results text boxes. In addition, this screen also includes a Technician text box and associated Add, Edit, and Delete buttons. The operation of the Technician text box is described above in relation to the Refrigerant section.

The Service History tab 1670, shown in FIG. 16P, lists the service date, technician, company, description, and certification number associated with each Radioactive service record entry. The user can add a service record by activating the Add button. The user can edit a service record by activating the Edit button. The user can delete a service record by highlighting the entry and activating the Delete button. When the user selects either the Add or the Edit button, the Radioactive Service Record screen 1674, shown in FIG. 16Q, is displayed.

The Radioactive Service Record screen 1674 contains Date Serviced, Description, and Comments text boxes. In addition, this screen also includes a Technician text box and associated Add, Edit, and Delete buttons. The operation of the Technician text box and associated buttons is described above in relation to the Refrigerant section.

If the user selects PCB from the Select a Material Screen 1605 shown in FIG. 16B, a PCB section 1680 is displayed as a frame on the Regulatory Material Tracking screen 1600. An illustrative PCB section 1680 is shown in FIG. 16R. The PCB section 1680 includes five tabs. The Documents tab is identical to the Documents tab 1370 described above in connection with the Facilities Setup screen 1300.

The Material Data tab 1682 includes Equipment ID, Description, Installation Date, Removal Date, if applicable, Manufacturer, Volume, Unit Serial Number, Status and Owned By text boxes. The available Owned By types are Facility, Utility, and Property Owner. The available Status types are Unknown, Removed, In-Service, and Spare.

The Testing tab 1684, shown in FIG. 16S, lists the testing date, technician, company, description, and certification number associated with each testing history entry. The user can add a testing history record by activating the Add button. The user can edit a testing history record by activating the Edit button. The user can delete a testing history record by highlighting the entry and activating the Delete button. When the user selects either the Add or the Edit button, the PCB Testing Record screen 1686, shown in FIG. 16T, is displayed.

The PCB Testing Record screen 1686 includes Date Tested, Description, Concentration, and Condition text boxes. In addition, this screen also includes a Technician text box and associated Add, Edit, and Delete buttons. The operation of the Technician text box is described above in relation to the Refrigerant section.

The Disposal History Tab 1690, shown in FIG. 16U, contains Manifest Number, Designated Facility, Disposal Date, EPA Identification, and Certificate of Disposal text boxes. The Service History tab 1692, shown in FIG. 16V, lists service date, technician, company, description, and certification number associated with each PCB service record entry. The user can add a service record by activating the Add button. The user can edit a service record by activating the Edit button. The user can delete a service record by highlighting the entry and activating the Delete button. When the user selects either the Add button or the Edit button, the PCB Service Record screen 1696, shown in FIG. 16W, is displayed.

The PCB Service Record screen 1696 contains Date Serviced, Description, and Comments text boxes. In addition, this screen also includes a Technician text box. The operation of the Technician text box and associated buttons is described above in relation to the Refrigerant section.

Air Menu

The Air menu on the main screen 1000 contains a list of screens associated with RMIS Air functionality. From this menu, the user can navigate to the Air screen.

When the user selects the Air item in the Air menu on the main screen 1000, the Air Main Screen 1700 is displayed to the user. The Air Main Screen includes an Equipment section 1710 and an Informational section 1770. The Equipment section 1710 includes an Equipment Inventory tab 1720 and a What-If Equipment tab 1748. In an alternative embodiment, the Equipment Inventory tab 1720 includes a sorting section. The sorting section provides a Sort menu and a Show for Configuration menu. On the Equipment Inventory tab 1720, equipment is sorted into four groups: emission points, monitoring equipment, control equipment, and emission units. A user can add a new entry into a group by selecting the New button associated with that group. For example, a user can add a new emission point by selecting the New EP button.

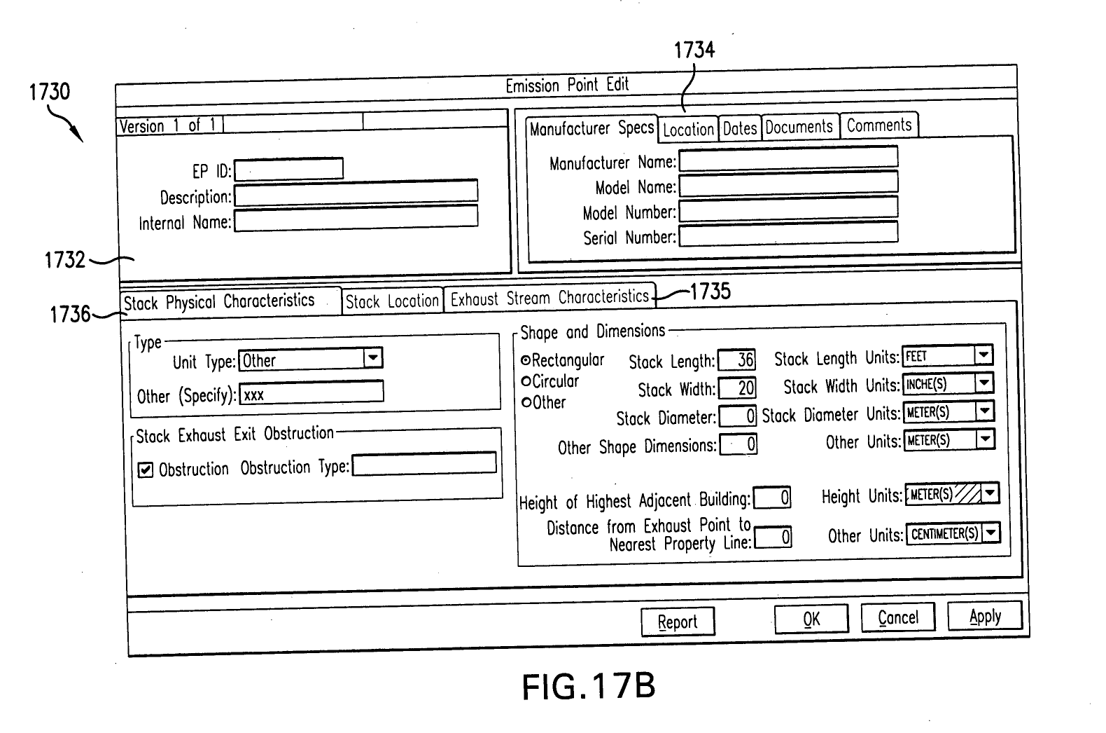

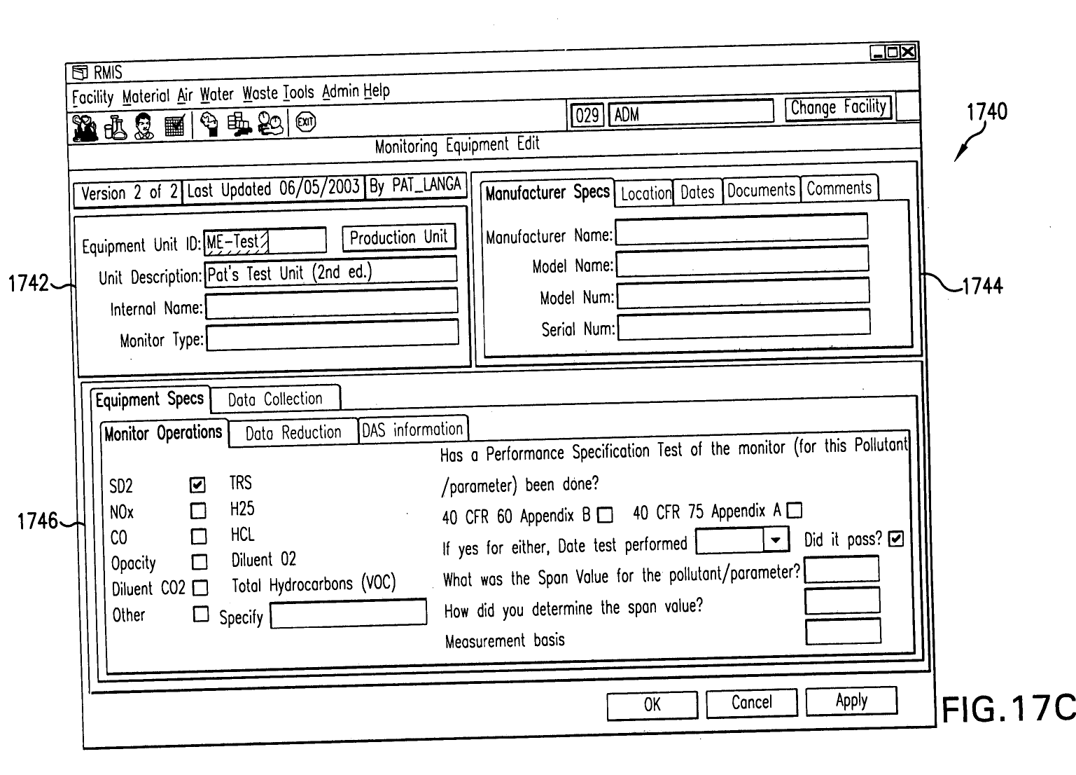

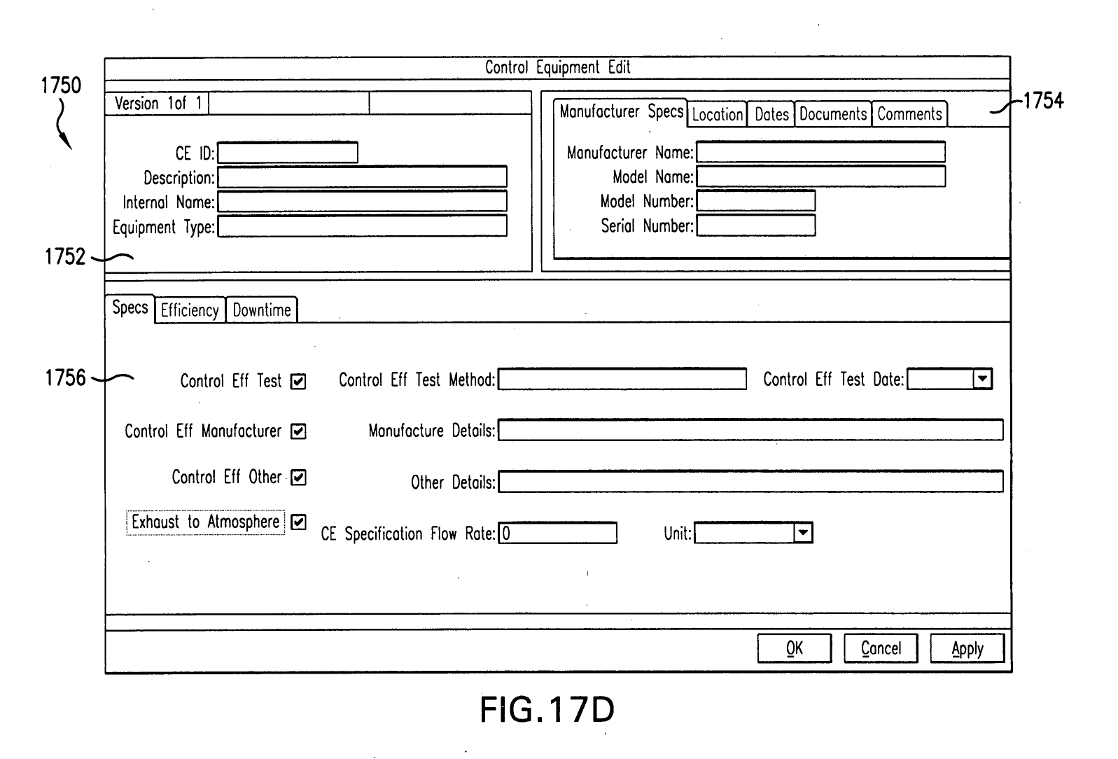

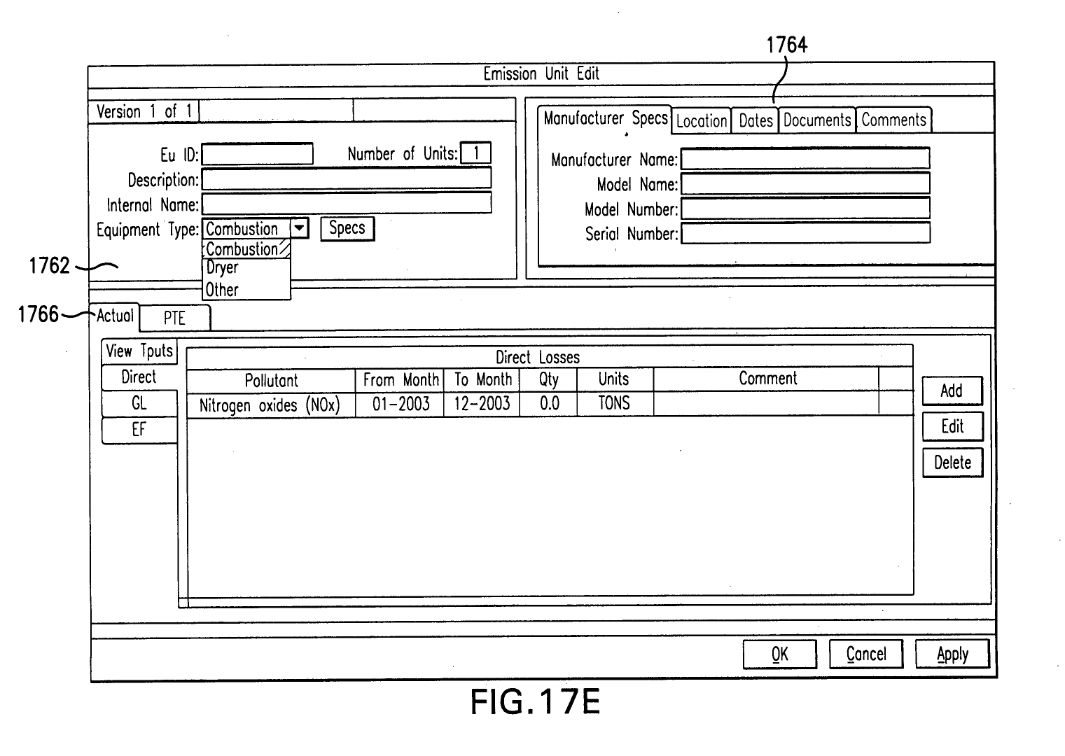

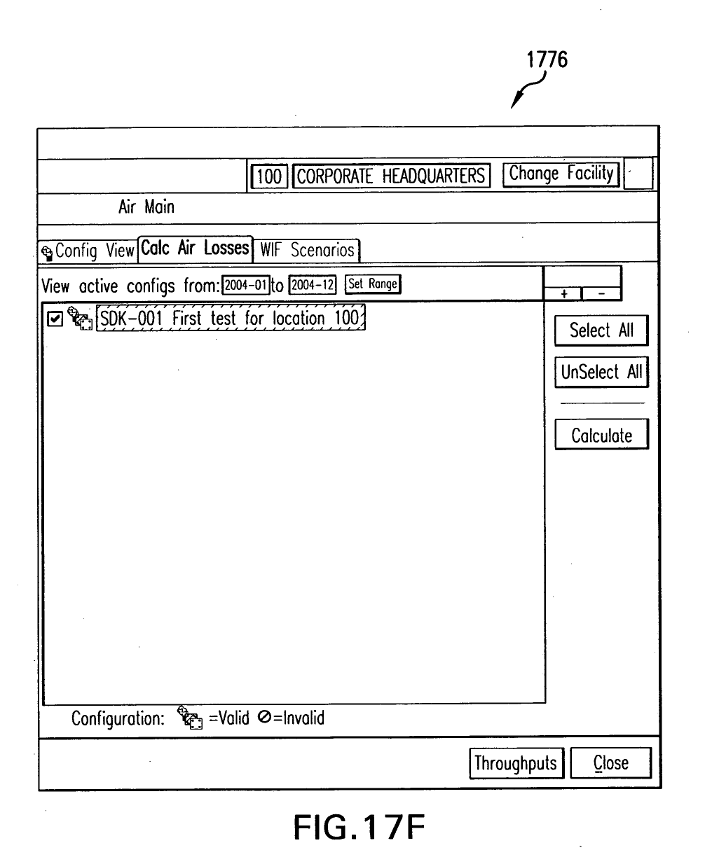

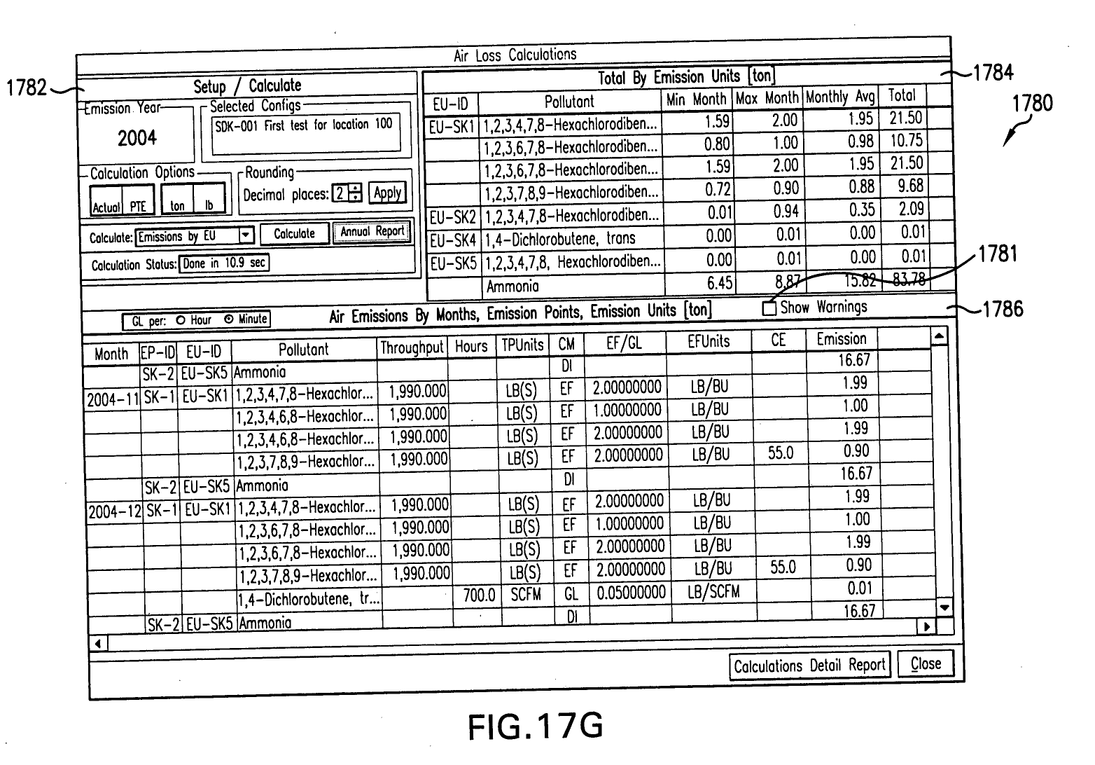

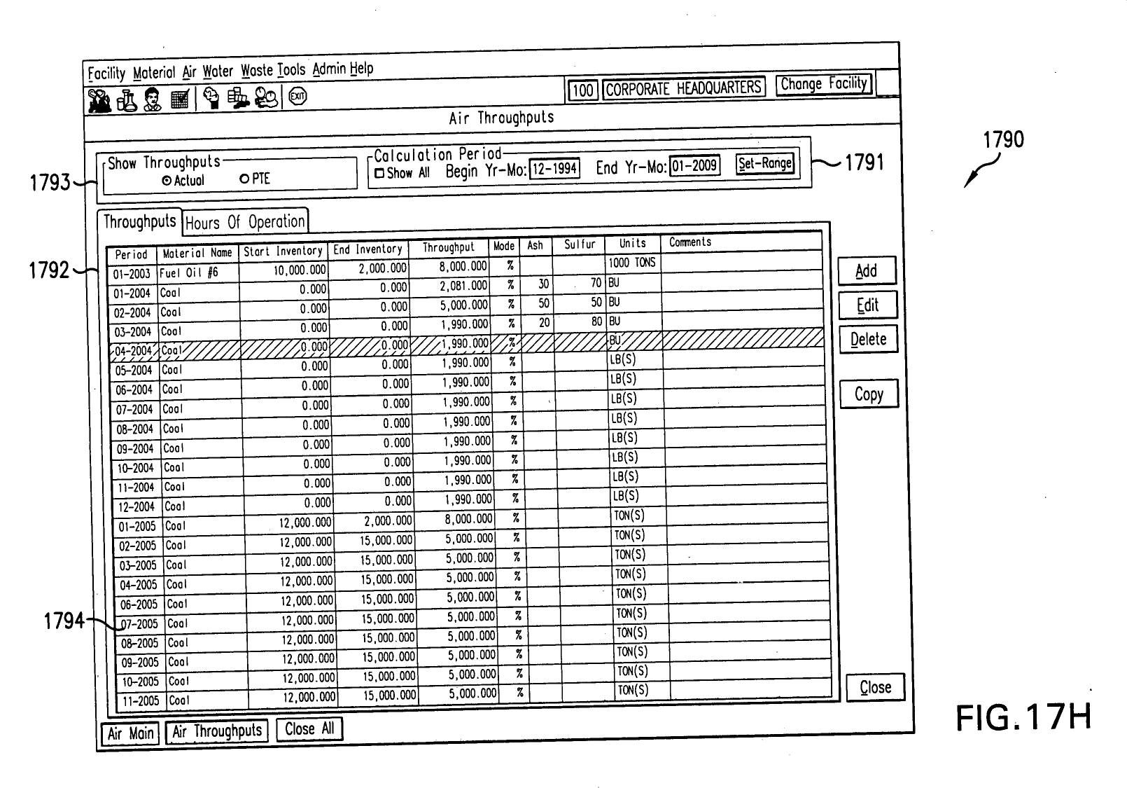

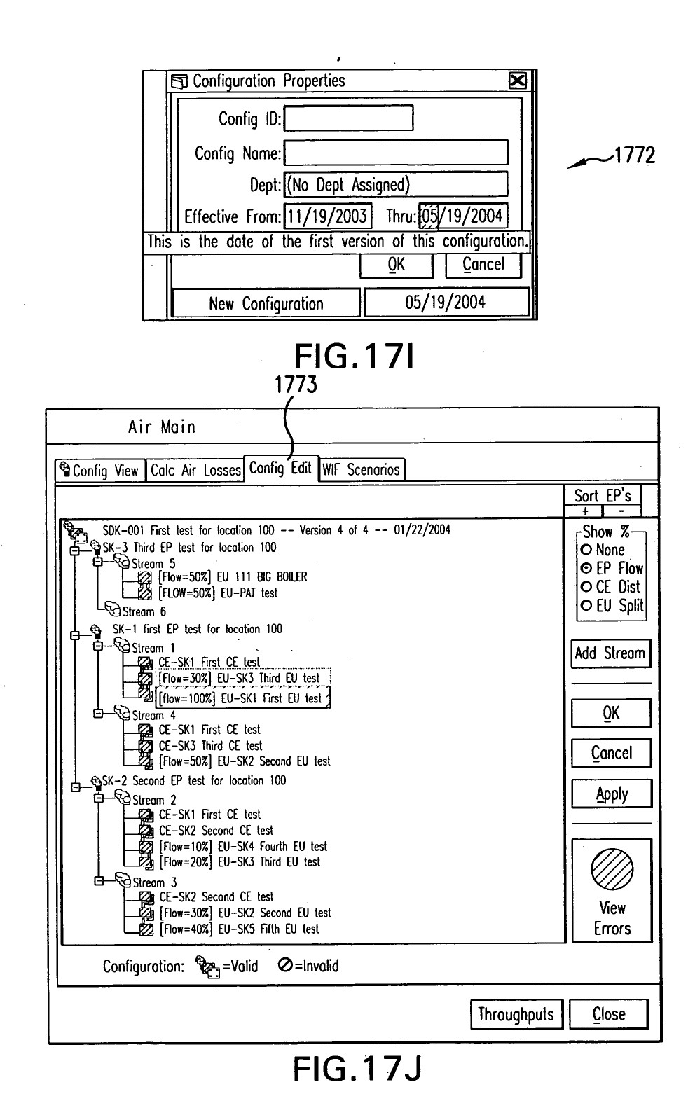

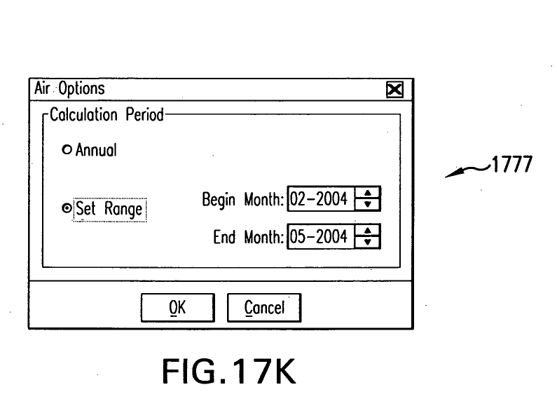

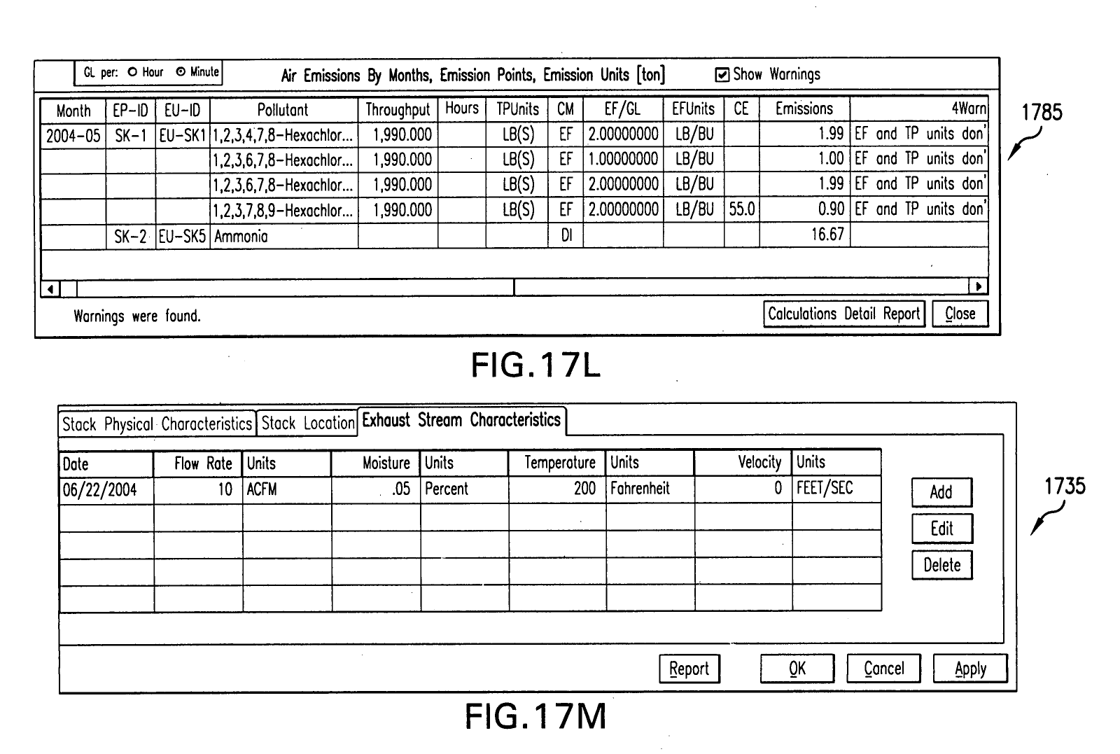

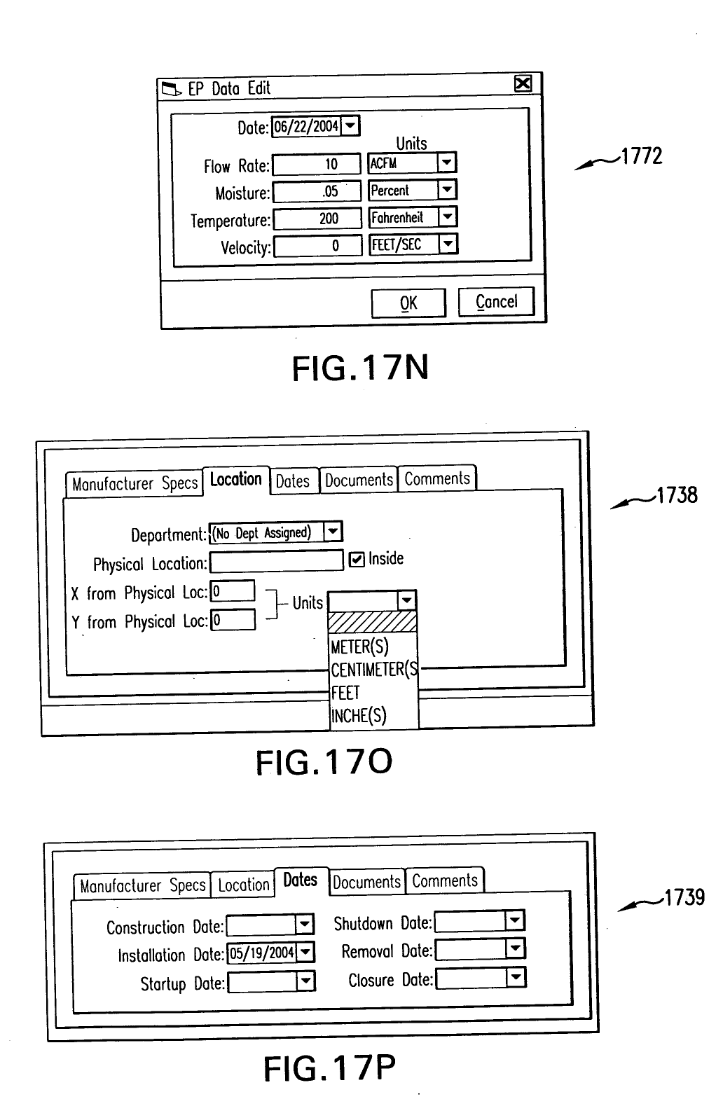

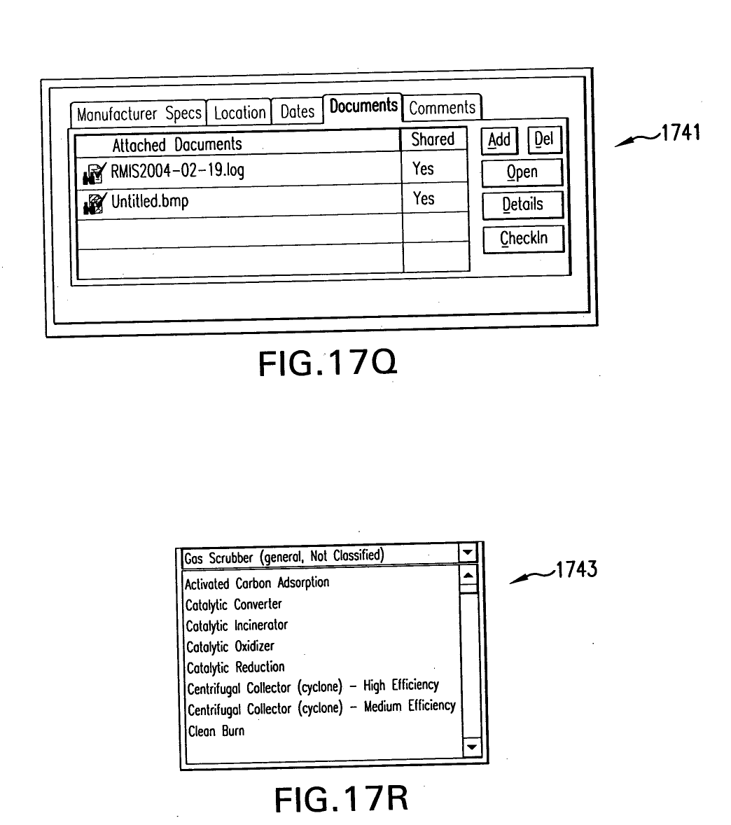

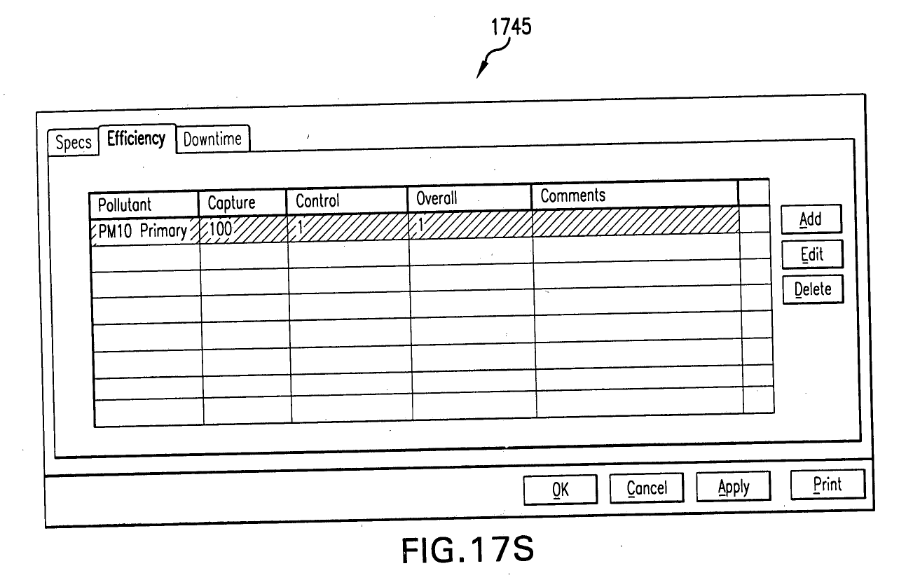

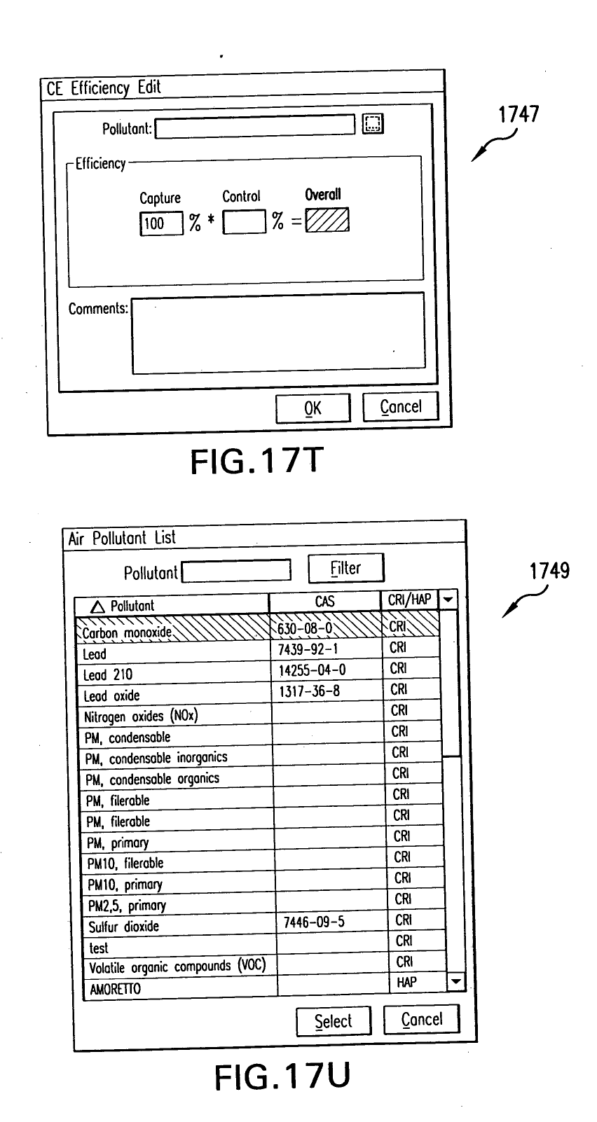

When the user selects the New EP button or edits an existing emission point entry, the Emission Point Edit screen 1730, shown in FIG. 17B, is displayed. The screen includes an information section 1732, a section with five tabs 1734, and a section with three tabs 1736. The information section 1732 contains EP ID, Description, and Internal Name text boxes. In addition, the information section 1732 may include a Production Unit button. The first tab section 1734 includes Manufacturer Specs, Location, Date, Documents, and Comments tabs. These taps are common to Emission Point Edit screen, Monitoring Equipment Edit screen, Control Equipment (CE) Edit screen, and Emission Unit Edit screen. The ME, CE, and EU edit screens are discussed in further details below. The second tab section 1736 includes a Stack Physical Characteristics tab, a Stack Location tab, and an Exhaust Stream Characteristics tab.

The Stack Physical Characteristics tab allows the user to specify unit type, shape and dimensions, and stack exhaust exit obstruction if any. For unit type, the user may select from a menu with the following, but not exhaustive, selections: fugitive, vertical, horizontal, goose neck, vertical with raincap, downward-facing vent or other. For specifying shape, the user may select rectangular, circular, or other. For specifying dimensions, the user may select from a dropdown menu with unit measurements.

The Stack Location tab allows the user to input data about location of the stack, such as latitude, longitude, and height. The Exhaust Stream Characteristics tab 1735, as shown in FIG. 17M, allows the user to view, add, or edit data concerning the characteristics of an exhaust stream such as flow rate, moisture, temperature, velocity, and date. Characteristics tab 1735 includes Add, Edit, and Del buttons for adding, editing, and deleting stream characteristics. When the user selects the Edit button, the EP Data Edit screen 1737, as shown in FIG. 17N, is displayed. From this screen the user may edit any of the stream characteristics listed above.

The Manufacturer Specs tab of section 1734, as shown in FIG. 17B, allows the user to enter manufacturer specifications data such as manufacturer name, model name, model number, and serial number. The Location tab 1738, as shown in FIG. 170, allows the user to enter location details. The Date tab 1739, as shown in FIG. 17P, allows the user to enter all appropriate dates, including but not limited to construction date, installation date, and startup date. The Documents tab 1741, as shown in FIG. 17Q, allows user to attach, delete, check-in, check-out, and view documents details.

When the user selects the New ME button or edits an existing monitoring equipment entry on the Air screen 1700, the Monitoring Equipment edit screen 1740, shown in FIG. 17C, is displayed. The screen includes an information section 1742, a section with five tabs 1744, and a section with two tabs 1746. The information section 1742 contains Equipment Unit ID, Unit Description, Internal Name, and Monitor Type text boxes. In addition, the information section may include a Production Unit button. The first tab section 1744 includes Manufacturer Specification, Location, Date, Documents, and Comments tabs. The second tab section 1746 includes an Equipment Specification tab and a Data Collection tab. The Equipment Specification tab includes the following three sub tabs: Monitor Operations, Data Reduction, and DAS Information.

When the user selects the New CE button or edits an existing control equipment entry on the Air screen 1700, the Control Equipment Edit screen 1750, shown in FIG. 17D, is displayed. The screen includes an information section 1752, a section with five tabs 1754, and a section with three tabs 1756. The information section 1752 contains CE ID, Description, Internal Name, and Equipment Type textbox. In addition, the information section includes a Production Unit button. The first tab section 1754 includes Manufacturer Specs, Location, Dates, Documents, and Comments tabs. These five tabs are common to the five tabs of section 1734 described in details above.

The Equipment Type textbox 1743, as shown in FIG. 17R, allows the user to select, add, or edit to the equipment type dropdown list. Once an equipment entry is added or edited, an error check is run and the user is permitted to view the errors and resolve them, or cancel the entry.

The second tab section 1756 includes an equipment Specs tab, Efficiency tab, and Downtime tab. The Specs tab allows the user to input data about the equipment specification such as control efficiency test method, manufacturer details, CE specification flow rate, and unit. The Downtime tab allows the users to view, add, or edit downtime information on a piece of control equipment. The Efficiency tab 1745, as shown in FIG. 17S, allows the user to input data about the efficiency of a piece of control equipment. The Efficiency tab 1745 includes Add, Edit, and Del buttons for adding, editing, and deleting efficiency data. When the user selects the Edit button, the CE Efficiency Edit screen 1747, as shown in FIG. 17T, is displayed. This screen allows the user to select the type of pollutant and to calculate the overall efficiency as well as to input any comments. The CE Efficiency Edit screen 1747 also includes a Pollutant ellipse button where the user may call up the Air Pollutant List 1749, as shown in FIG. 17U. The Air Pollutant List 1749 provides the user with a comprehensive list of pollutants and the pollutant classification for each of the pollutants, such as hazardous air pollutants or others.

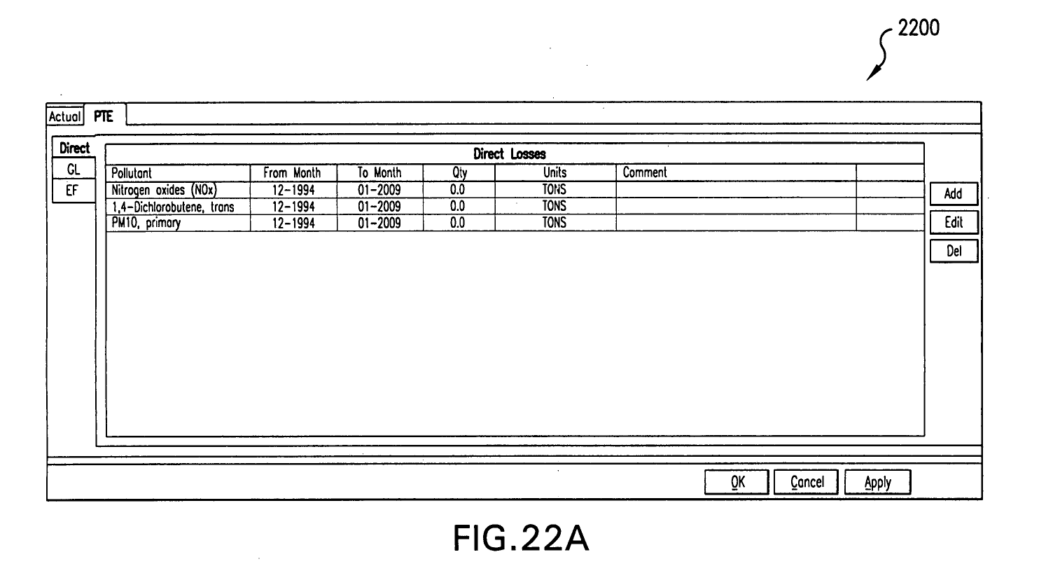

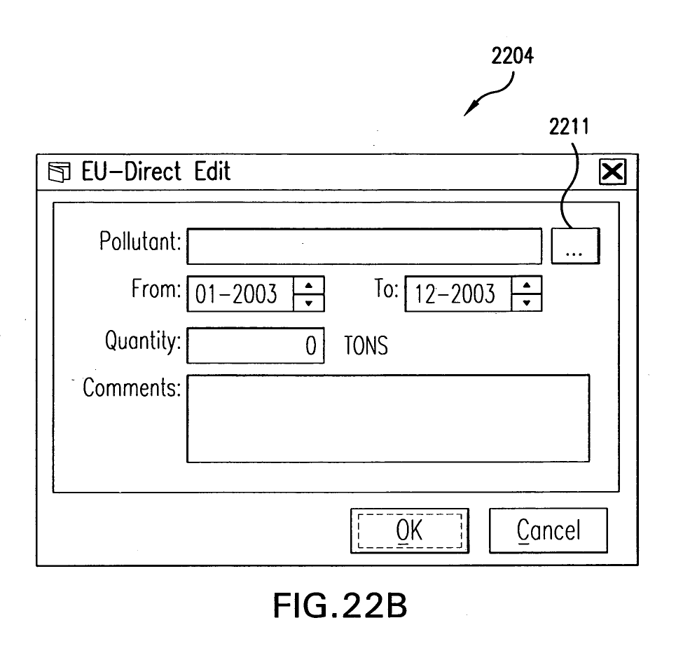

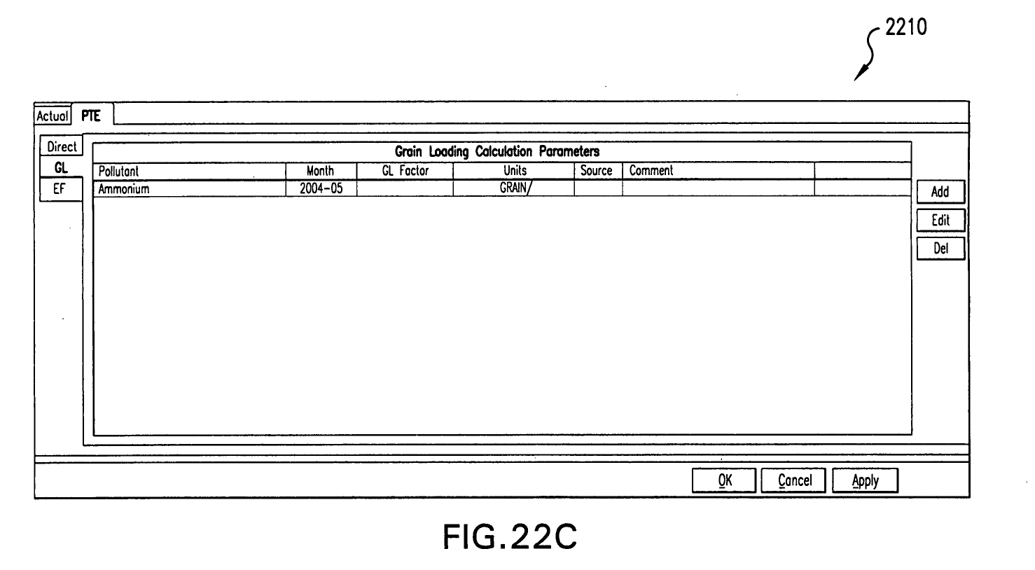

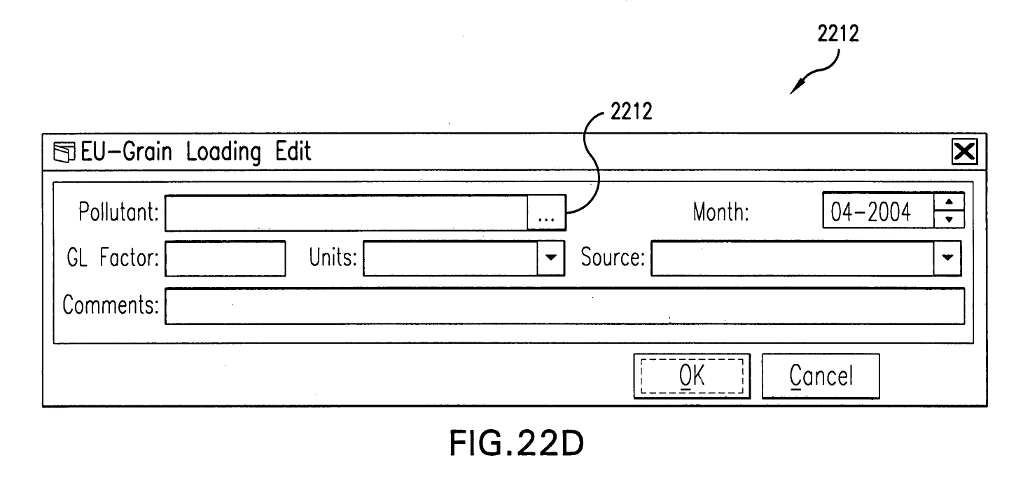

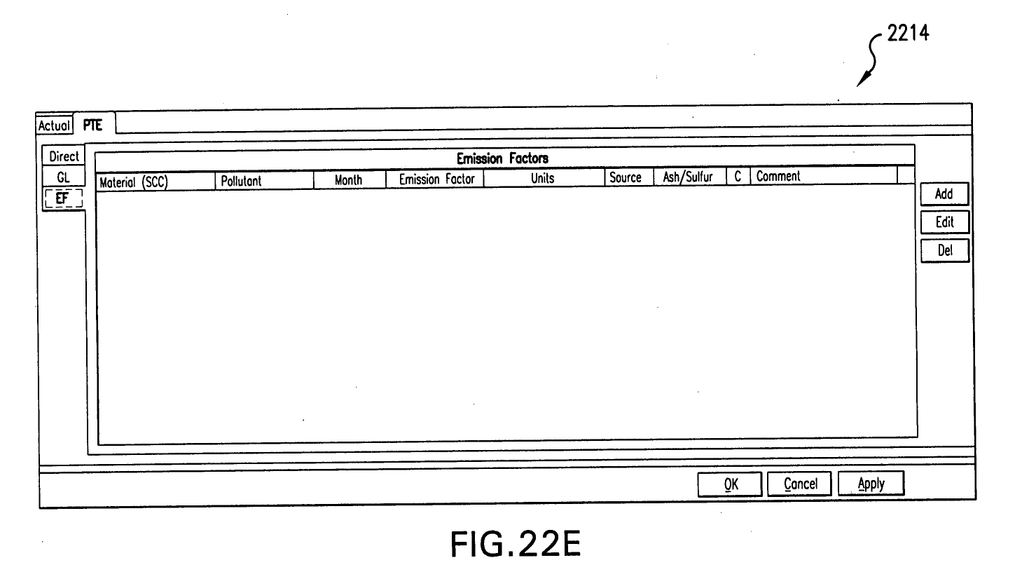

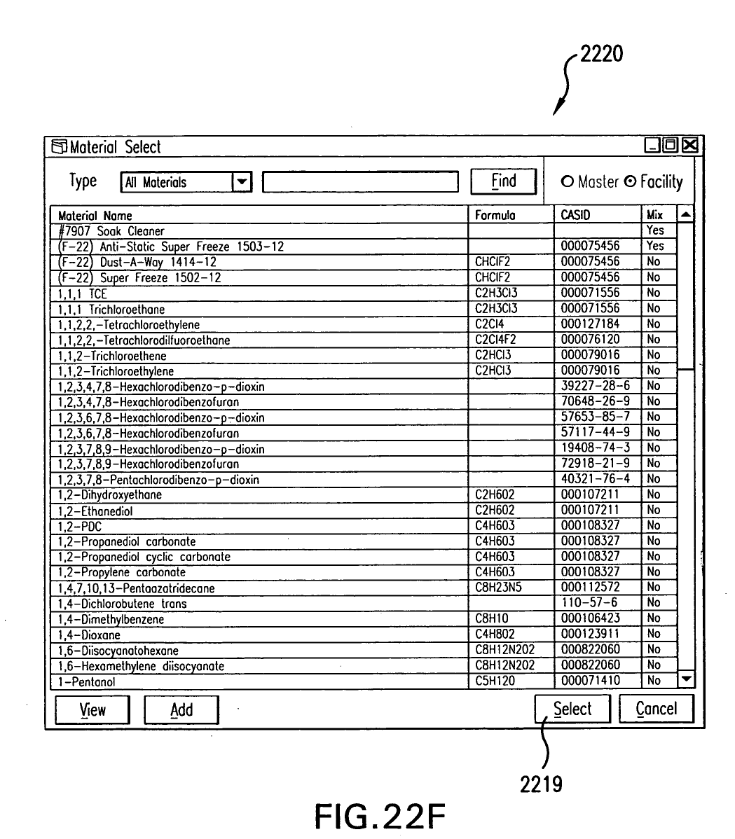

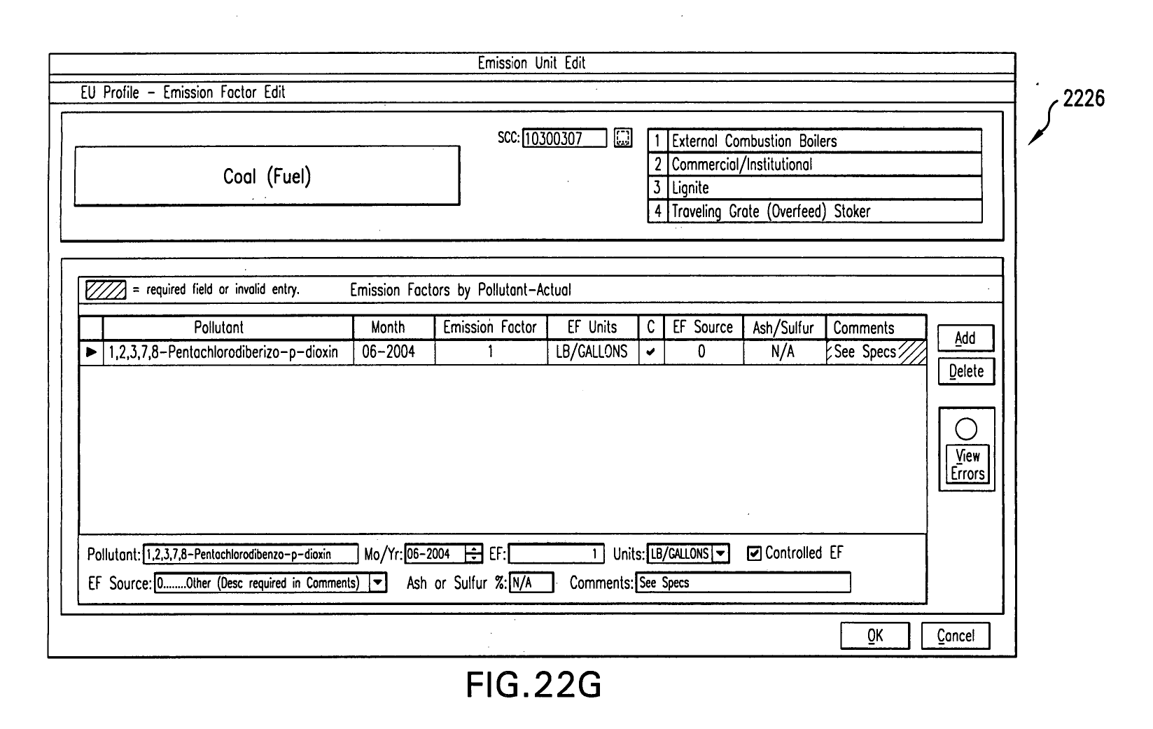

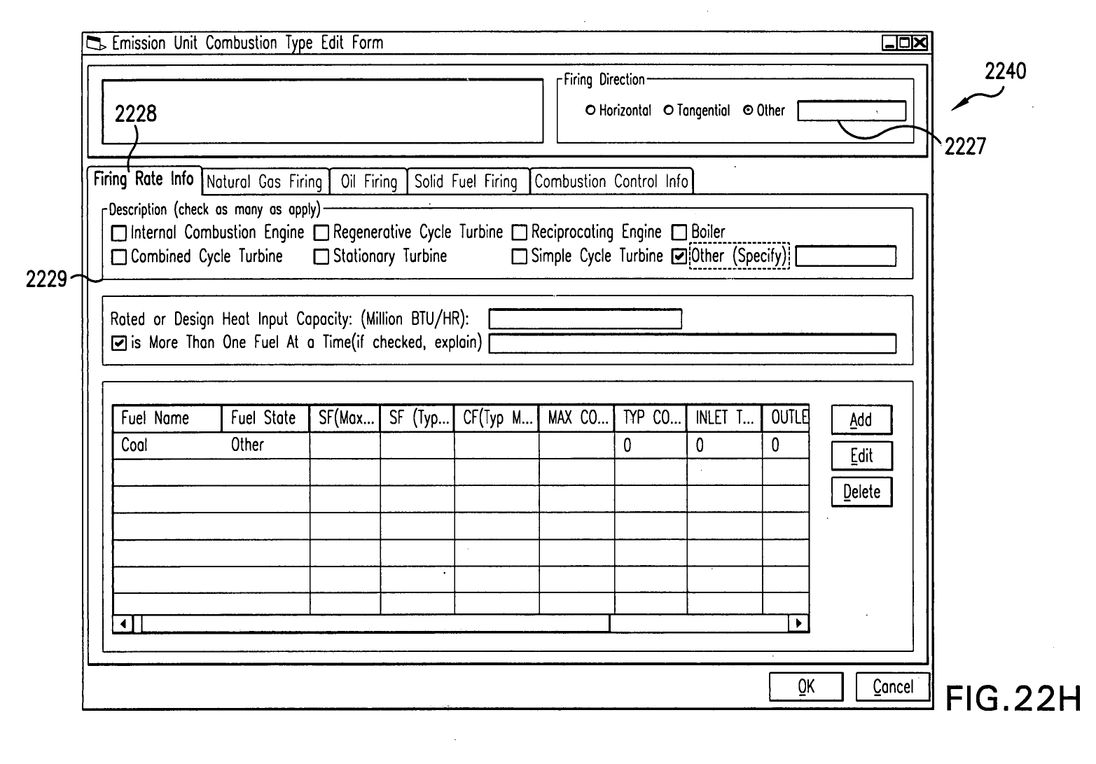

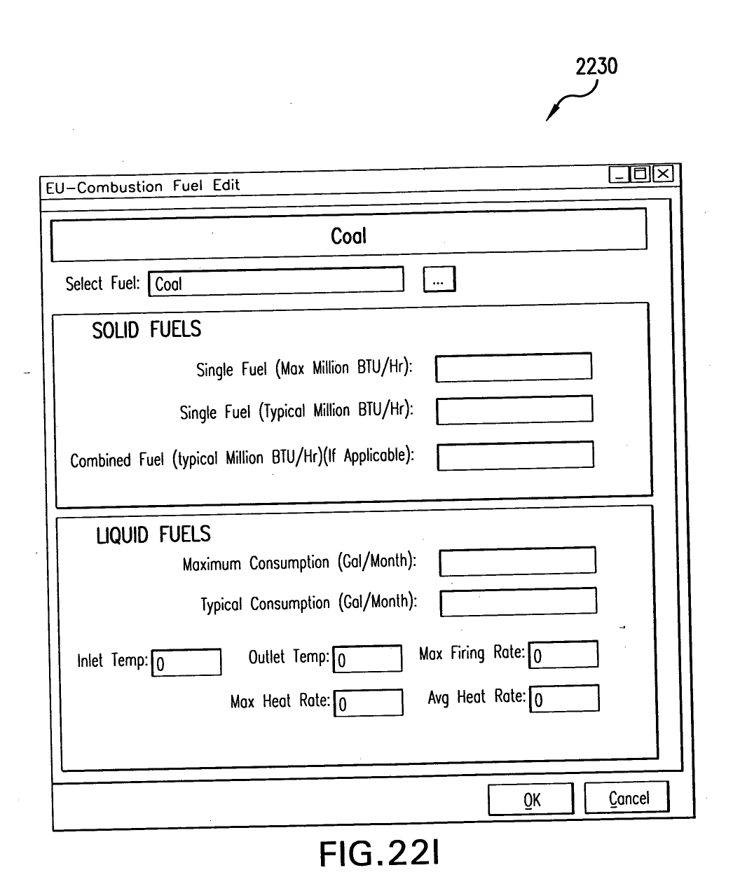

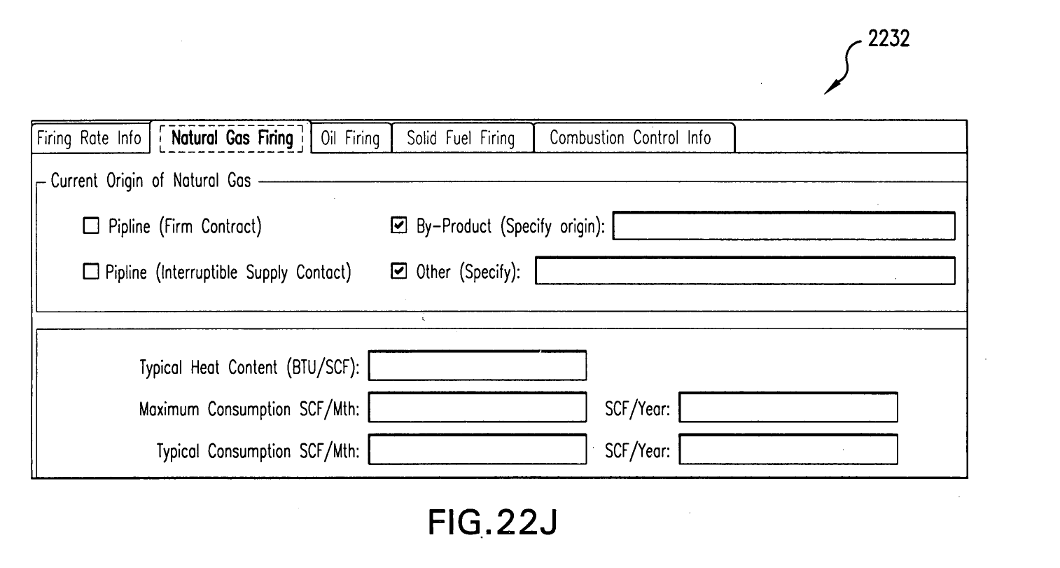

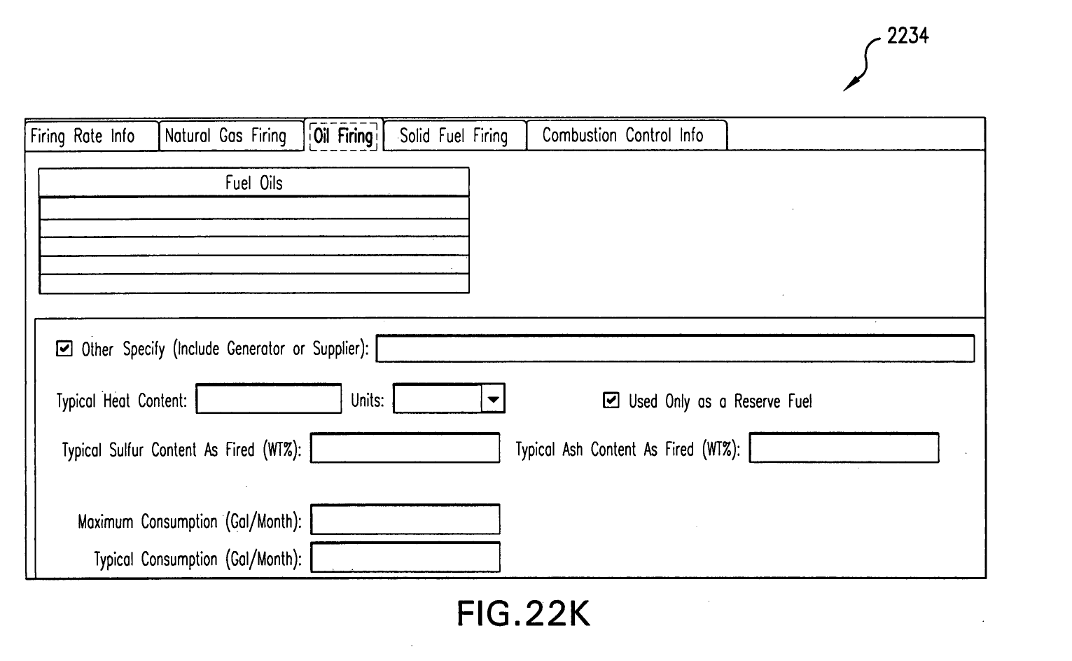

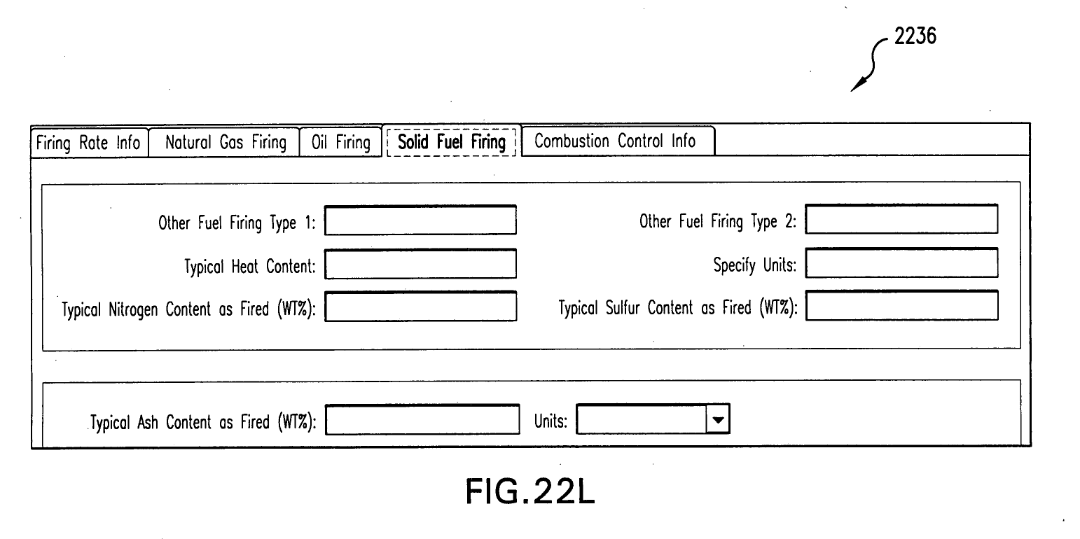

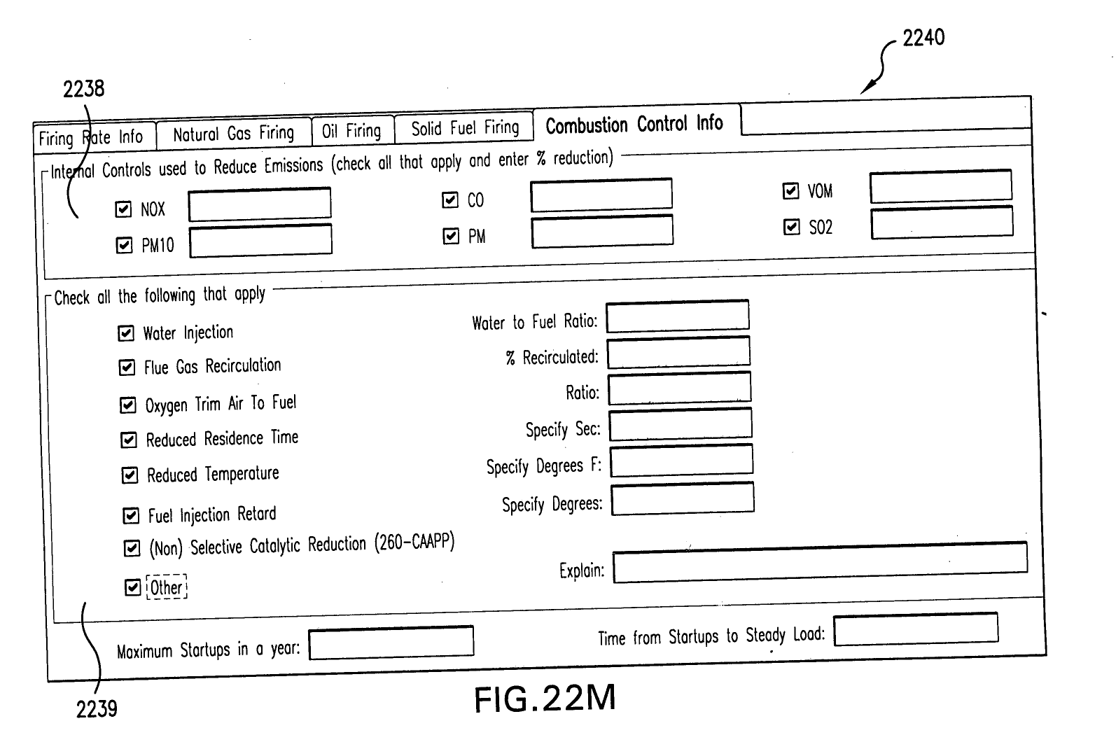

When the user selects the New EU button or edits an existing emission unit entry on the Air screen 1700, the Emission Unit (EU) edit screen 1760, shown in FIG. 17E, is displayed. All screens related to the Emission Unit edit screen 1760 will be described in further details with reference to FIG. 22A-FIG. 22M. The screen includes an information section 1762, a section with five tabs 1764, and a section with two tabs 1766. The information section 1762 contains EU ID, Unit Description, Internal Name, Equipment Type, and Number Of Units text boxes. In addition, the information section 1762 includes a Specs button and may also include a Production unit button. The first tab section 1764 includes Manufacturer Specs, Location, Dates, Documents, and Comments tabs. These five tabs are common to the five tabs of section 1734 described in details above. The second tab section 1766 includes Actual and Potential to Emit (PTE) tabs.

The Actual tab of section 1766 includes View Throughputs (Tputs), Direct, GL, and EF sub-tabs. The Actual tab allows the user to enter data for Direct, Grain Loading (GL), or Emission Factor (EF). It also allows the user to access the throughputs data by selecting the View Throughputs sub-tab. The Direct, GL, and EF sub-tabs are common to the three sub-tabs included in the PTE tab 2200 and are described in details below.

The PTE tab 2200, as shown in FIG. 22A, includes Direct, GL, and EF sub-tabs. The Direct sub-tab allows the user access to data such as pollutant type, date range, quantity, units, and comments. The GL sub-tab 2210, as shown in FIG. 22C, allows the user access to data such as pollutant type, date range, GL factor, source, units, and comments. Finally, the EF sub-tab 2214, as shown in FIG. 22E, allows the user access to data such as material, pollutant type, date range, emission factor, units, source, comments, and pollutant classification such as ash or sulfur.

In addition, the PTE tab 2200 includes Add, Edit, Del buttons for adding, editing, and deleting data of the selected sub-tab. For example, when the user selects the Direct tab and the Edit button, the EU—Direct Edit screen 2204, as shown in FIG. 22B, is displayed. This screen allows the user to edit direct losses data. The user may also select the pollutant from a list of pollutants by selecting the ellipse button 2211. When the user selects the ellipse button 2211, a pollutant list screen similar to FIG. 17U is displayed. When the user selects the GL sub-tab and the Edit button, the EU—Grain Loading Edit screen 2212, as shown in FIG. 22D, is displayed. This screen allows the user to edit grain loading data.

Similarly, when the user selects the EF sub-tab 2214 and the Add button, the Material Select screen 2220, as shown in FIG. 22F, is displayed. This screen provides a comprehensive list of material in which the user may add or select from. From the Material Select screen 2220, the user may edit the material by highlighting the material desired and activating the Select button 2219. The Material Select screen 2220 may also be called up from the Actual tab—EF sub-tab or the PTE tab—EF sub-tab with the Add button. When the user selects button 2219, the Emission Unit Edit screen 2226, as shown in FIG. 22G, is displayed. This screen allows the user to specify an emission unit's characteristics such as the source, % sulfur or ash, pollutant type, and others.

The Equipment Type dropdown textbox, located in the information section 1762, allows the user to select from a list of equipment type such as combustion, dryer, or other. The characteristics of each of these equipments can be edited by selecting Specs button 1765. For illustration, a combustion equipment type will be selected. When the user selects Specs button 1765, the Emission Unit Combustion Type Edit screen 2240, as shown in FIG. 22H, is displayed. The Emission Unit Combustion Type Edit screen 2240 includes an information section 2227 and a section 2228 with five tabs. Informational section 2227 allows the user to specify the firing direction of the combustion unit such as horizontal, tangential, or other using, for example, a radio button. Section 2228 includes Firing Rate Info, Natural Gas Firing, Oil Firing, Solid Fuel Firing, and Combustion Control Info tabs.

The Firing Rate Info tab includes a description section 2229 where the user specifies the types of engines or turbines used. The Firing Rate Info tab also allows the user to specify the rated or designed heat input capacity of the combustion unit. In addition, the user may add, edit, or delete combustion firing rate data such as fuel type, fuel state, inlet temp, outlet temp, etc., by activating the corresponding Add, Edit, and Del buttons located on the Firing Rate Info tab. When the user activates the Edit button, the EU—Combustion Fuel Edit screen 2230, as shown in FIG. 22I, is displayed. This screen allows the user to add or edit the fuel's characteristics. EU—Combustion Fuel Edit screen 2230 includes sections for solid fuels and liquid fuels. The Solid Fuel section includes entry text boxes relevant to solid fuels, such as max and typical million BTU/hr. The Liquid Fuel section allows the user to input information relevant to liquid fuels, such as maximum and typical consumption.

The Natural Gas Firing tab 2232, as shown in FIG. 22J, allows the user to input natural gas firing data such as origin, heat content, consumption etc. The Oil Firing tab 2234, as shown in FIG. 22K, allows the user to input data about oil firing such as fuel oil type, heat content, sulfur and ash content, maximum and typical consumption, etc. The Solid Fuel Firing tab 2236, as shown in FIG. 22L, allows the user to input solid fuel firing data such as: fuel firing type; heat content; % by weight of nitrogen, ash, and sulfur etc. Finally, the Combustion Control Info tab 2240, as shown in FIG. 22M, includes an internal control information section 2238 and a general information section 2239. The internal control information section 2238 allows the user to specify any control method used to reduce emission and the percentage reduction amount. The general information section 2239 allows the user to specify whether a method such as water injection, gas recirculation, fuel injection retard, etc., was used to control the combustion.

The Information section 1770 of the Air Main screen includes an Air Loss Configurations tab, a Calculate Air Losses tab 1775, a WIF Scenarios tab, and a Show % option selection box 1771. The Information section 1770 may also includes a Configuration History tab. The Show % option selection box 1771 allows the users to display the percentages of EP flow, CE flow distributions, EU Split, or hide the percentages display all together.

Informational section 1770 also contains New Config, Edit Config, and Del Config buttons. Users can add, edit, or delete configurations by selecting the corresponding button. When the user selects the New Config button, the Configuration Properties Screen 1772, as shown in FIG. 171, is displayed. Configuration Properties Screen 1772 allows the user to modify the ID and Name properties of the configuration. It also allows the user to configure the startup, shutdown, and/or removal dates as well as an assigned department, if any.

In an alternative embodiment of the present invention, the Informational section 1770 has an additional Config Edit tab 1773, as shown in FIG. 17J. The Config Edit tab 1773 allows the user to edit an existing configuration. It also includes an View Error button and a clear visual indicator when an error exists in the configuration. When an error is present, the user is required to edit the configuration before the configuration entry can be applied.

The Calculate Air Losses tab, shown in FIG. 17F, includes a Calculate button and a Throughputs button. When the user activates the Calculate button, the Air Options screen 1777, as shown in FIG. 17K, is displayed. The Air Options screen contains a Calculation Period section for setting a month range for the calculation. The Air Options screen also allows the user to define the Calculation Period by year through the Annual radio button. In an alternative embodiment, the screen 1777 also contains a text box for setting the rule effectiveness factor. When the user activates the OK button, the Air Loss Calculations screen 1780 is presented.

The Air Loss Calculations screen 1780, shown in FIG. 17G, can be a standalone screen or a frame within the Air main screen. The Air Loss Calculations screen has a Set/Calculate section 1782, a Totals By Emission Units section 1784, and a Air Emissions section 1786. The Air Emissions section displays data such as month, EP-ID, EU-ID, Pollutant, Throughput, Hours, TPUnits, CM, EF/GL, EFUnits, CE, Emissions, and Warning if there is any warning data to be displayed and if the Show Warnings box 1781 is selected. For example, when the EF and TP units are out of a certain specified range, warning data are generated and displayed in the warning column 1785, as shown in FIG. 17L. The Air Emissions section 1786 also allows the user to display the data in minutes or in hours by selecting the corresponding minute or hour radio button.

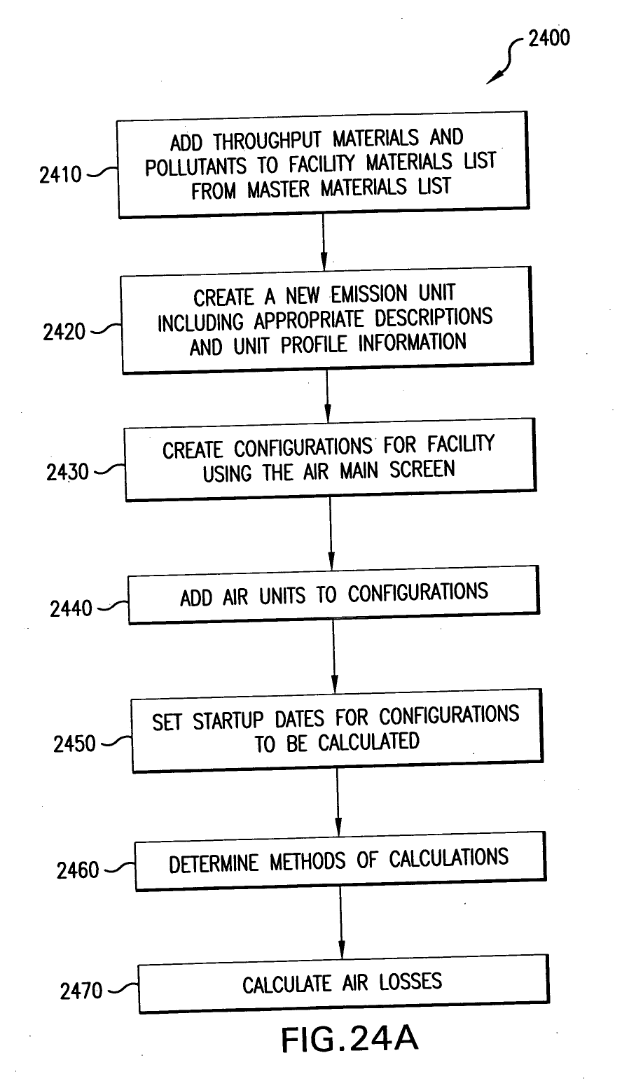

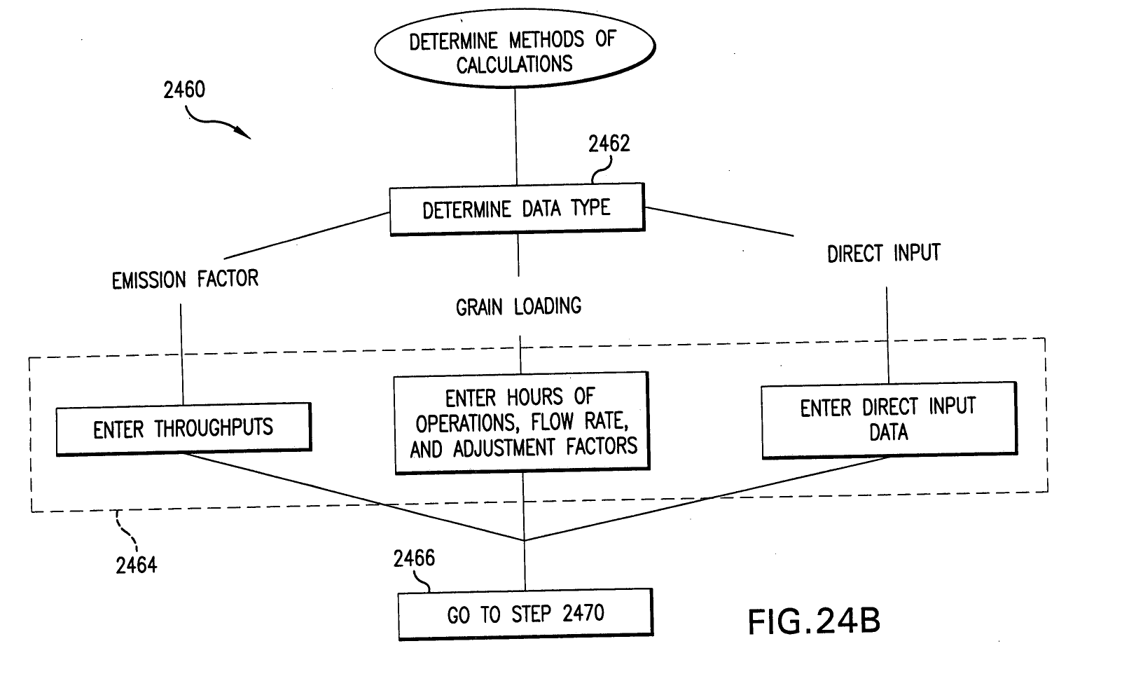

FIG. 24A illustrates the air loss calculation routine 2400 to be carried out by, for example, the user. Routine 2400 includes steps 2410-2470. In step 2410, the throughput materials and pollutants are added to the facility materials list using the Materials screen 1500 described above. In step 2420, a new emission unit is created (or an existing unit is selected). The selection may include appropriate descriptions and unit profile information such as throughputs materials, pollutants, and emission factors. The unit may be selected or created using the Emission Unit Edit screen 1760 described above. In step 2430, new configuration(s) are created or existing configurations are selected for the facility using the Air Main screen 1700 described above. In step 2440, air units are added to configuration(s) using the Air Main screen 1700. In step 2450, startup dates are set for the configurations to be calculated. In step 2460, methods of calculations are determined based on the type of data and effective dates entered. Finally, in step 2470, air emission information is calculated by selecting proper units of measurements.

FIG. 24B shows step 2460 in further detail according to an embodiment of the present invention. In step 2462, one of the three data types is determined to use for the air losses calculations. The three data types are emission factors, grain loading, and direct input. In step 2464, the data necessary for the data type chosen is determined. For emission factors, throughputs data is entered for the EU using the Air Throughputs screen 1790, as shown in FIG. 17H. For grain loading, hours of operations data is entered for EU configurations, flow rate for EP, and adjustment factors for the set of EU related to EP using the Emission Point Edit screen 1730 and Emission Unit Edit screen 1760. A direct input path can also be used to allow a user and/or other system to enter direct input data. Finally, the next step 2466 is to proceed to step 2470 in which air losses are calculated.

After steps 2410-2450 is completed, RMIS 130 provides a list of EU included and verifies that all EUs to be calculated were at least one day active and were part of at least one of the selected configurations over the period of calculations. After steps 2462-2464, sub-steps of step 2460, RMIS 130 performs proper calculations with appropriate data input determined in step 2464. For example, if the direct input path is chosen in steps 2462 through 2464, RMIS 130 performs the routines below to calculate air losses. RMIS 130 checks if there is any direct input data for EUs. If direct input data are available, then RMIS 130 calculates monthly AE (air emission) for pollutant using the equation below.

$$AE = \frac{Amount}{Nmonths}$$

RMIS 130 then loops through EU Profile and checks for any other pollutants that has not been accounted for in direct input data calculations. If there is any pollutant found, RMIS 130 selects calculation method for each pollutant as EF or GL. The closest date in the EU profile for selected pollutant determines which method is going to be used by RMIS 130. If there are multiple records for the same pollutant for EF (Different TP (throughputs) materials can yield same pollutants), the most recent date for the pollutant will then be used in the method of calculation.

However, if the emission factor input path is chosen in steps 2462 through 2464, RMIS 130 performs the routines below to calculate air losses. RMIS 130 checks for any TP for each EU in this month. If there is any TP for the month, RMIS 130 cycles through all pollutants produced by a particular material in use. If any pollutant has EF method selected in the previous step, then RMIS 130 calculates emission factor (otherwise TP based data for this pollutant, month will be ignored) using the equation below. (Alternatively, Emission factor might be just a number, not formula).
EF=f(A,C,Ca,S)

Where:
f—formula from EU profile.
A—ash content in fuel
C—Carbon content in fuel
Ca—Calcium content in fuel
S—Sulfur content in fuel

RMIS 130 takes the values for A, S, C, Ca from monthly throughputs. For TP based on OAF (Percentage of flow for particular EU), RMIS 130 calculates EU activity among group of related EU as follows:
A=GroupTotal*OAF

RMIS 130 calculates adjusted control efficiency as follows:

In order to simplify equations, RMIS 130 uses CE factor, which can be calculated as:

$${f}_{i} = ( 1 - \frac{{CE}_{i}}{100} )$$

In the case of the control equipment connected in series, adjusted CE factor for the specific pollutant can be calculated by multiplying CE factors of each unit for the same pollutant:
f=f₁*f₂*fₙ

For the parallel connection, adjusted CE factor can be calculated as follows:

$$f = \frac{{\sum }_{n} {f}_{i} * {OAF}_{i}}{100}$$

And where OAF is an operational adjustment factor, which represents percentage of flow through each unit, Adjusted CE factor for any combinations of parallel and series CE can be calculated using formulas above. RMIS 130 then calculates air emissions as follows:
AE=A*EF*f

However, if the GL input path is chosen in steps 2462 through 2464, RMIS 130 performs the routines below to calculate air losses. RMIS 130 checks if there is any HOP (hours of operation) for the EU for month range selected for the air calculation. If there is any, then RMIS 130 calculates AE as:

$$AE = \frac{GL * FlowRate * OAF * HOP}{100 * 7000 * 2000} * f tons$$

Where: FlowRate as measured in EP;

OAF—Percentage of flow for particular EU;

HOP—hours of operation for this particular unit in this month;

7000—conversion factor from grains into pounds;

2000—conversion factor from pounds to tons.

RMIS 130 then calculates the totals by pollutant, and EU. In order to calculate totals by EP and department, RMIS 130 also uses configuration data.

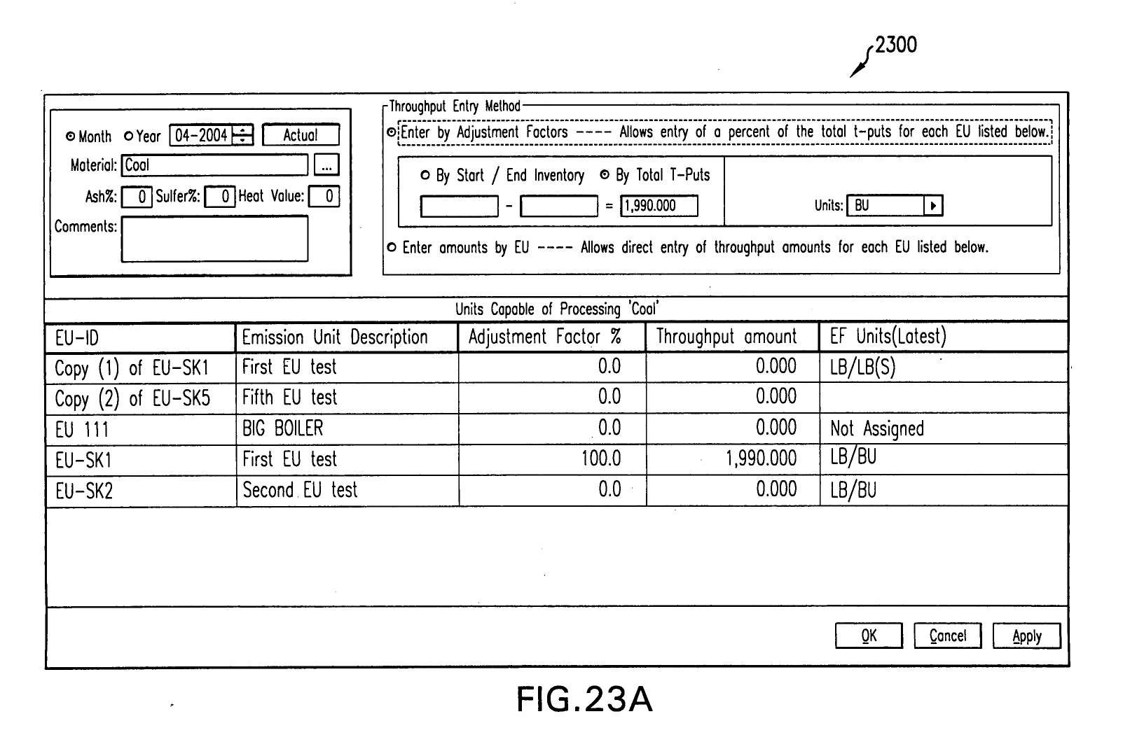

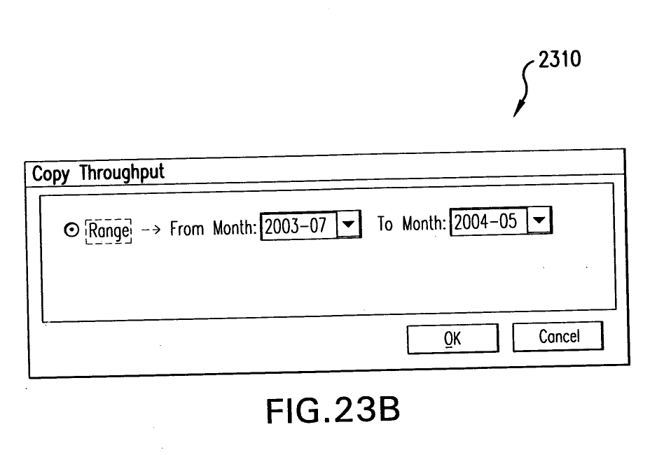

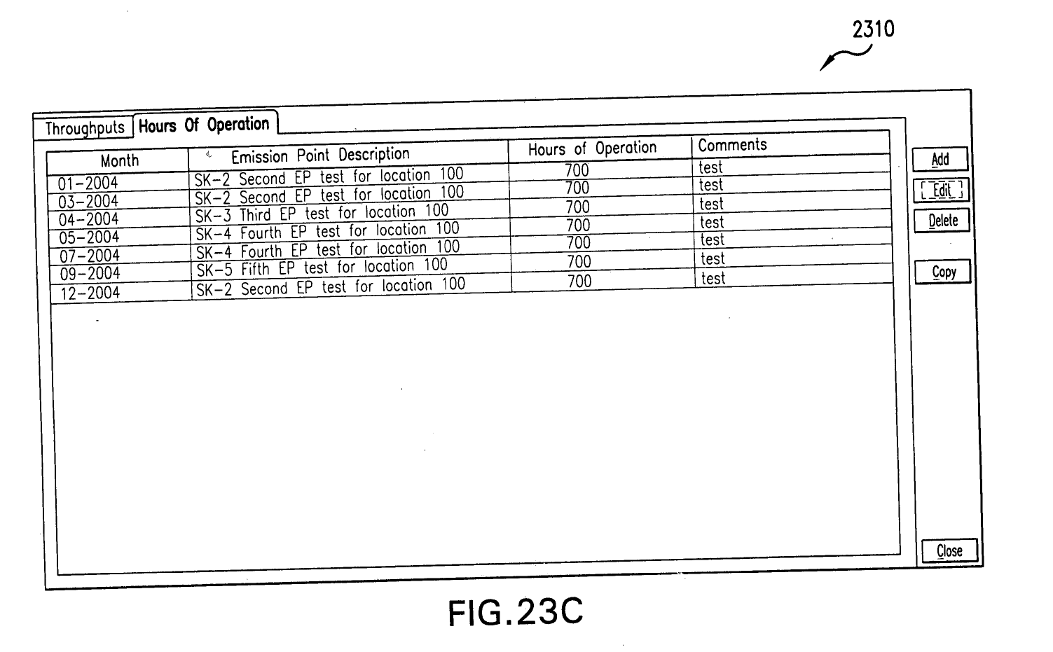

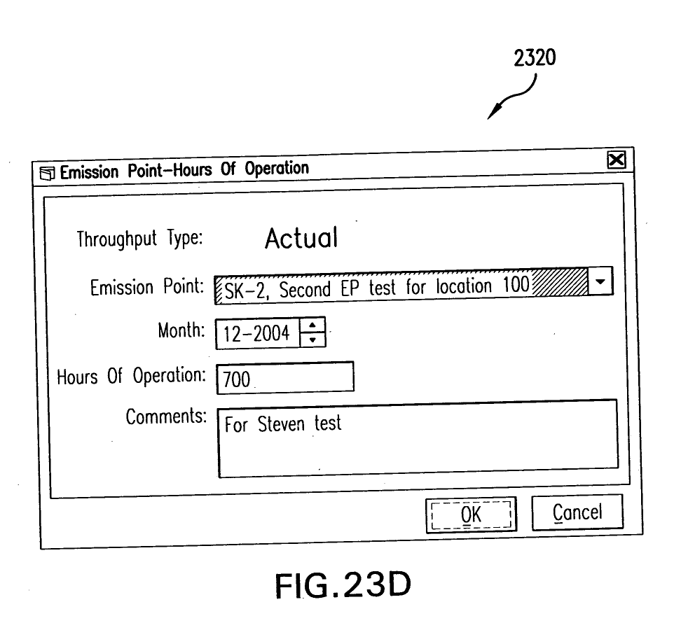

When the user activates the Throughputs button, the Air Throughputs screen 1790, as shown in FIG. 17H, is displayed. The Air Throughputs screen can be displayed as a stand alone screen or as a frame within the Air main screen. The Air Throughputs screen 1790 includes a calculation period section 1791, a show throughputs section 1793, and a section 1792 with two tabs. The calculation period section 1791 allows the user to specify the date range the user wishes to view, or the user could select all time periods. The show throughputs section 1793 allows the user to list the throughputs or hours of operation in Actual or PTE mode. Finally, the section 1792 includes Throughputs and Hours of Operation tabs with Add, Edit, Delete, and Copy buttons for adding, editing, deleting, and copying throughputs and hours of operation data. Throughputs tab provides the user with information such as period, material name, start inventory, end inventory, throughput, % ash, % sulfur, units and comments. All screens related to the Air Throughputs screen 1790 will be described in further details below with references to FIG. 23A-FIG. 23D.

When the user activates the Edit button in the Throughputs tab, the Throughputs Edit screen 2300, as shown in FIG. 23A, is displayed. The Throughputs Edit screen allows the user to edit and save a throughput entry. Throughput entries may be made by either entering adjustment factors or by entering amounts of EU. Similarly, when the user activates the Copy button in the Throughputs tab, the Copy Throughputs screen 2310, as shown in FIG. 23B, is displayed. This screen allows the user to specify the date range in which throughput distribution data are to be copied.

The Hours of Operation tab 2320, as shown in FIG. 23C, shows the hours of operation for an emission point, the date range, the emission point description, and comments relating to such datum point. When the user selects the Add or Edit button in section 1792, while in the Hours of Operation tab, the Emission Point—Hours of Operation screen 2330, as shown in FIG. 23D, is displayed. This screen allows the user to add or edit hours of operation data.

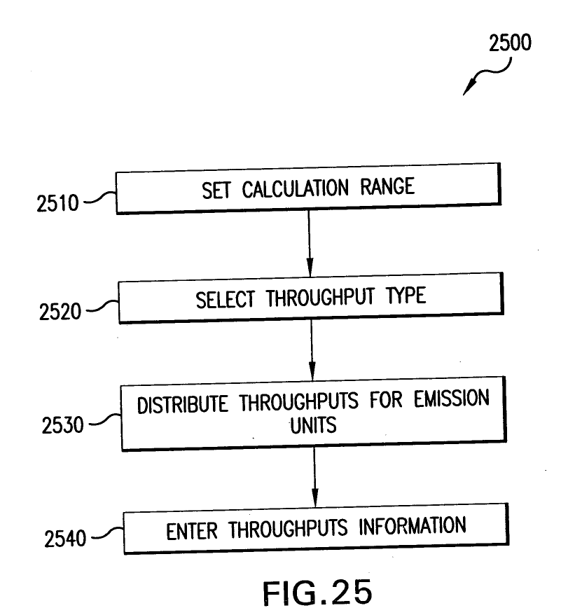

FIG. 25 further describes the air throughputs calculation process 2500. Throughputs calculation process 2500 includes steps 2510-2540. In step 2510, the calculation range is set. The calculation range can be set in multiple ways. In one embodiment, the user can set the range using the set range button in the Air Main Screen 1700 and then selecting the beginning and ending months. In yet another embodiment, the user can set the calculation range directly from the Air Throughputs screen 1790 by selecting the desired beginning and ending months using the set range button in calculation period section 1791.

In step 2520, a selection is made the between the actual throughputs or the potential to emit throughputs data types. The throughput data type can be selected just by selecting the corresponding radio button on the top of the Air Throughputs screen 1790. In step 2530, throughputs are distributed among the emission units. Distribution information regarding all the materials that an emission unit is capable of processing is entered on the Emission Unit Edit screen 1760. Emission units capable of processing the selected throughput material are displayed in the listing section 1794 of the Air Throughputs screen 1790. To add or remove an emission unit listed in section 1794, the user may use the Emission Unit Edit screen 1760.

Finally, in step 2540, throughputs information is entered. This can be done in multiple ways. In one embodiment, the cumulative throughputs for all emission units are entered and then distributed across the emission units by % (Adjustment Factors). In yet another embodiment, throughputs data is entered for each Emission unit by the exact amount desired.

Waste Menu

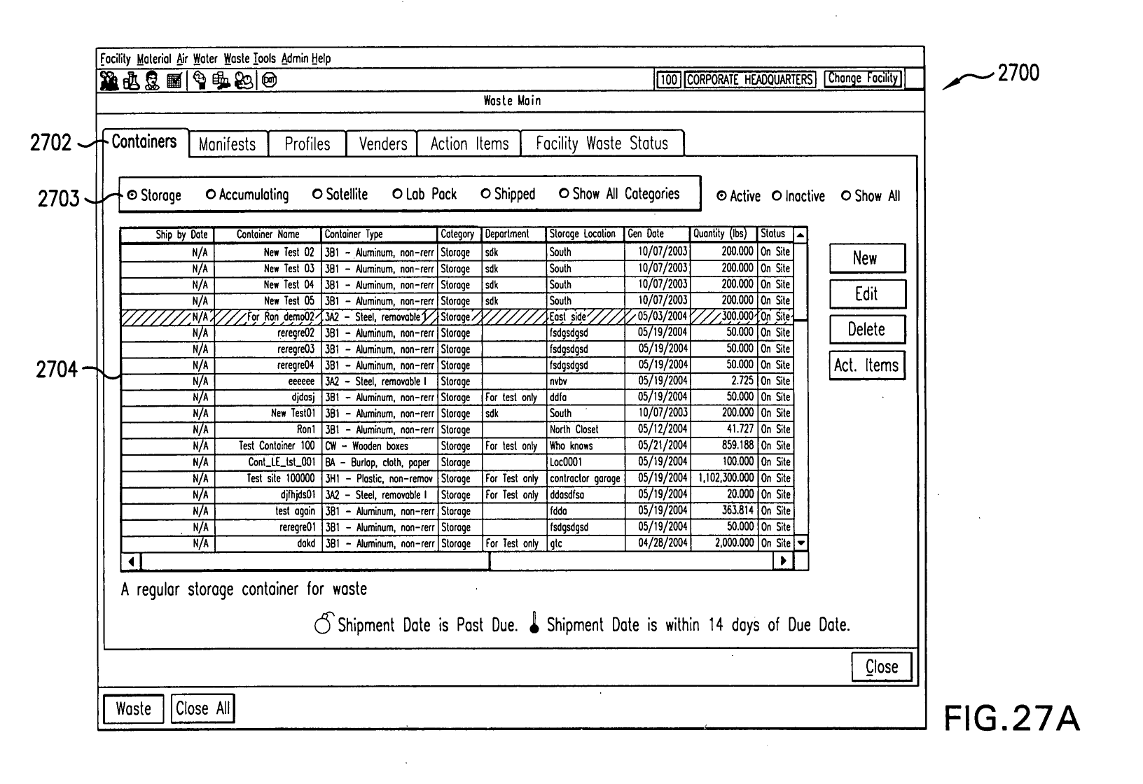

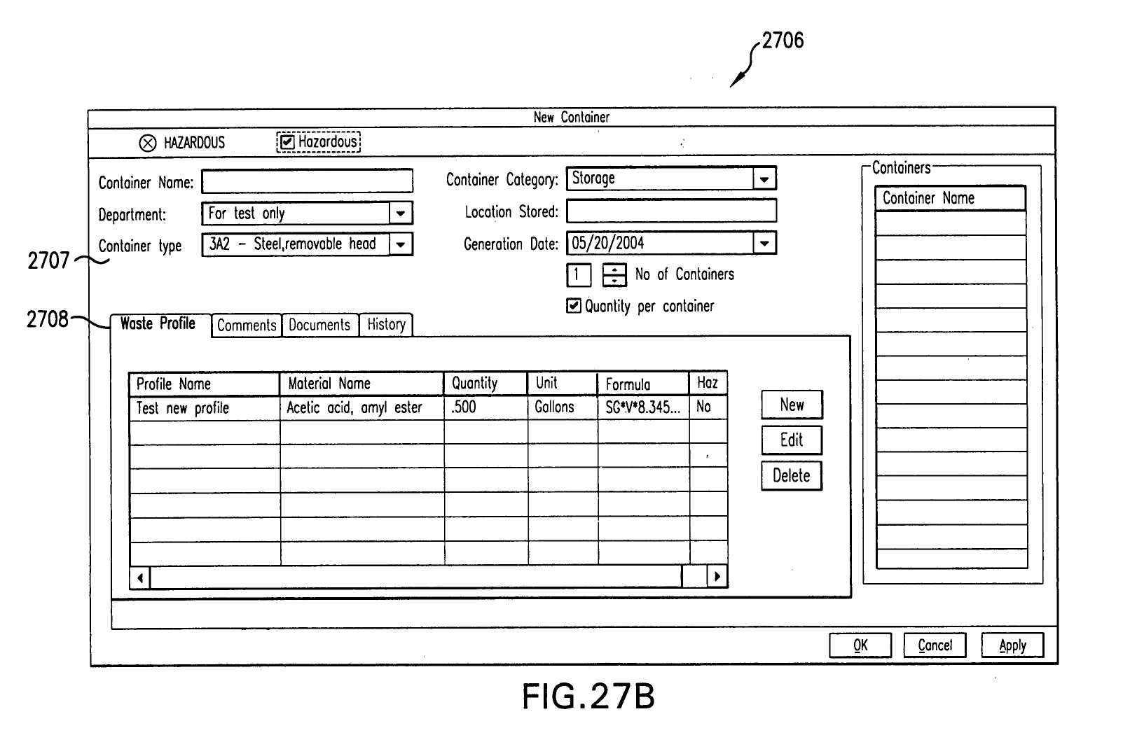

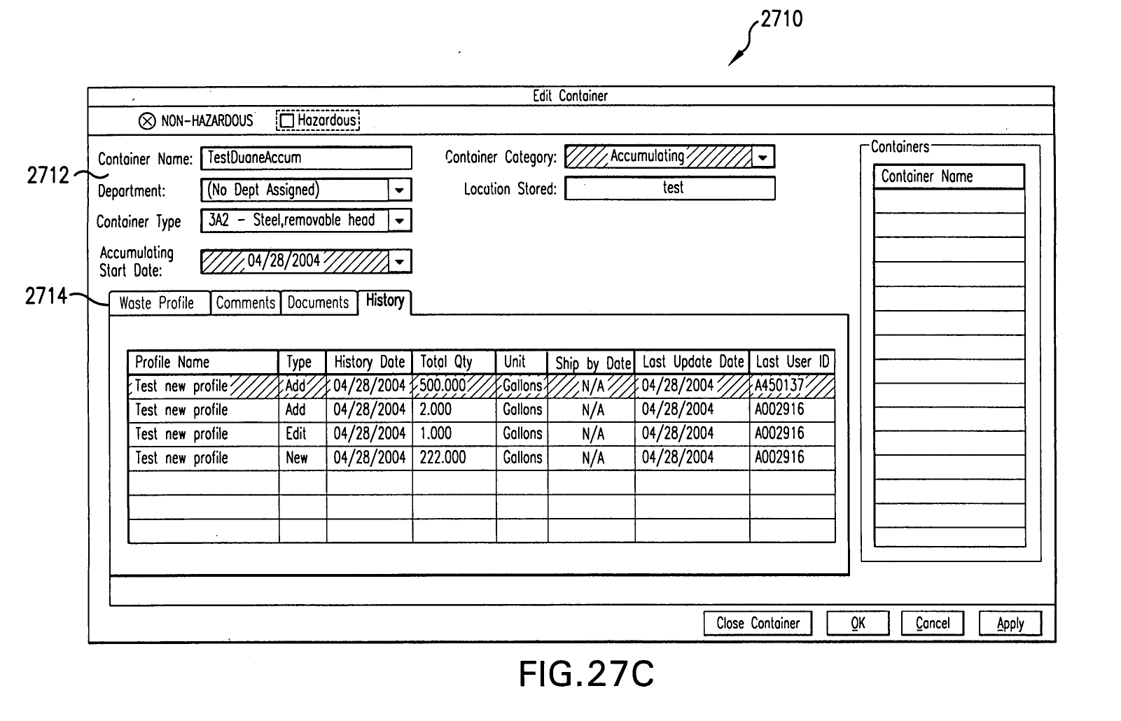

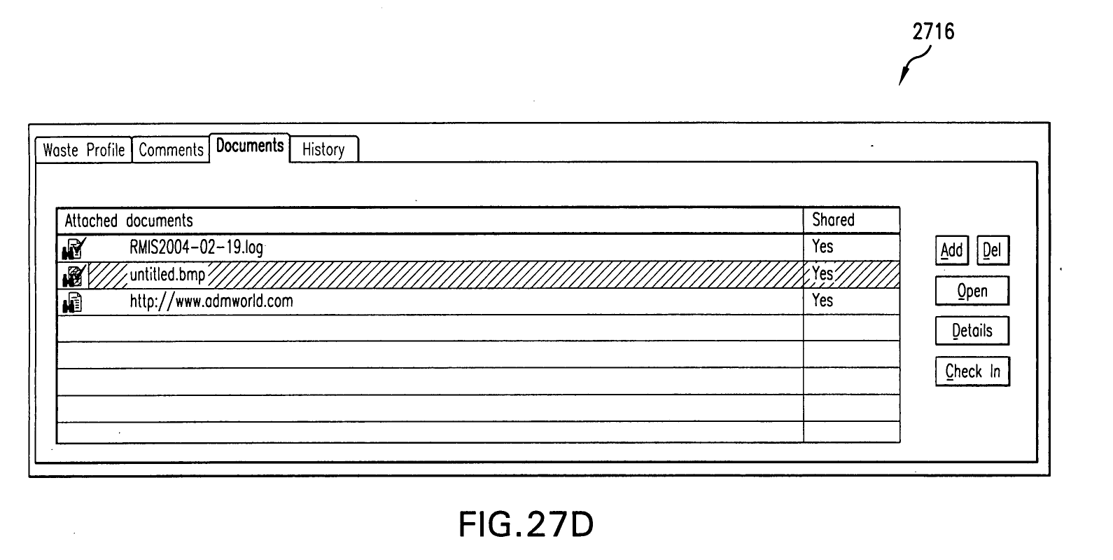

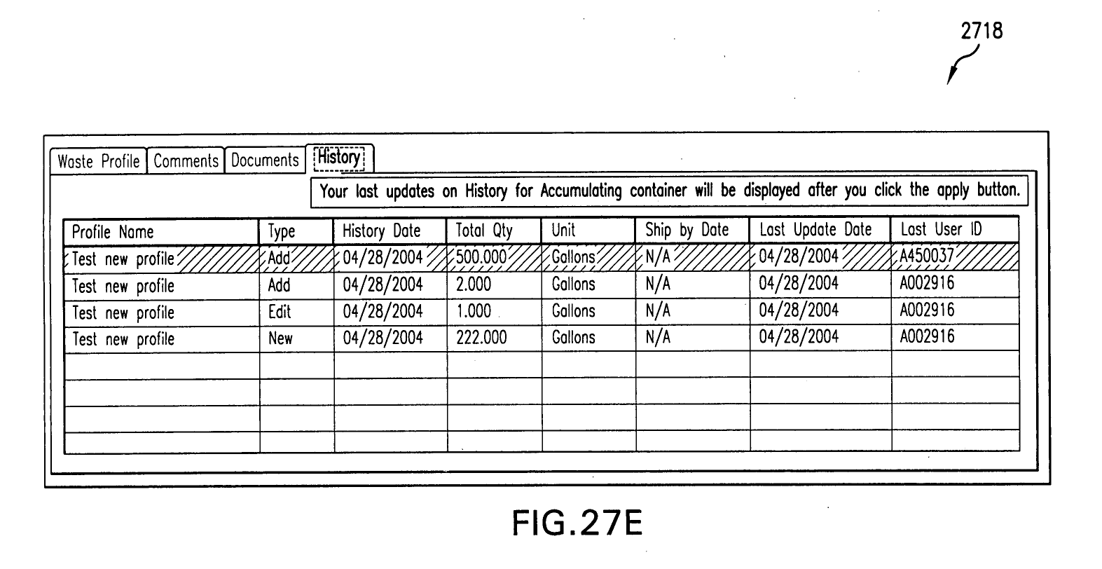

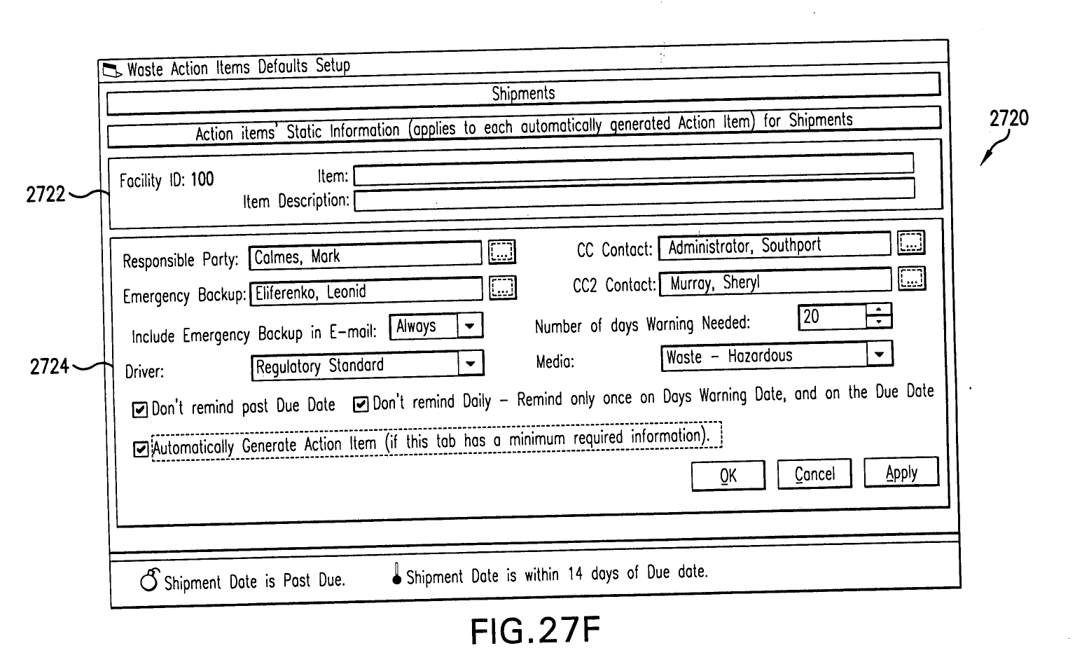

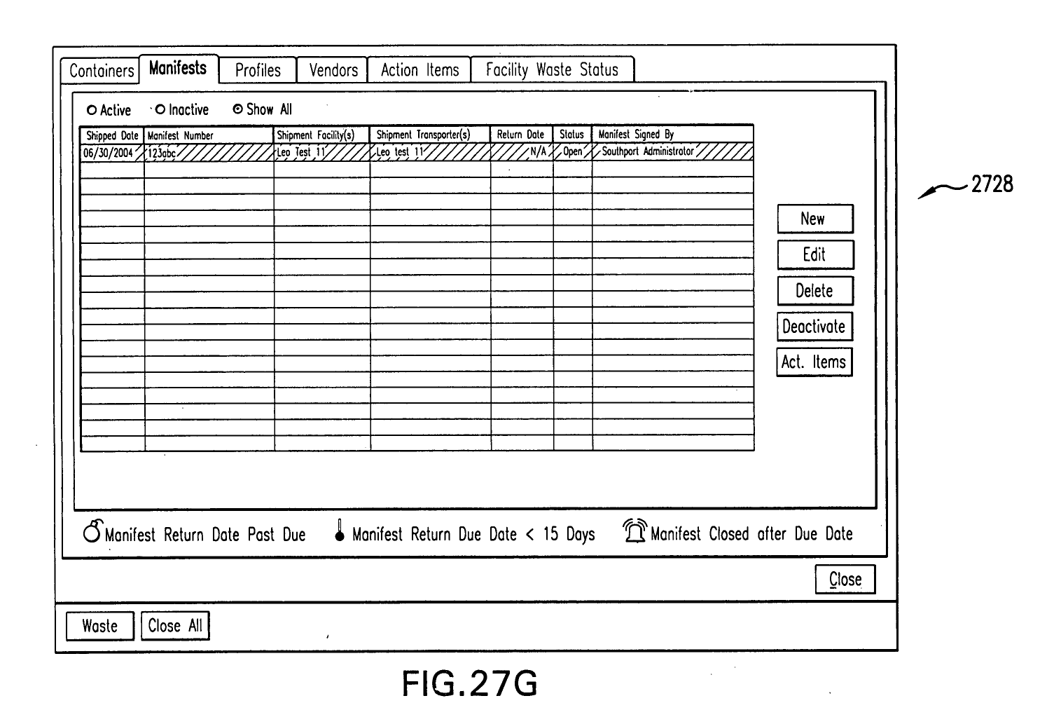

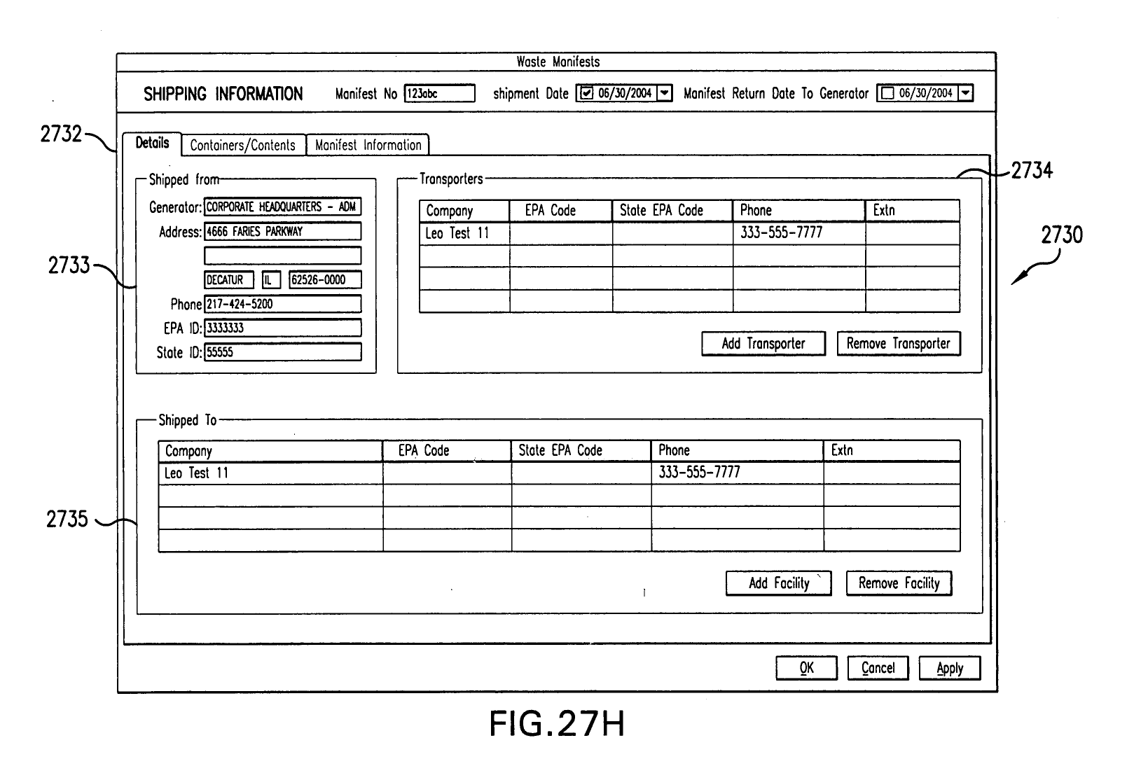

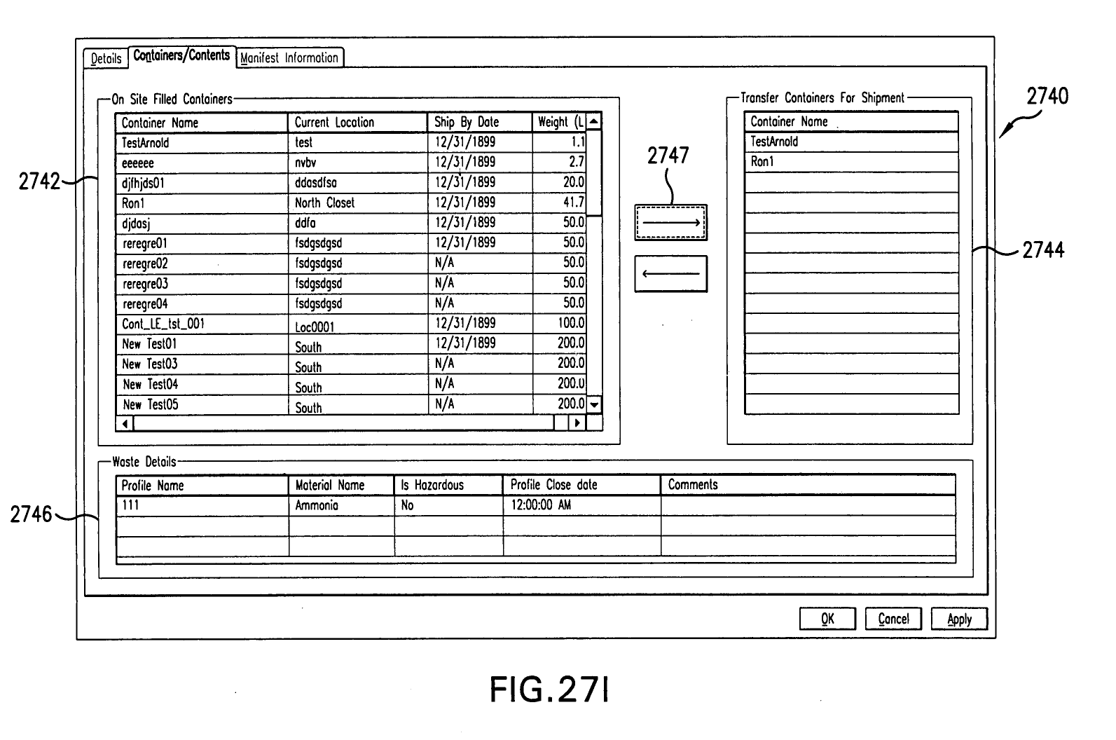

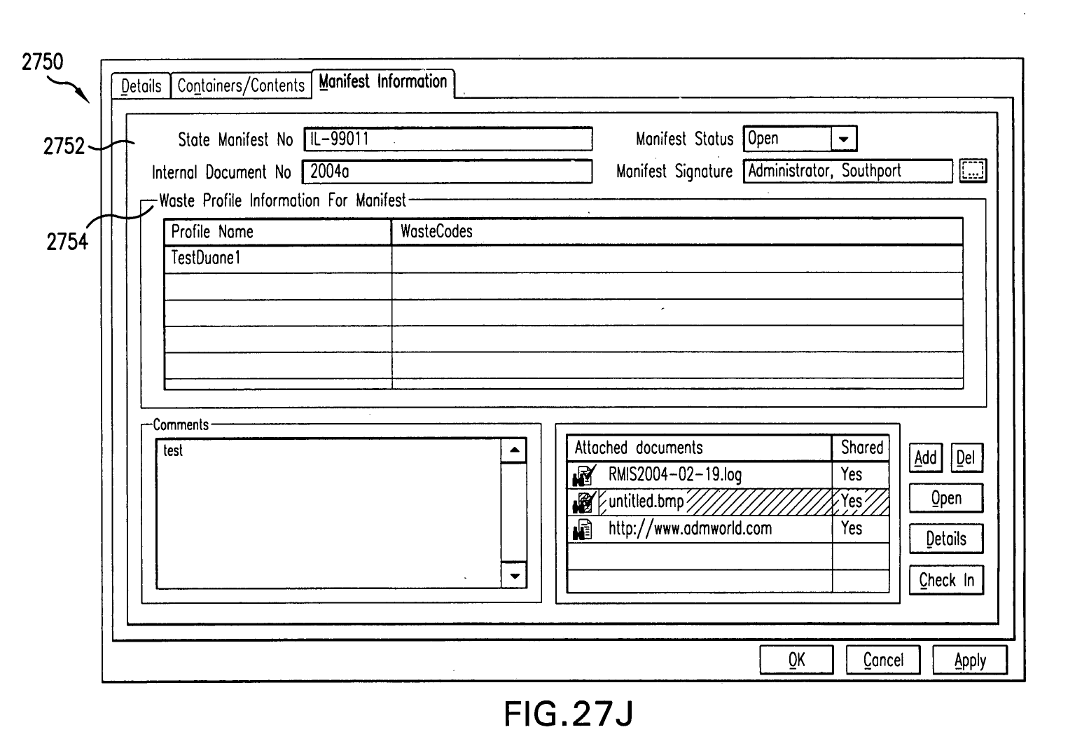

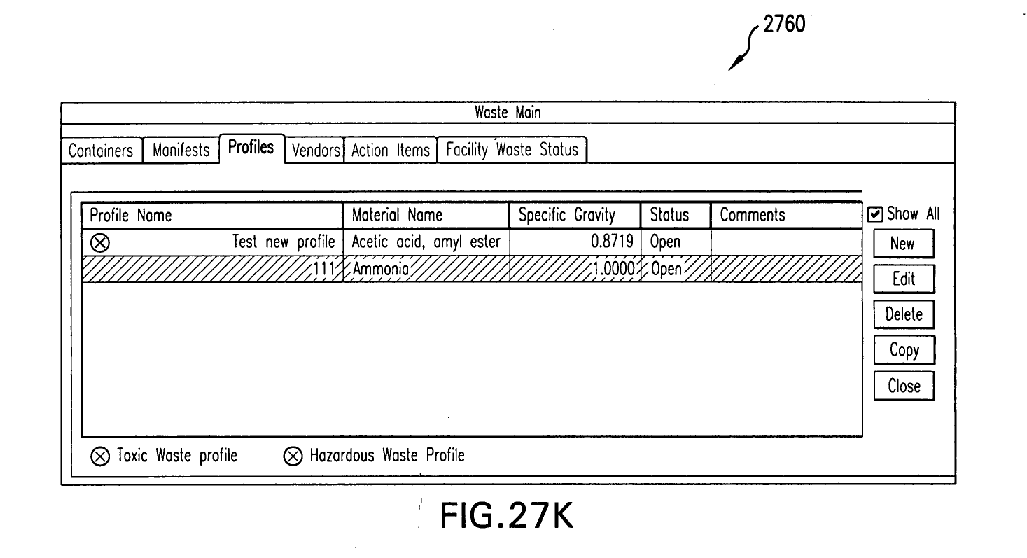

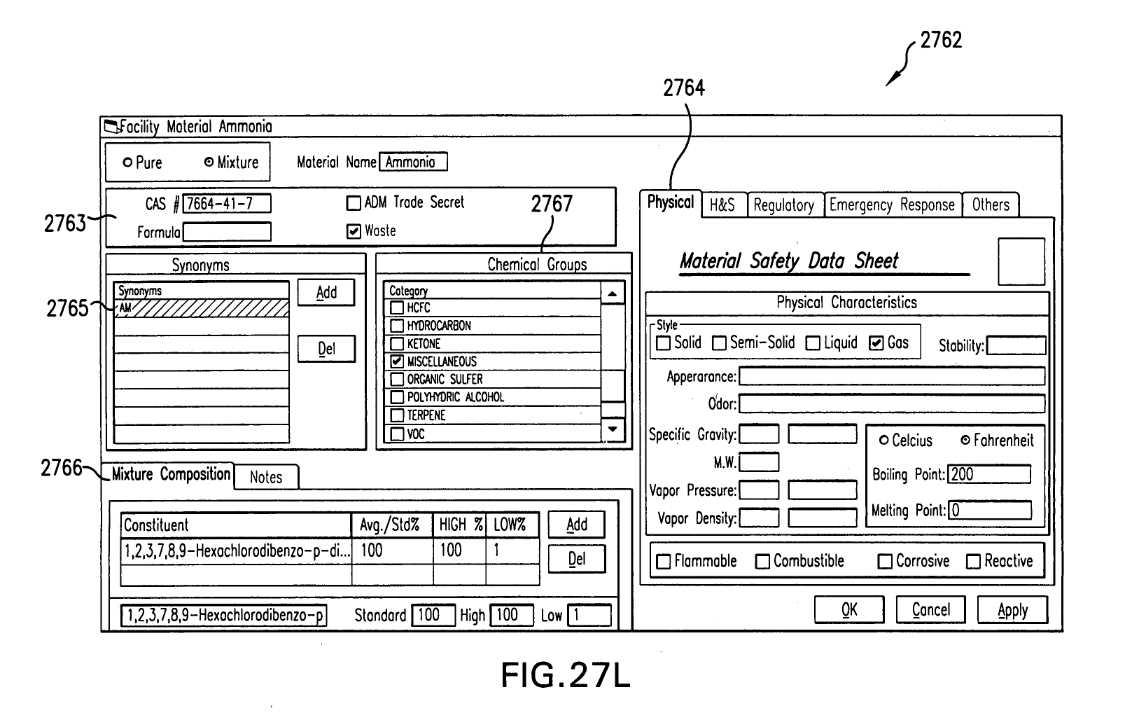

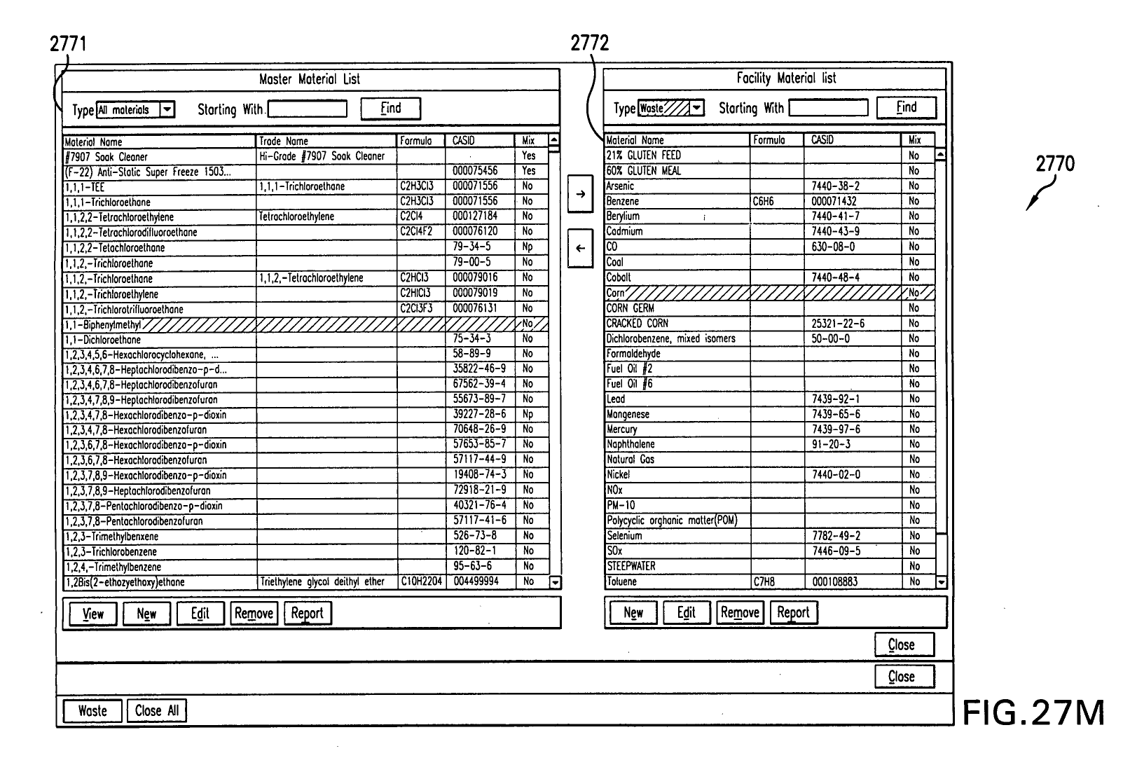

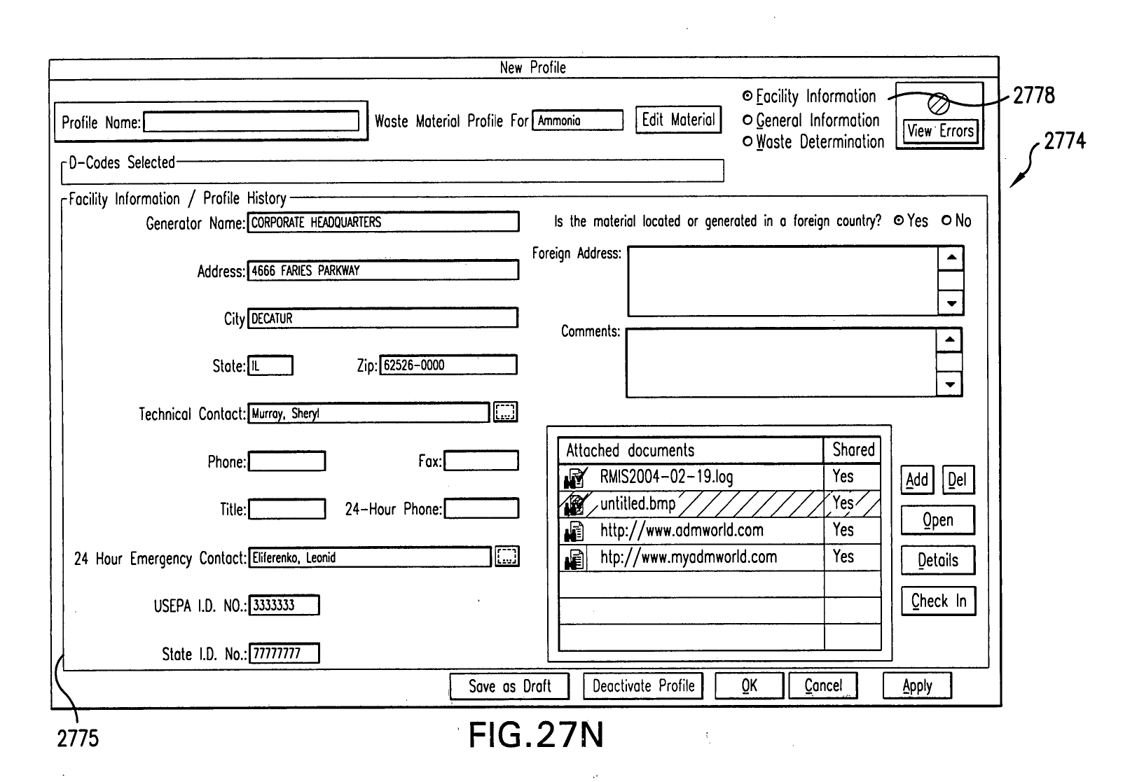

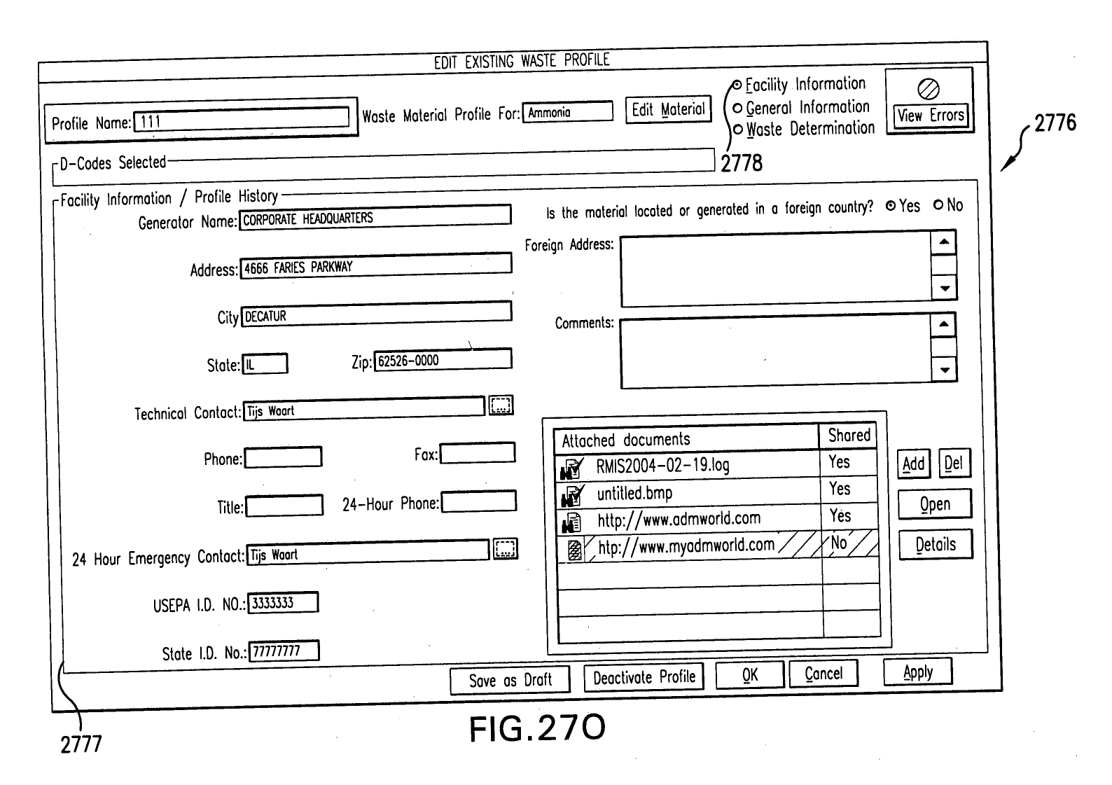

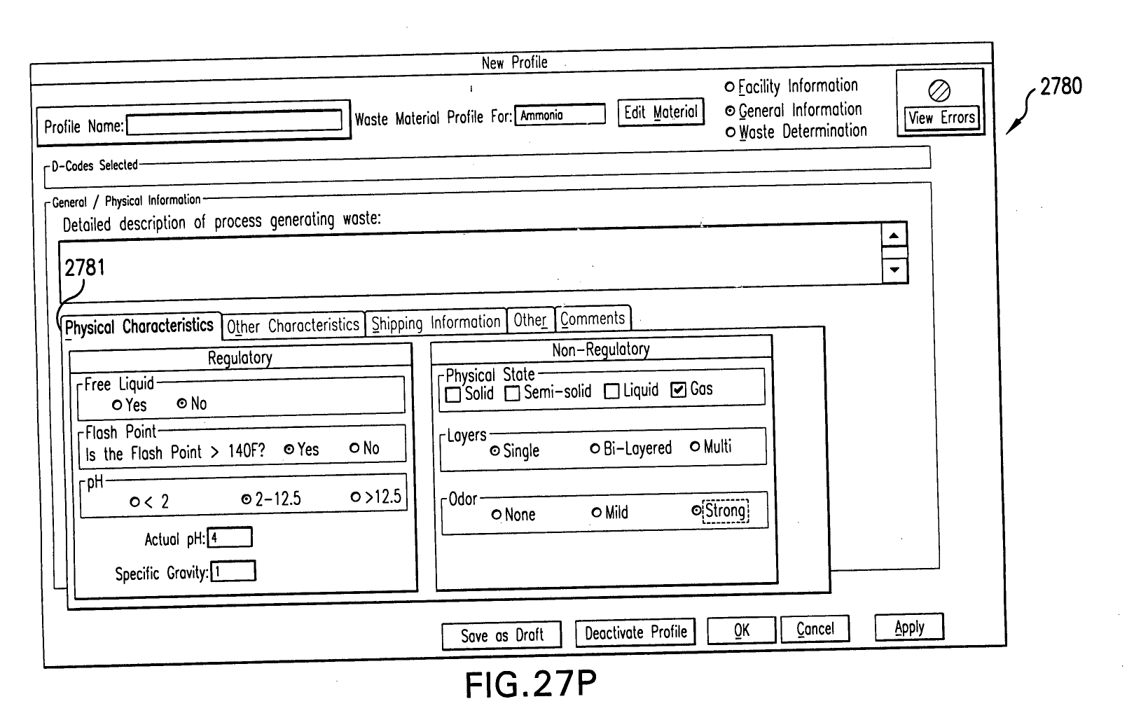

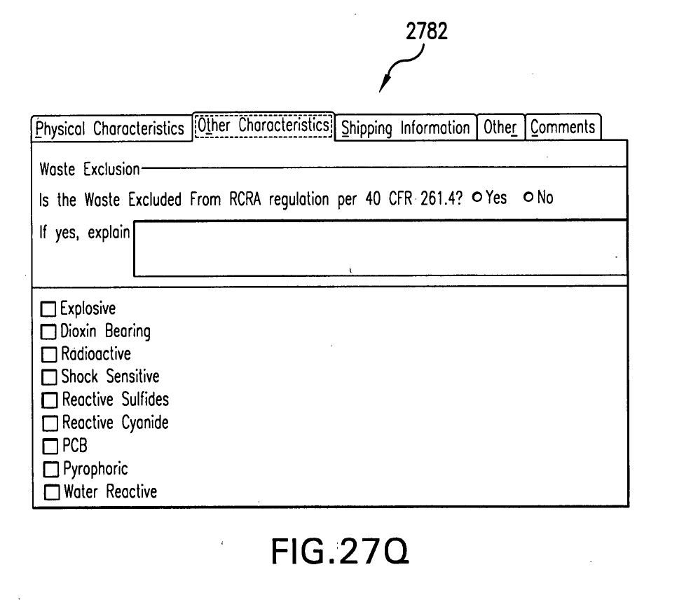

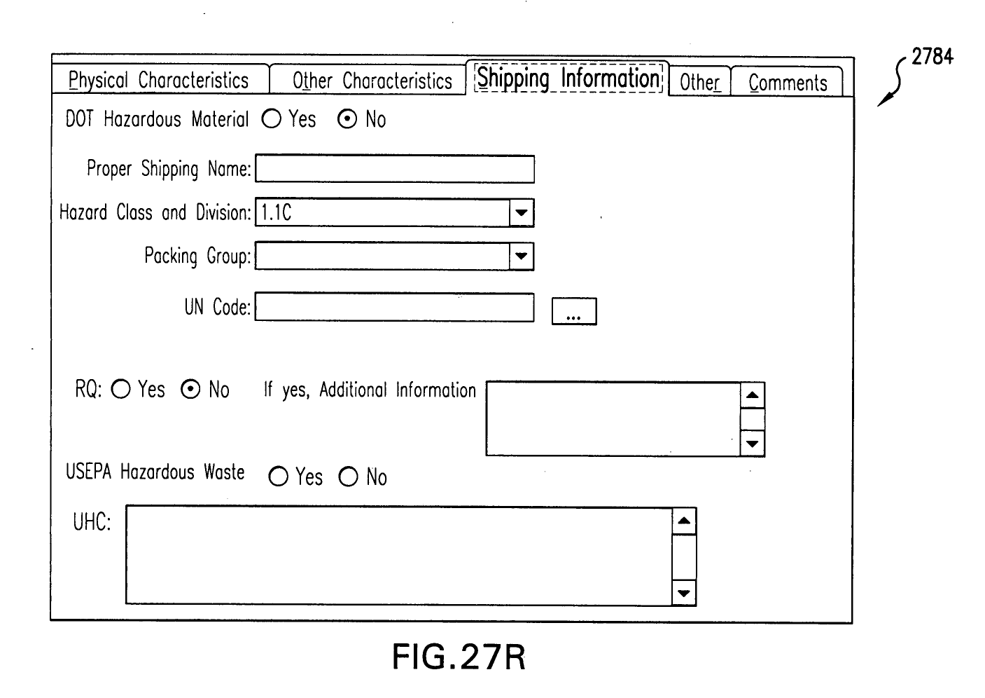

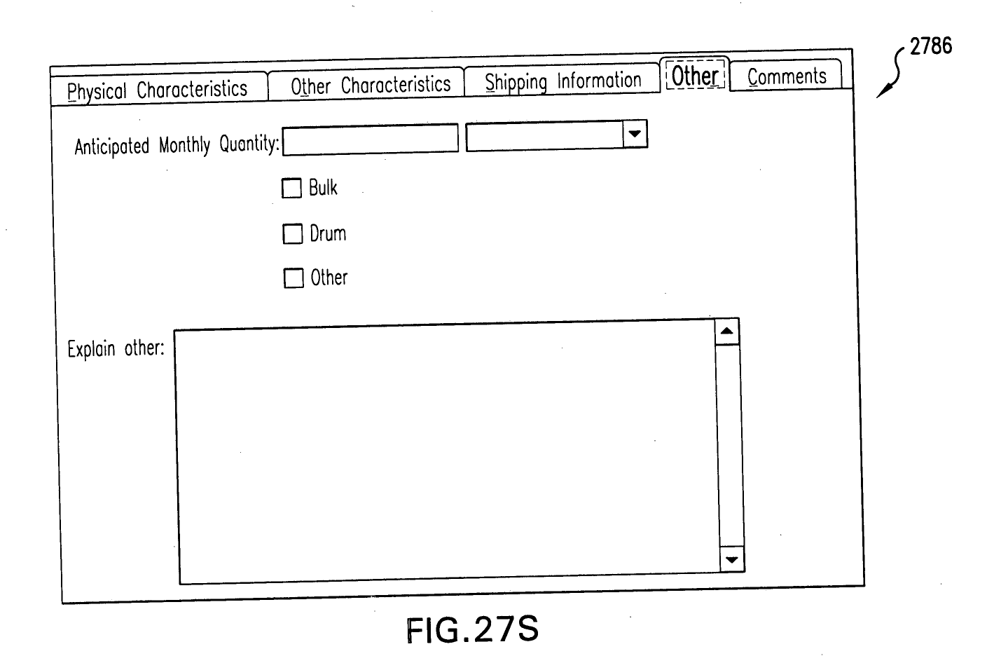

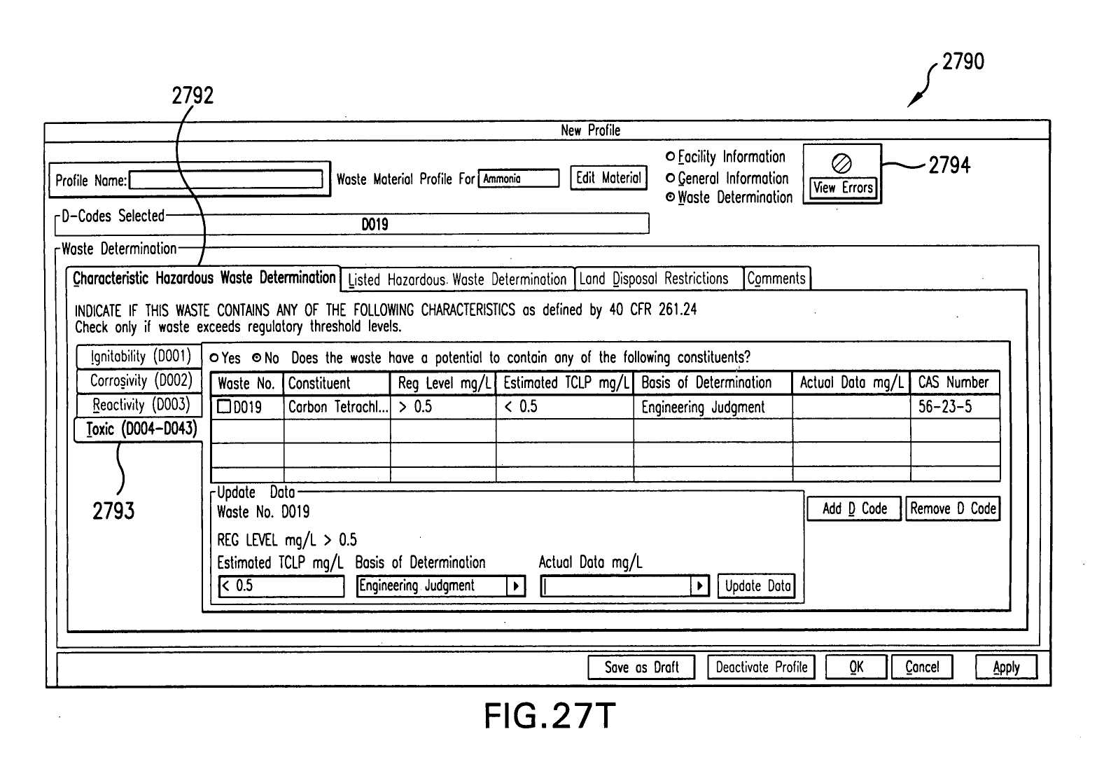

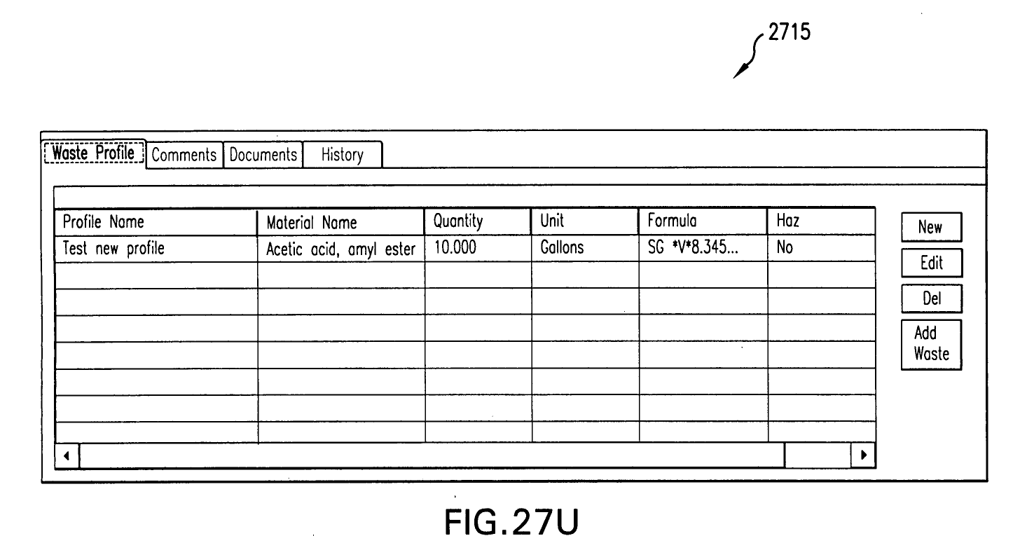

The user can access the Waste Main screen 2700, shown in FIG. 27A, from the main screen 1000 by selecting it from the Waste menu or by clicking the Waste Material icon button, sixth button, on the main toolbar. The Waste Main screen 2700 allows the user to manage waste materials. The Waste Main screen 2700 includes a section 2702 with Containers, Manifests, Profiles, Vendors, Action Items, and Facility Waste Status tabs. In addition, the Waste Main screen 2700 allows the user to manage wastes at multiple facilities simply by selecting on the desired facility using the Change Facility button.

The Container tab, also shown in FIG. 27A, includes a Material Category section 2703 which allows the user to specify the type of waste category to view such as storage, accumulating, satellite, lab pack, shipped, or show all categories. The Container tab also includes New, Edit, Delete, and Act. Items buttons and a Waste list 2704. The Waste list 2704 lists waste materials by ship date, container name, container type, waste category, department, storage location, gen date, quantity, and status.

When the user activates the New button, the New Container screen 2706, as shown in FIG. 27B, is displayed. The New Container screen 2706 includes an information section 2707 and a section 2708 with four tabs. The Information section 2707 contains data entry textboxes for inputting container data such as container name, department, container type, container category, location stored, generation date, quantity, and number of containers. The tab section 2708 includes Waste Profile, Comments, Documents, and History tabs. The Waste Profile tab, also shown in FIG. 27B, contains a waste list with the following categories: profile name, material name, quantity, unit, formula, and hazardous status. The Waste Profile tab also contains New, Edit, and Del buttons for adding, editing, and deleting waste profile. The Documents and History tabs of the New Container screen 2706 are similar to the Documents and History tabs of the Edit Container screen 2710; they are described in further details below.

The Edit Container screen 2710, as shown in FIG. 27C, may be called up by activating the Edit button located in the Container tab of the Waste Main screen 2700. The Edit Container screen 2710 has an information section 2712, a tab section 2714 with four tabs, and a comment inputting section. The Information section 2712 allows the user to edit information such as: container name, department, container type, container category, location stored, hazardous or non-hazardous, and accumulation start date. The tab section 2714 includes Waste Profile, Comments, Documents, and History tab.

The Waste Profile tab 2715, as shown in FIG. 27U, allows the user to view waste listing that contains profile name, material name, quantity, unit, formula, and hazardous or non-hazardous classification. The Waste Profile tab also includes Edit, Del, and Add Waste buttons for adding, editing, and deleting waste profile data. The Documents tab 2716 of the Edit Container screen 2710 is shown in FIG. 27D. This tab contains a listing of relevant documents on the current container. The user may also add, delete, open, and view details on any one of the documents listed by highlighting the desired document and activating the corresponding button. The History tab 2718, as shown in FIG. 27E, displays data such as profile name, type, history date, total quantity, unit, ship by date, last update date, and last user ID.

From the Waste Main screen 2700, the user may access the Shipments screen 2720, as shown in FIG. 27F, by selecting the Act. Items button located in the Containers tab shown in FIG. 27A. This screen allows the user to enter shipment information and/or flag shipment for follow-up. The first information section 2722, of the Shipments screen 2720, contains item and item description information. The second information section 2724 contains shipment data such as: responsible party, emergency backup, contact persons, driver and media. The information section 2724 also allows the user to set the following options: number of days warning needed, emergency back-up in email, due date reminder, daily reminder, and auto generation of action item. In addition, the Shipments screen 2720 allows the user to edit contact information and to set options for sending letter, fax, or email to the contact person by direction the user to the Contact screen 1800.

The Manifest tab 2728 of the Waste Main screen 2700 is shown in FIG. 27G. The Manifest tab 2728 has a listing of manifest data such as shipped date, manifest number, shipment facility, shipment transporter, return date, status, and manifest signed by information. The Manifest tab 2728 also gives the user the option to list active manifest data, inactive manifest data, or show all available data. In addition, the Manifest tab 2728 includes New, Edit, Delete, Deactivate, and Act. Items for creating, editing, deleting, deactivating, and accessing the Action Item screen 1400.

When the user activates either the New or Delete button, the Waste Manifests screen 2730, as shown in FIG. 27H, is displayed. The Waste Manifests screen 2730 includes a section 2732 with Details, Container/Contents, and Manifest Information tabs. The Details tab, also shown in FIG. 27H, includes an information section 2733, a transporters list 2734, and a shipped to list 2735. The information section 2733 has shipment data such as: generator, address, phone, EPA ID, and state ID. The shipped to list 2735 lists information about the facility that is to receive the waste shipment. The list includes company address, EPA code, State EPA code, and phone number. The transporters list 2734 lists similar data with respect to the transporter.

The Container/Contents tab 2740 of the Waste Manifests screen 2730 is shown in FIG. 271. The Container/Contents tab 2740 includes an onsite container list 2742, container shipment list 2744, and a waste details list 2746. The onsite container list 2742 shows container information such as container name, current location, ship by date, and weight. The container shipment list 2744 shows containers that need to be shipped. Waste containers can easily be transferred to and from the onsite container list 2742 and container shipment list 2744 by using the transfer buttons 2747. The container shipment list 2744 may contain similar information about a container as the onsite container list 2742. The waste details list 2746 contains detailed information on wastes such as hazardous classification, profile name, material name, profile close date, and other comments.

The Manifest Information tab 2750 of the Waste Manifests screen 2730 is shown in FIG. 27J. The Manifest Information tab 2750 includes an information section 2752 that contains state manifest number, manifest status, internal document number, and manifest signature textboxes for data entry. The Manifest Information tab 2750 also includes a section 2754 that has a waste profile list showing the profile name and waste codes. If a waste profile is selected from the waste profile list, the user may view comments and documents related to the waste selected. The user may also add and delete documents for the selected waste profile. If a document is shared, the user is given an option to check-in or check-out the document.

The Profiles tab 2760, as shown in FIG. 27K, can be accessed from the Waste Main screen 2700 by selecting the Profiles tab. The Profiles tab 2760 allows the user to create, edit, delete and copy profiles by activating the corresponding New, Edit, Delete, and Copy buttons. The Profiles tab 2760 shows a listing of waste profiles. The listing contains information such as profile name, material name, specific gravity, status, and comments. The user is then asked to select a material for the profile from a list. After selecting the desired material, the user is brought to the Facility Material screen, specific for the material selected, where detailed information about the material is collected. For example, if ammonia is selected then the Facility Material Ammonia screen 2762, as shown in FIG. 27L, is displayed. Alternatively, the user may create a new waste profile by activating the New button. When the user selects the New button, the Material screen 2770, as shown in FIG. 27M, is displayed. The Material screen 2770 includes a query option section 2771 that has a type selection combo box and a keyword textbox. The Material screen 2770 also includes a material list, a facility material list 2772. Each entry in the material list includes the material name, trade name, formula, CASID, and mix indicator. The listing of the material list may be limited by using the type selection combo box and the keyword textbox. Similarly, the facility material list 2772 could also be limited by using its associated type selection combo box and a keyword textbox. The facility material list 2772 includes the material name, formula, CASID, and mix indicator for each entry.

The Facility Material Ammonia screen 2762 is similar to the Master Material screen 1540 described above. Sections 2763, 2764, 2765, and 2767 of the Facility Material Ammonia screen 2762 correspond to sections 1544, 1550, 1546, and 1548, respectively, of the Master Material screen 1540 described above. In addition, the Facility Material Ammonia screen 2762 includes Physical, H&S, Regulatory, Emergency Response, and Others tabs. These five tabs are also similar to Physical, H&S, Regulatory, Emergency Response, and Others tabs of the Master Material screen 1540 described above.

When the user activates the New button in the Profiles tab 2760, New Profile screen 2774, as shown in FIG. 27N, is displayed. This screen allows the user to create new profiles for Facility Information, General Information, and Waste Determination by selecting on the corresponding radio button located in section 2778 of the New Profile screen 2774. The New Profile screen 2774 also allows the user to specify the profile name and identify the waste material the profile is being created for; this is a common function for the Facility Information, General Information, and Waste Determination screen. By default, FIG. 27N displays the Facility Information screen, which is embedded in the New Profile screen 2774. Alternatively, the Facility Information screen can be a separate pop-up screen. The Facility Information screen includes an information section 2775 with data such as: generator name, address, city, state, technical contact, phone, fax, title, emergency contact, USEPA ID, state ID, foreign address if the material is foreign originated, and comments. The user may also add documents relevant to the new profile by selecting the Add button. Once the relationship between the documents and new profile is established, the user may delete, open, or view details on the documents. In addition, if any error exists in the configuration for the profile being created, an error indicator on the New Profile screen 2774 will be shown in red. If no error exists, the error indicator will be shown in green. This error indicator is common to the Facility Information, General Information, and Waste Determination screens.

When the user selects the General Information radio button, the General Information screen 2780, as shown in FIG. 27P, is displayed. This screen allows the user to enter detailed description of the process generating waste. The General Information screen 2780 also includes a section 2781 with Physical Characteristics, Other Characteristics, Shipping Information, Other, and Comments tabs. The Physical Characteristics tab is also shown in FIG. 27P. This tab includes sections for data entry of regulatory and non-regulatory information. The Other Characteristics tab 2782 is shown in FIG. 27Q. This tab allows the user to enter data such as radioactivity, explosiveness, and other regulatory related information. The Shipping Information tab 2784 is shown in FIG. 27R. The Shipping Information tab 2784 allows the user to enter shipping related information. The Other tab 2786, as shown in FIG. 27S, allows the user to enter data such as anticipated quantity and bulk, drum, or other classification.

The Edit Existing Profile screen 2776, as shown in FIG. 270, is displayed when the user activates the Edit button in the Profiles tab 2760. This screen has similar data entry requirements as the New Profile screen 2774.

The Waste Determination screen 2790, as shown in FIG. 27T, can be accessed from the New Profile screen 2774 by selecting the Waste Determination radio button. The Waste Determination screen 2790 is shown as an embedded screen, but it can be a separate pop-up screen. The Waste Determination screen 2790 includes a section 2792 with four tabs; they are Characteristic Hazardous Waste Determinations, Listed Hazardous Waste Determination, Land Disposal Restrictions, and Comments.

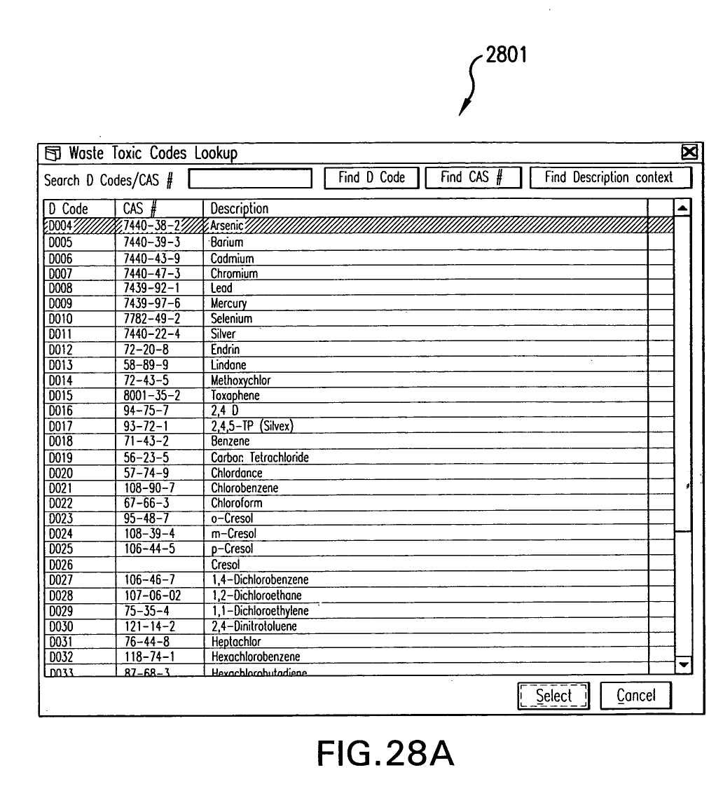

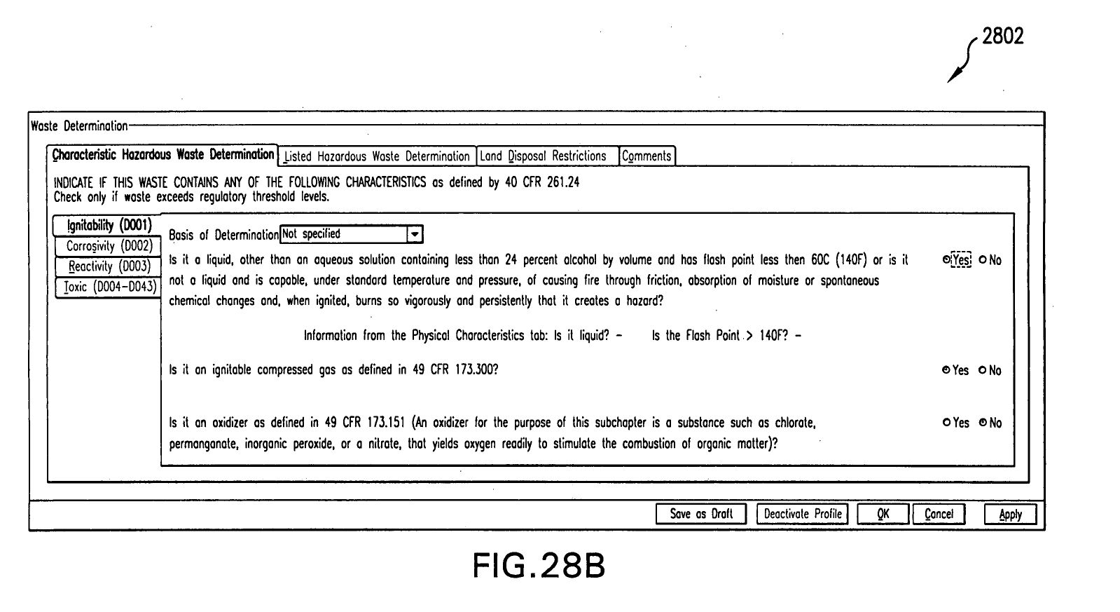

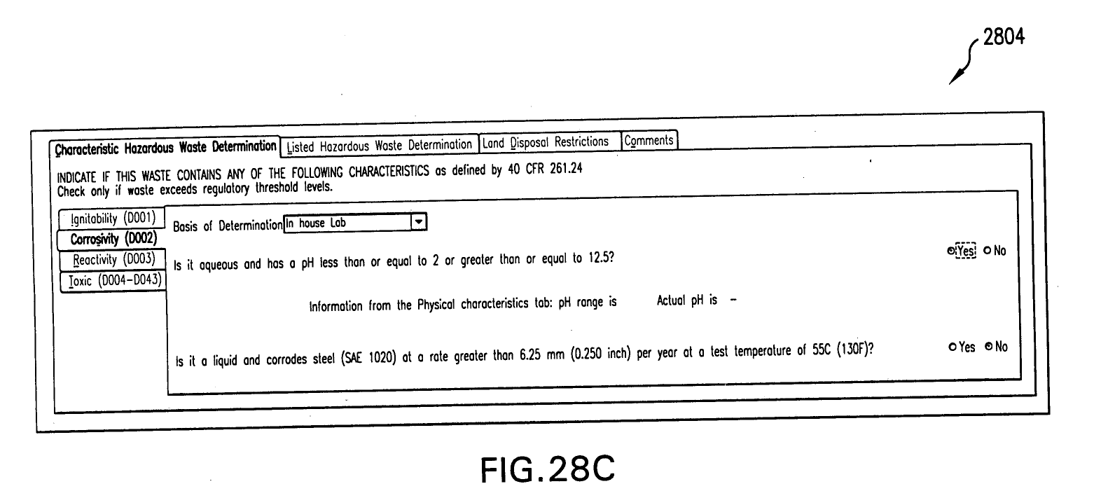

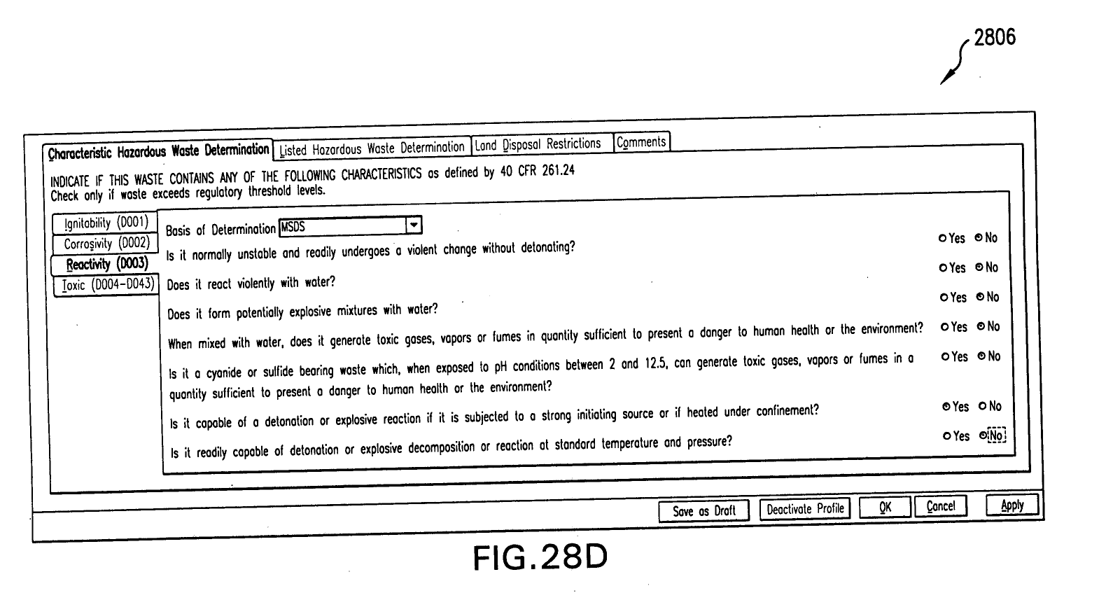

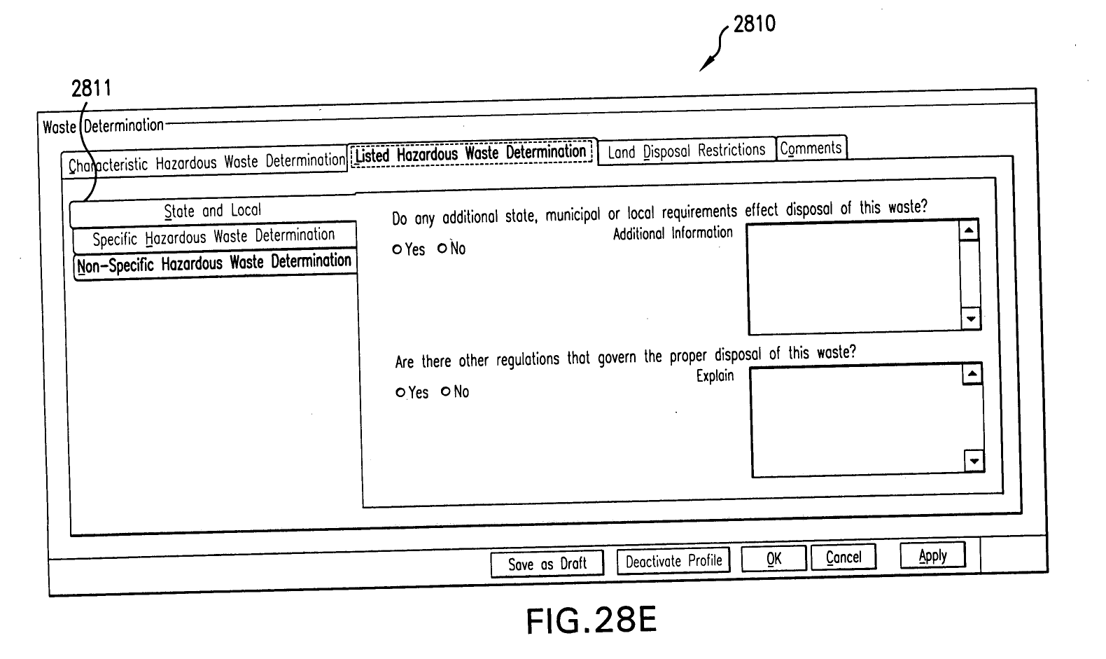

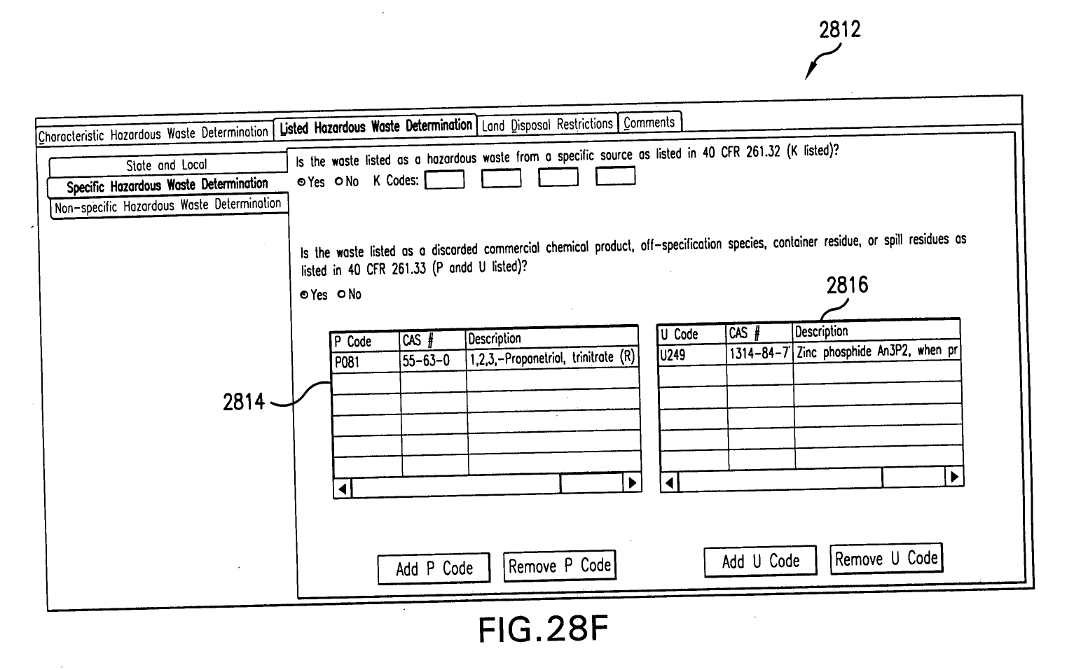

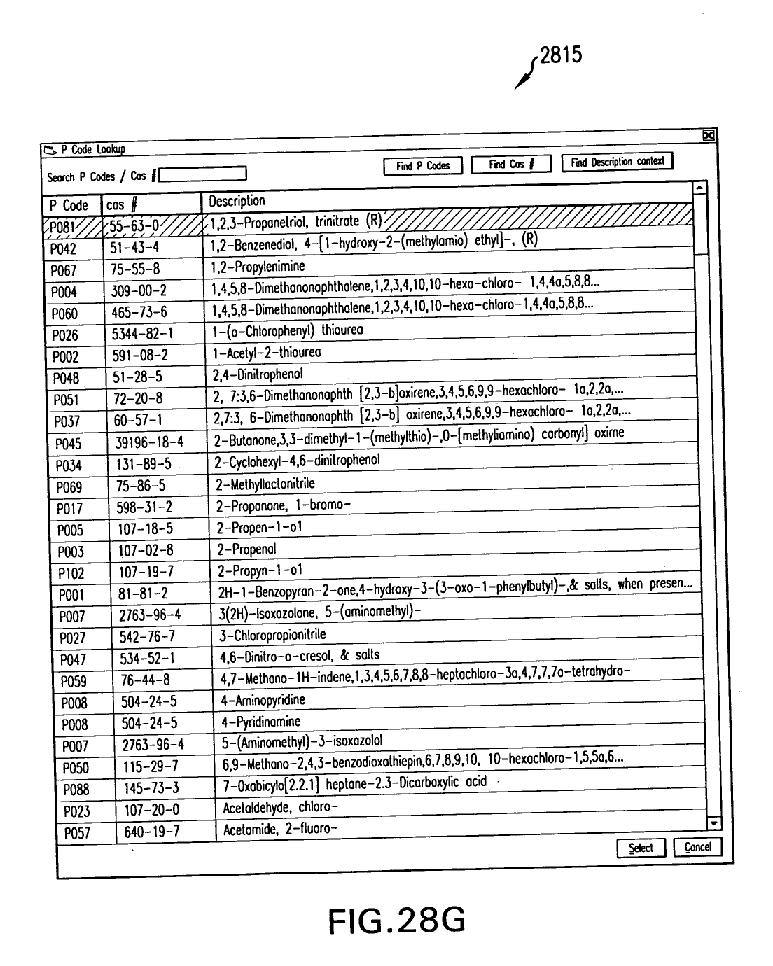

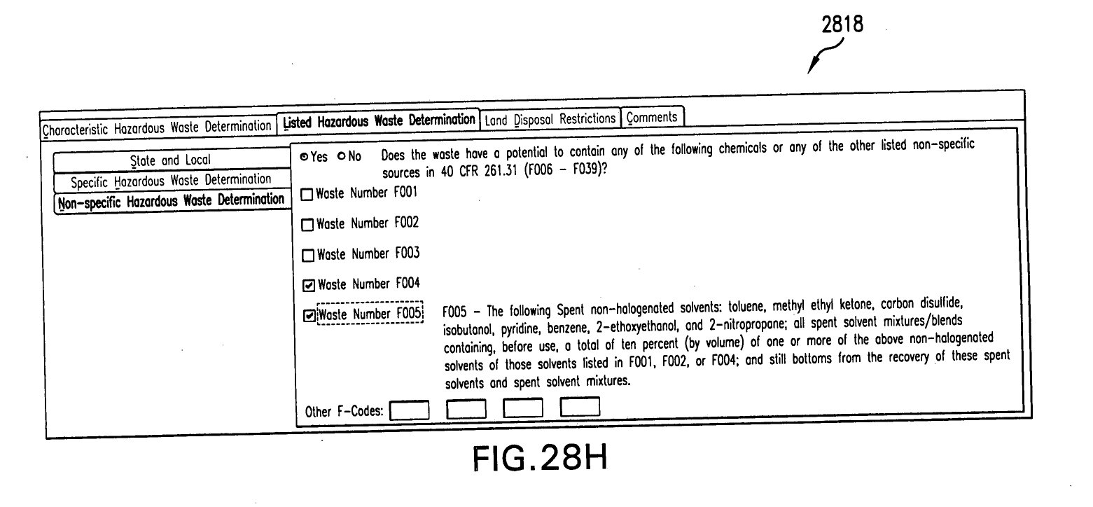

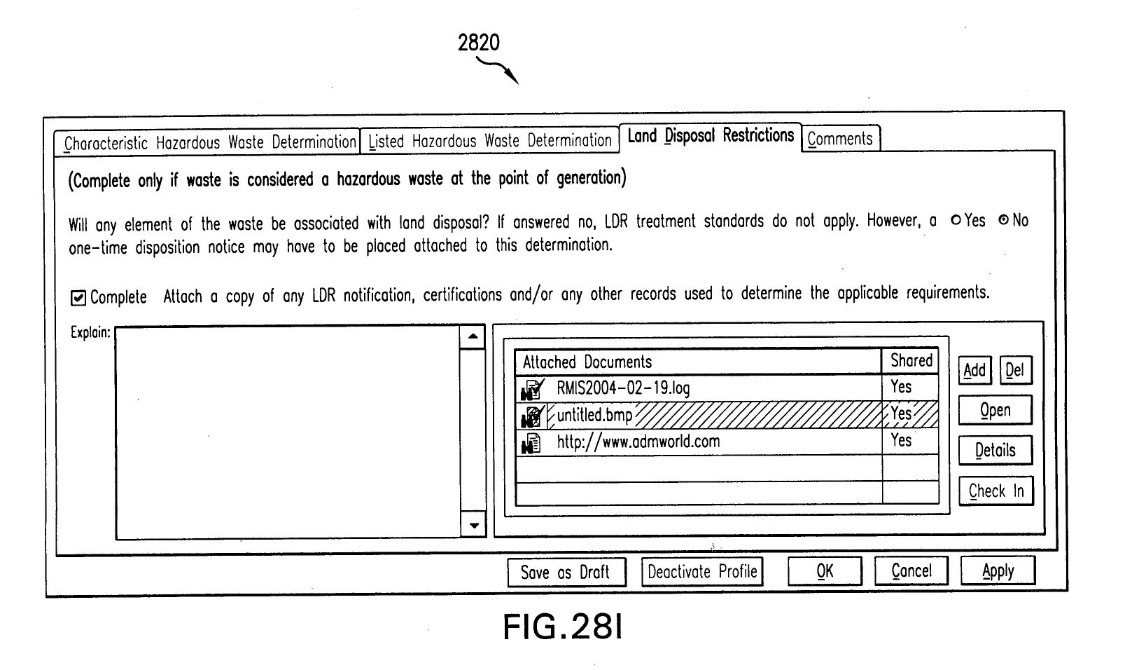

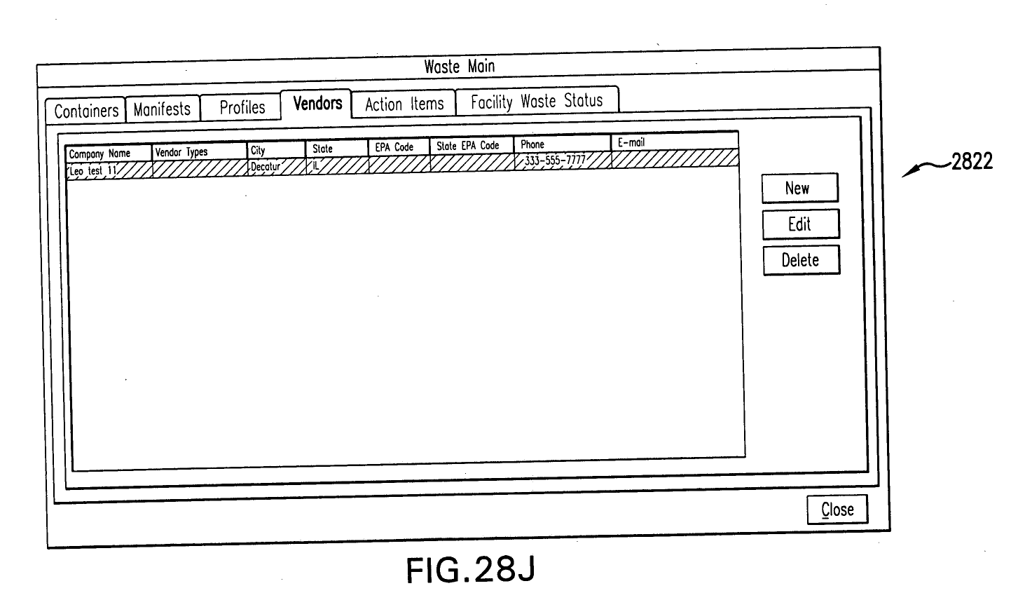

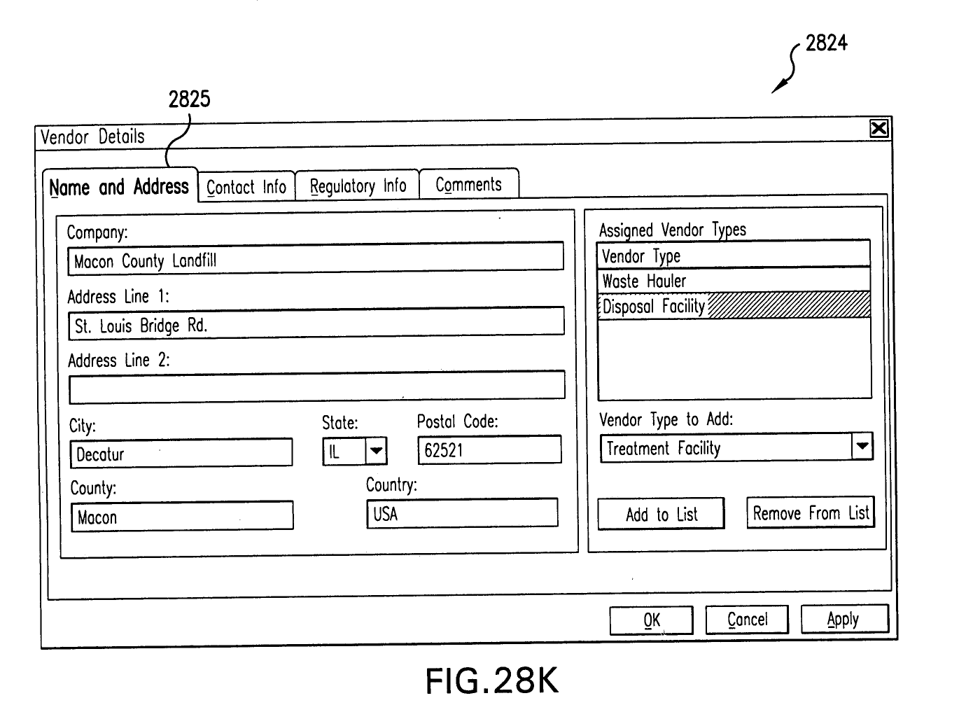

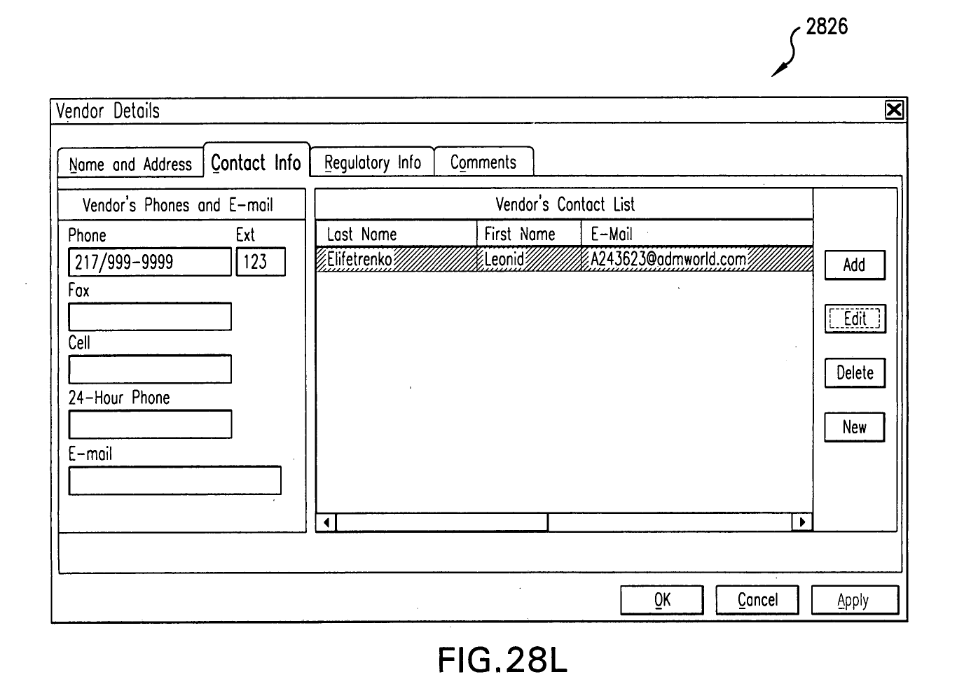

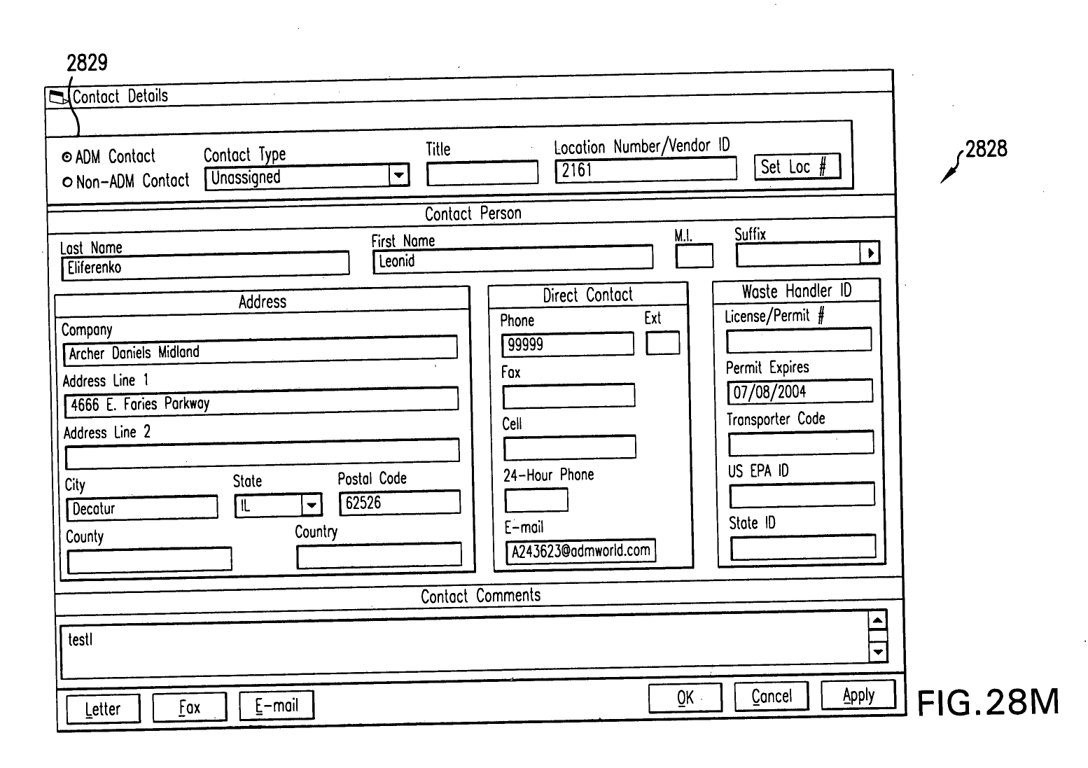

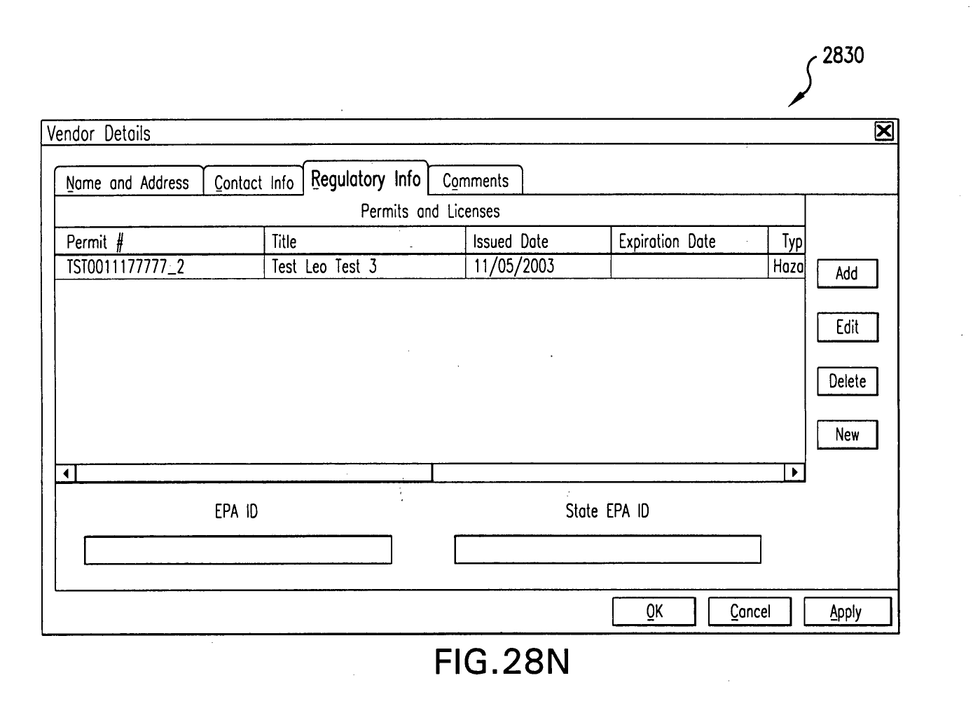

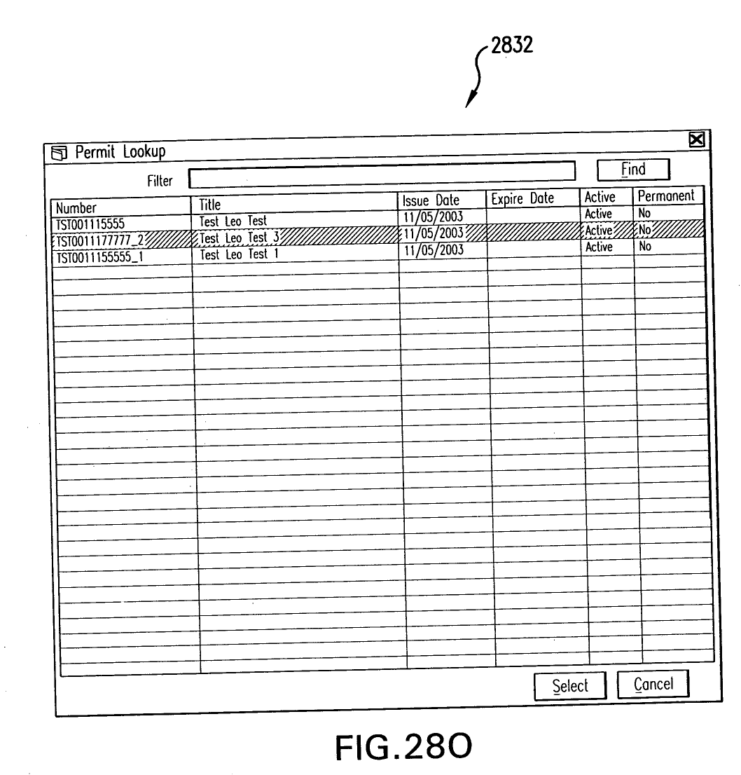

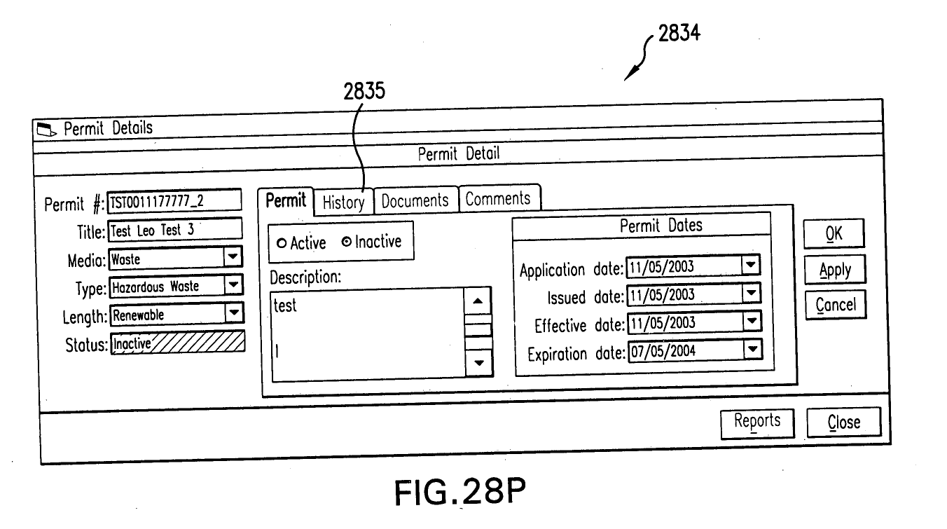

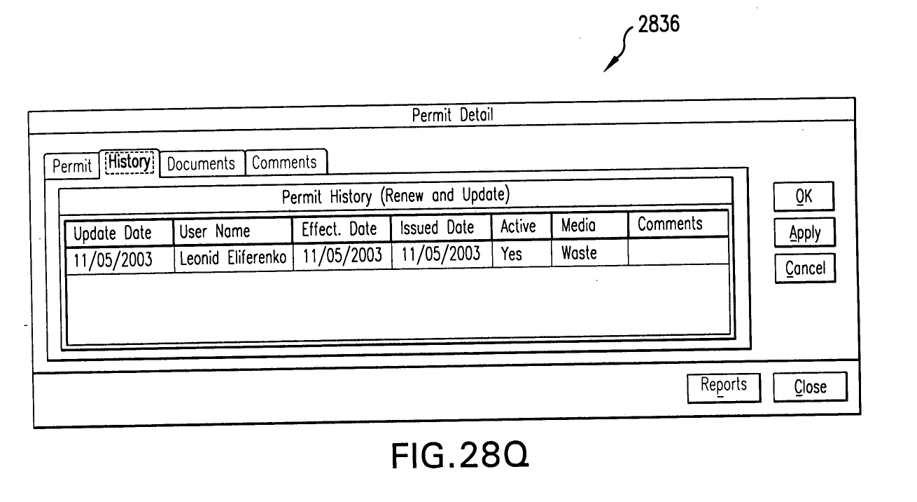

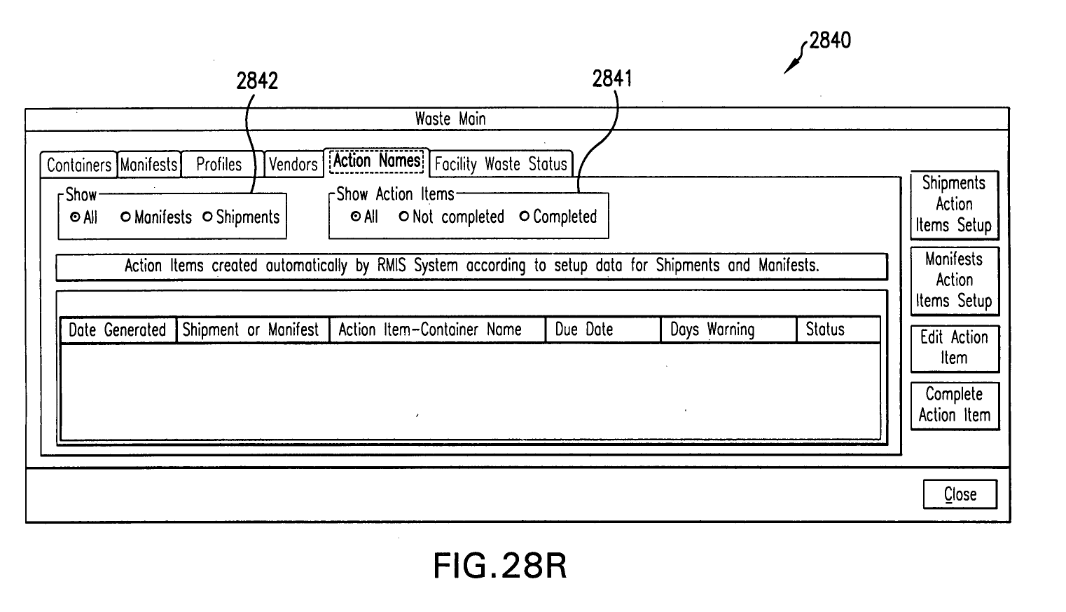

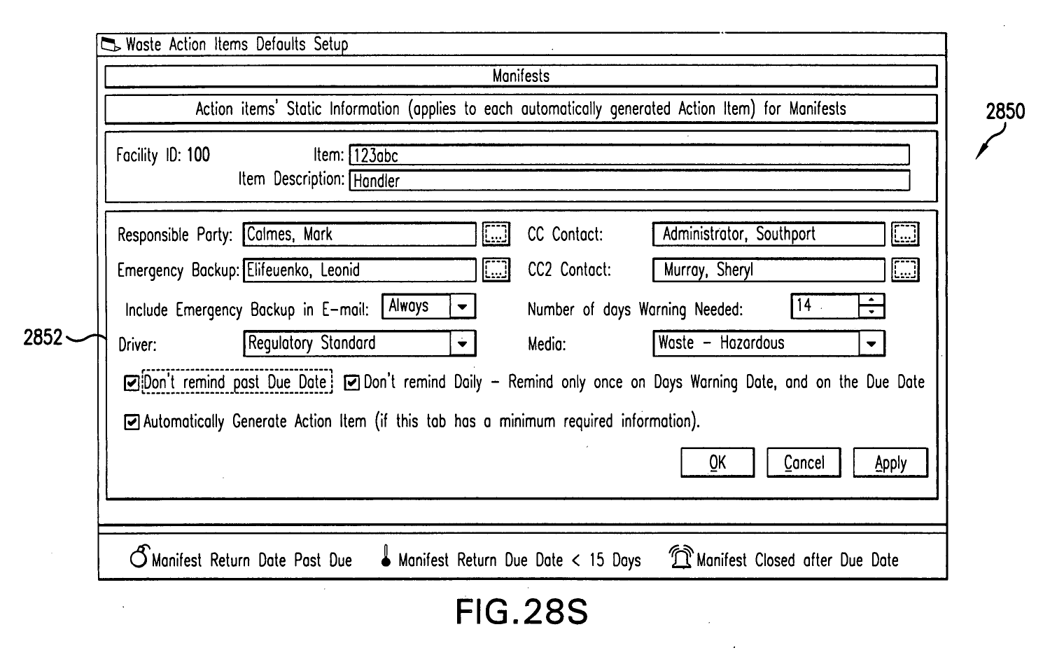

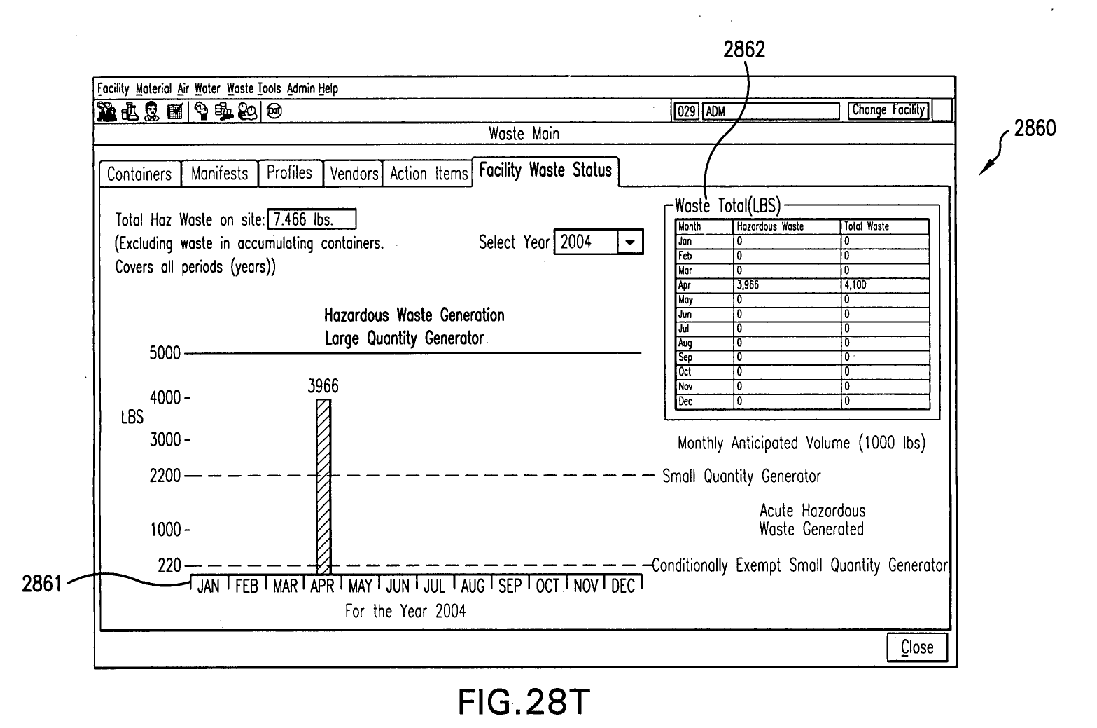

The first tab, Characteristic Hazardous Waste Determinations is also shown in FIG. 27T. This tab has a section 2793 containing four sub-tabs; they are Ignitability, Corrosivity, Reactivity, and Toxic tabs. The Toxic sub-tab is also shown in FIG. 27T. The Toxic sub-tab includes a constituent list that lists the waste number, constituent, regulated level, estimated level, basis of determination, CAS (chemical abstract service) number, and actual data by mg/L. This list allows the user to determine whether the waste contains the constituent listed. Upon determination, the user may indicate whether any of the listed constituent is present by selecting either the yes or no radio button located in the Toxic sub-tab. The Toxic sub-tab also allows the user to update, add, or remove item in the constituent list by selecting the corresponding Update Data, Add D Code, and Remove D Code buttons. Updating can be done by selecting the desired constituent and then make the proper changes to the textboxes provided in the updating section of the Toxic sub-tab. All screens related to the Waste Main screen 2700 will be described in further details below with reference to FIG. 28A-FIG. 28T.

When the user selects the Add D Code button, the Waste Toxic Codes Lookup screen 2801, as shown in FIG. 28A, is displayed. The Waste Toxic Codes Lookup screen 2801 allows the user to easily look up existing toxic codes or query the code by D code, CAS number, or description.

The Ignitability sub-tab 2802 of the Characteristics Hazardous Waste Determinations tab is shown in FIG. 28B. The Ignitability sub-tab 2802 allows the user to enter data regarding the ignitability of the waste.

The Corrosivity sub-tab 2804 of the Characteristics Hazardous Waste Determinations tab is shown in FIG. 28C. This sub-tab allows the user to enter data regarding the corrosive nature of the waste such as pH value.

The Reactivity sub-tab 2806 of the Characteristics Hazardous Waste Determinations tab is shown in FIG. 28D. The Reactivity sub-tab 2806 requires the user to specify whether or not the material is the following: stable; reactive with water; form potentially explosive mixtures when with mixed water; generate toxic gas when mixed with water; contain cyanide, sulfide, or other toxic gases, or vapor in sufficient quantity to be dangerous for human or environment, etc.

The second tab of the Waste Determination screen 2790 is the Listed Hazardous Waste Determination tab 2806 shown in FIG. 28E. The Listed Hazardous Waste Determination tab 2806 includes a tab section 2811 with three sub-tabs. Tab section 2811 includes State and Local, Specific Hazardous Waste Determination, and Non-Specific Hazardous Waste Determination sub-tabs. The State and Local sub-tab is also shown in FIG. 28E. The State and Local sub-tab allows the user to enter information regarding state and local rules that may govern the disposal of hazardous waste.

The Specific Hazardous Waste Determination sub-tab 2812 is shown in FIG. 28F. The Specific Hazardous Waste Determination sub-tab 2812 includes a P code listing 2814 and a U Code listing 2816. In addition, the Specific Hazardous Waste Determination sub-tab 2812 requires the user to enter the K code if there is any. (P, U, and K are waste classification codes defined in Title 40 of the Code of Federal Regulations section 261.) The P code listing 2814 lists the P code, CAS number, and description. The U code listing 2816 lists the U code, CAS number, and description. Both the P and U codes can be added or removed by the selecting the corresponding add or remove button. For example, the P code may be looked up by selecting the Add P Code button. Once the Add P Code button is selected, the P Code Lookup screen 2815, as shown in FIG. 28G, is displayed. A similar screen exists for the U code.

The Non-Specific Hazardous Waste Determination sub-tab 2816 is shown in FIG. 28H. This sub-tab allows the user to enter non-specific hazardous waste determination data.

The third tab of the Waste Determination screen 2790 is the Land Disposal Restrictions tab 2820, as shown in FIG. 281. This tab allows the user to view or add any land disposal restrictions information. The user may also add, delete, or open any documents that are relevant to the waste being disposed by selecting on the corresponding Add, Del, and Open buttons provided in the Land Disposal Restrictions tab 2820.

From the Waste Main screen 2700, the user may access the Vendors screen 2822, as shown in FIG. 28J, by selecting the Vendors tab. The Vendors screen 2822 provides a listing of vendors and related information such as company name, vendor type, address, and phone number. In addition, The Vendors screen 2822 also includes New, Edit, and Delete buttons for adding, editing, and deleting vendors.

When the user selects the New button, the Vendor Details screen 2824, as shown in FIG. 28K, is displayed. The Vendor Details screen 2824 also includes a tab section 2825 containing Name and Address, Contact Info, Regulatory Info, and Comments tabs. The Name and Address tab allows the user to view or edit data such as name, address, and vendor type.

The Contact Info tab 2826, as shown in FIG. 28L, allows the user to enter contact related data such as phone, fax, and email. The user is also allowed to add, edit, and delete new contact persons by selecting on the corresponding Add, Edit, and Delete buttons. When the user selects the New button from the Contact Info tab 2826, the Contact Details screen 2828, as shown in FIG. 28M, is displayed, allowing the user to input detailed information on new contacts.

The Regulatory Info tab 2830, as shown in FIG. 28N, includes a list of permits and licenses. The list includes data categories such as permit number, title, issued date, expiration date, and type. The Regulatory Info tab 2830 also allows the user to add, edit, or delete permits information by selecting the corresponding Add, Edit, or Delete buttons. When the user selects the Add button, Permit Lookup screen 2832, as shown in FIG. 28O, is displayed. This screen facilitates the permit entering and searching process by providing a list of permits for the user to select. If the desired permit information does not exist, the user may create new permit information by selecting the New button located in the Regulatory Info tab 2830. This will display the Permit Details screen 2834.

The Permit Details screen 2834, as shown in FIG. 28P, allows the user to enter detailed permit information. The Permit Details screen 2834 includes a tab section 2835. Tab section 2835 contains Permit, History, Documents, and Comments tabs. The History tab 2836, as shown in FIG. 28Q, contains the permit history which the user may view, add, or edit if desired.

From the Waste Main screen 2700, the user may access the Action Items screen 2840, as shown in FIG. 28R, by selecting the Action Items tab. The Action Items screen 2840 includes a listing option 2842, a show action items option 2841, and an action items list. The listing option 2842 allows the user to list only manifests data, shipments data, or all available data. The show action items option 2841 allows the user to show all items or to limit the list to completed items or uncompleted items. In addition, Action Items screen 2840 includes Shipments Action Items Setup, Manifests Action Items Setup, Edit Action Item, and Complete Action Item buttons. Activating the Shipments Action Items Setup button will direct the user to the Shipments screen 2720. Activating the Manifests Action Items Setup will direct the user to the Manifests screen 2850, as shown in FIG. 28S. The Manifests screen 2850 includes an information section 2852 that is similar to the second information section 2724 of the Shipments screen 2720.

The Facility Waste Status screen 2860, as shown in FIG. 28T, can be accessed from the Waste Main screen 2700 by selecting the Facility Waste Status tab. The Facility Waste Status screen 2860 includes a waste total chart 2861, a waste total list 2862, and the total hazardous waste weight on site readout textbox. The data in the waste total chart 2861 and waste total list 2862 can be limited to a particular year by selecting the desired year in the year selection combo box. The waste total list 2862 lists the waste by month, hazardous waste weight, and total waste weight.

Contact

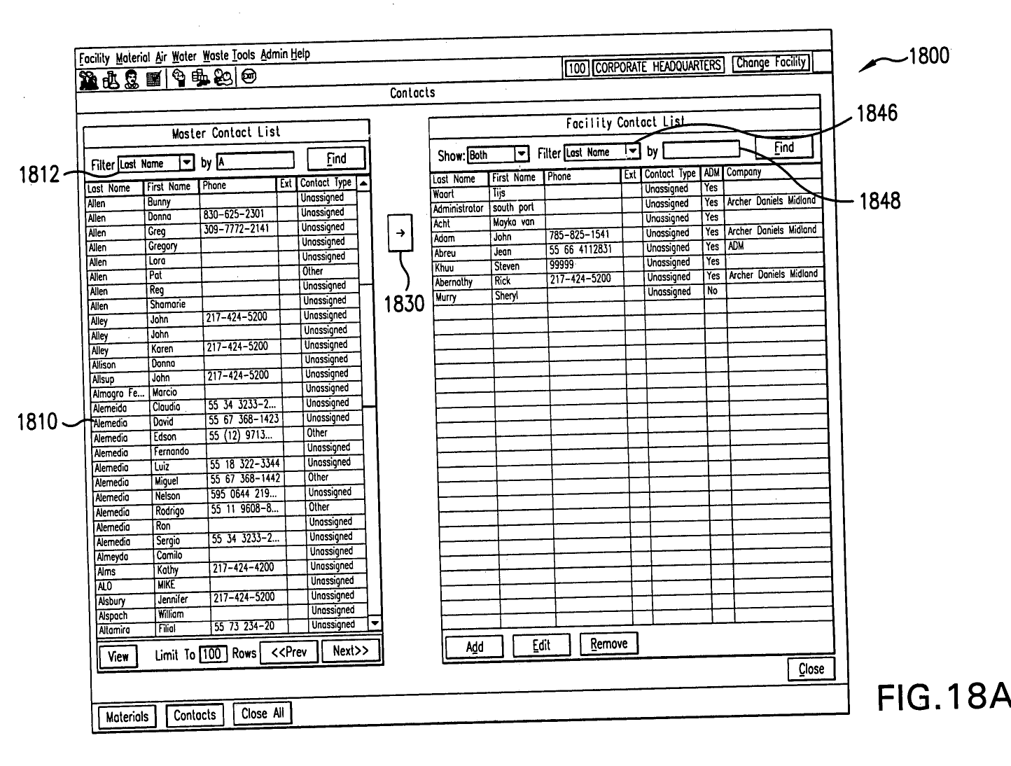

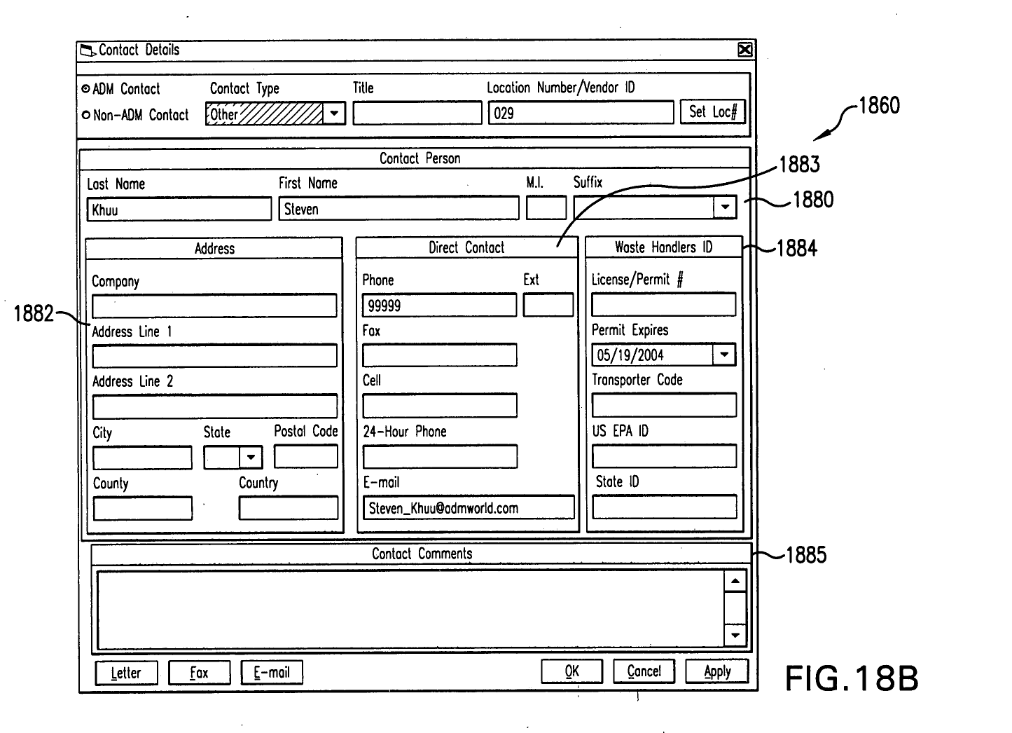

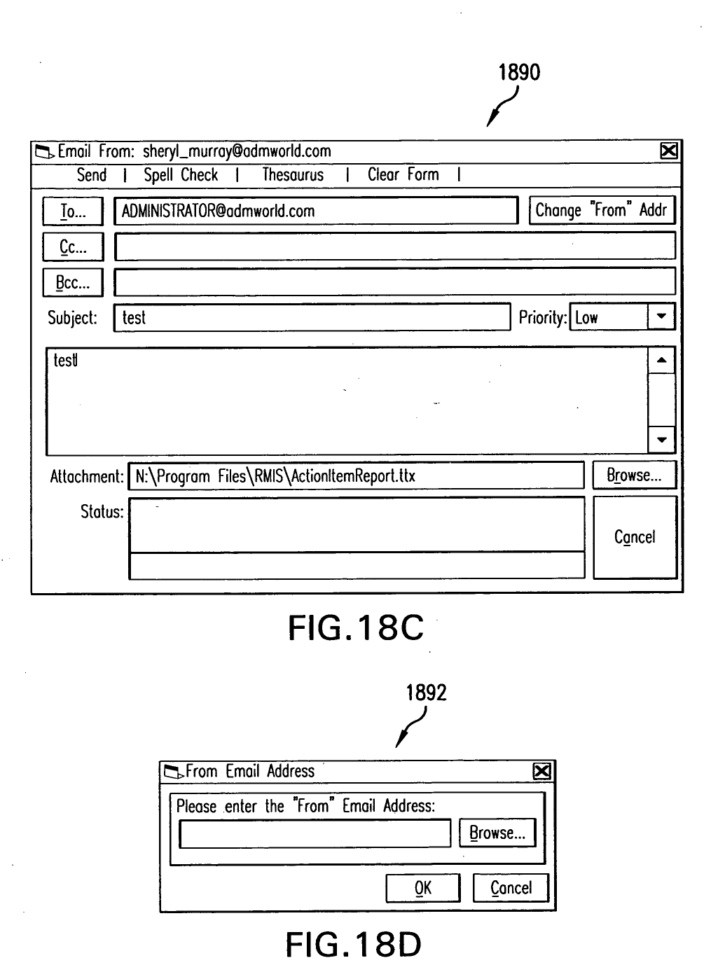

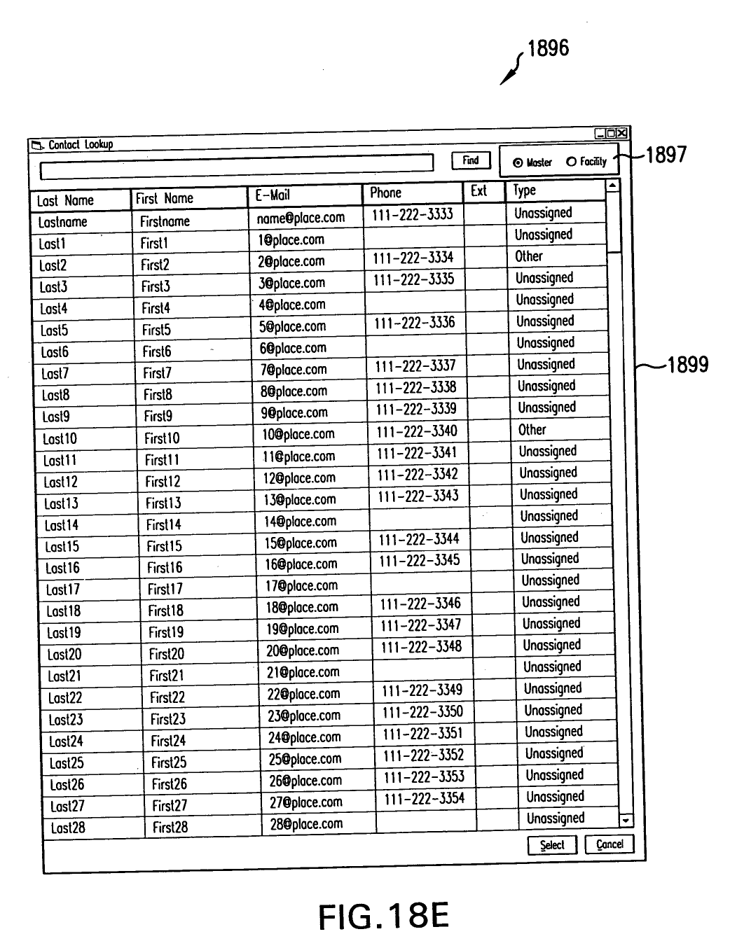

The user can access the Contacts screen 1800 shown in FIG. 18A from the main screen 1000. The Contacts screen 1800 allows the user to manage facility contacts. The Contacts screen 1800 includes a Master Contact List 1810 and a Facility Contact List 1840. The Master Contact List 1810 can only be viewed and not edited by the user. The Master Contact List includes the last name, first name, phone number, extension, and contact type for each listed contact. When the Contacts screen 1800 is first displayed, the Master Contact List 1810 contains all RMIS application contacts. The user can filter the list by selecting a category from the Filter menu 1812. Possible filter categories include Last Name, First Name, and Contact Type. The user can then type information pertaining to the selected filter category in the Filter text box 1814. When the Find button is activated, the RMIS system performs the defined filter and displays the result in the Master Contact List 1810. When the user highlights a contact from the Master Contact List and activates the View button, the user proceeds to the Contact Details screen 1860 described below.

The Facility Contact List 1840 includes the Last Name, First Name, Phone Number, Extension, Contact Type, Internal Indicator, and Company for each listed contact. For an entry, the company field may be empty when the Internal indicator is set to Yes. The Show menu allows the user to limit the contacts displayed in the Facility Contact List 1840 to Internal contacts, Non-Internal contacts, or Both. For example, when Internal contacts is selected, only Internal contacts are displayed in the Facility Contact List 1840. The Master Contact List 1810 displays only Internal contacts. A user can further filter the displayed contacts by selecting a category from the Filter menu 1846 and typing information pertaining to that category in the Filter text box 1848. Possible filter categories include Last Name, First Name, Contact Type, and Company. When the Find button is activated, the RMIS system performs the defined filter and displays the result in the Facility Contact List 1840.

Additional information about a contact in the Master Contact List and Facility Contact List could be displayed depending on the requirements of the RMIS user community. A contact from the Master Contact List 1810 can be copied to the Facility Contact List 1840 by highlighting the contact in the Master Contact List and activating the copy button 1830.

The user can edit contacts listed in the Facility Contact List by activating the Edit button. The user can also add a new contact to the Facility Contact List 1840 by activating the Add button. A contact is removed by highlighting the contact on the Facility Contact List 1840 and activating the Remove button. When the user selects either the Edit or the Add button, the user proceeds to the Contact Details screen 1860.

The Contact Details screen 1860 is illustrated in FIG. 18B. The Contact Details screen displays details associated with a contact selected on the Contact screen 1800. If the contact was selected from the Master Contact List 1810, the contact details can only be viewed and cannot be edited by the user. The Internal Contact and Non-Internal Contact radial buttons indicate whether the contact is an Internal contact or a Non-Internal contact. The Contact Description section also includes a Contact Type menu, a Title text box, a Location Number/Vendor ID text box, and a Set Location Number button. When the user selects the Set Location Number button, information related to the facility name, address and division for the contact person is displayed.

The Contact Details screen 1860 includes a Contact Person section 1880. The Contact Person section 1880 contains Last Name, First Name, Middle Initial, and Suffix text boxes. The address section 1882 includes text boxes for address information related to the contact. The direct contact section 1883 has text boxes for displaying various methods for contacting the person such as business phone number, fax number, cell phone number, 24 hour contact phone number, and e-mail address. The Waste Handlers ID section 1884 contains text boxes for necessary license and permit numbers, transport codes, EPA identifications, and state identifications for the contact. The Contact Comments box 1885 displays additional comments/information about the contact person.

When the user selects the Letter button on the Contact Details screen 1860, the user proceeds to a screen containing the template for composing a letter to the contact person. When the user selects the Fax button, the user proceeds to a screen containing a template for composing a fax coversheet to the contact person. RMIS 130 may populate certain portions of the letter and fax coversheet automatically based on the information stored for the contact and user.

When the user selects the E-mail button, the user proceeds to a screen for composing an e-mail message. An illustrative example of an e-mail screen is shown in FIG. 18C. Other alternatives for composing e-mail could be used with RMIS 130 as would be apparent to a person skilled in the art. The example e-mail screen 1890 contains standard text boxes, buttons, and features associated with e-mail applications. When a user sends e-mail the first time, the From Email Address screen 1892, show in FIG. 18D, is displayed prompting the user to enter the user's e-mail address. This screen will not appear again unless the user activates the Change From Address button on the e-mail screen 1890.

The Contact Lookup screen 1896, shown in FIG. 18E, can be accessed by activating the Browse button on the From Email Address screen 1892 or by activating the To, CC, or Bcc buttons on the e-mail screen 1890. The search section 1897 includes a Master radial button for selecting a contact from the Master Contact List, a Facility radial button for selecting a contact from the Facility Contact List, a text box for entering a search string, and a Find button for activating the search. The results of the search are displayed in the contact list section 1899. Each entry contains a last name, first name, e-mail address, phone number, extension, and contact type field. The user can then highlight one or more contacts from the list and activate the Select button to copy the e-mail address into the To, CC, Bcc, or From text boxes.

Permits

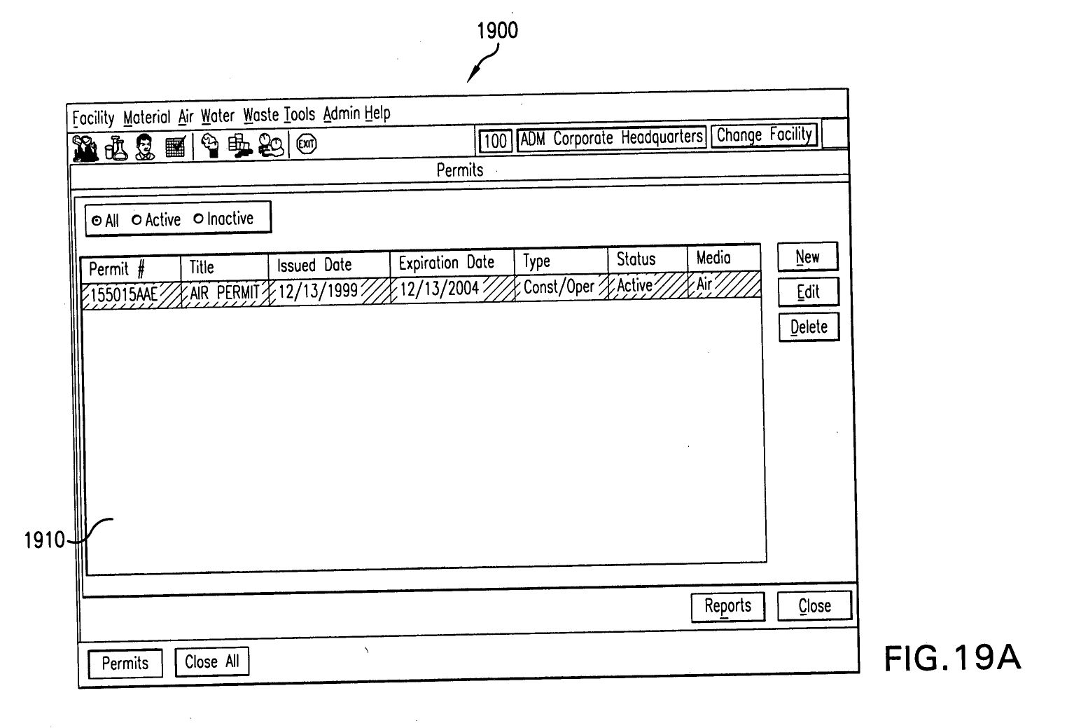

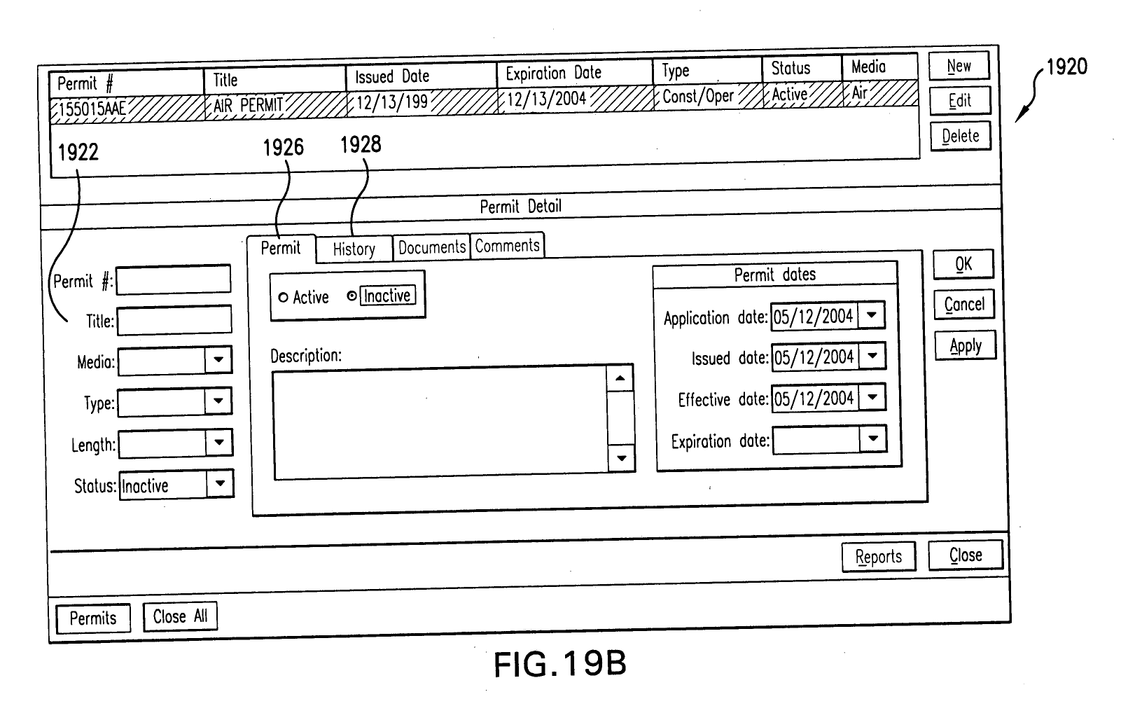

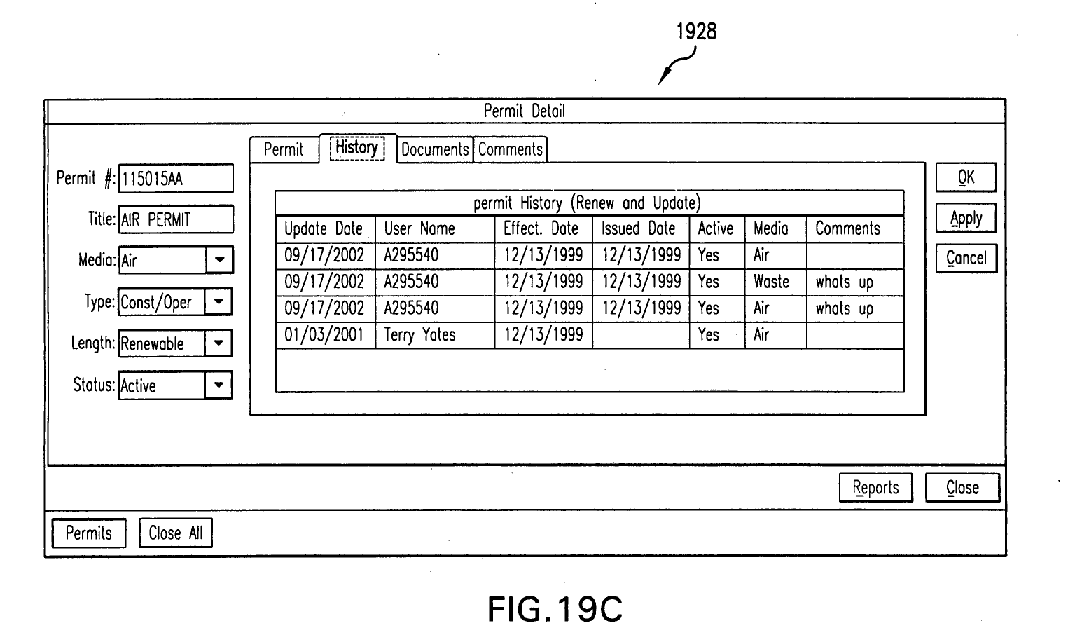

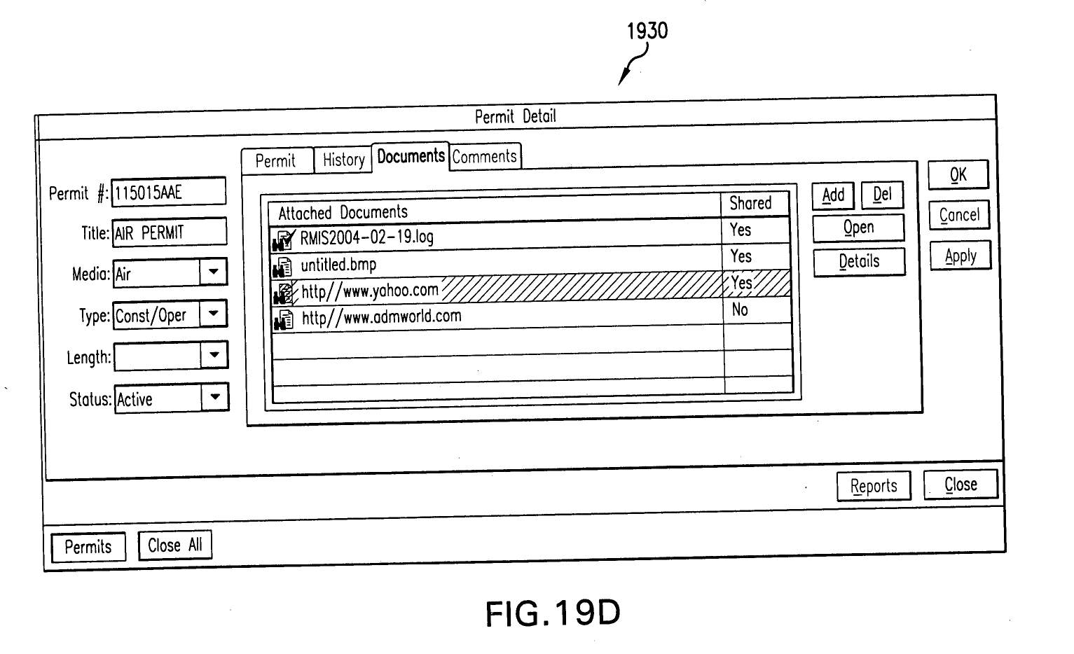

The user can access the Permits screen 1900 shown in FIG. 19A from the main screen. The Permits screen 1900 allows the user to manage facility permits. The Permit List 1910 includes the permit number, title, issued date, expiration date, type, status, and media for each entry. The user can edit permits listed in the Permit list by activating the Edit button. The user can also add a new permit by activating the New button. A permit is removed by highlighting the permit on the Permit list 1910 and activating the Delete button. When the user selects either the Edit or the New button, the user proceeds to the Permits Detail screen 1920.

The Permits Detail screen 1920 is illustrated in FIG. 19B. The Permits Detail screen displays details of a permit selected on the Permits screen 1900. The Permits Detail screen 1920 includes an information section 1922 and four tabs. The permit information section includes Permit Number, Title for the Permit, Media, Type, length and Status fields. The permit number and title are assigned by the user. The Media, Length, and Type fields are populated through a dropdown menu.

The Permit tab 1926 includes status radio buttons, a Description text box, and a permit dates section. The status radio buttons may allow the user to indicate whether the permit is active or inactive and/or whether the permit is renewable or permanent. The permit date section lists the application date, issued date, effective date, and expiration date of the permit. The Permit History tab 1928, shown in FIG. 19C, lists the update date, update person, effective date, issue date, permanent status, media and any comments associated with each permit history entry. The Permit Documents tab 1930, as shown in FIG. 19D, lists properties of documents related to a particular permit.

Incidents

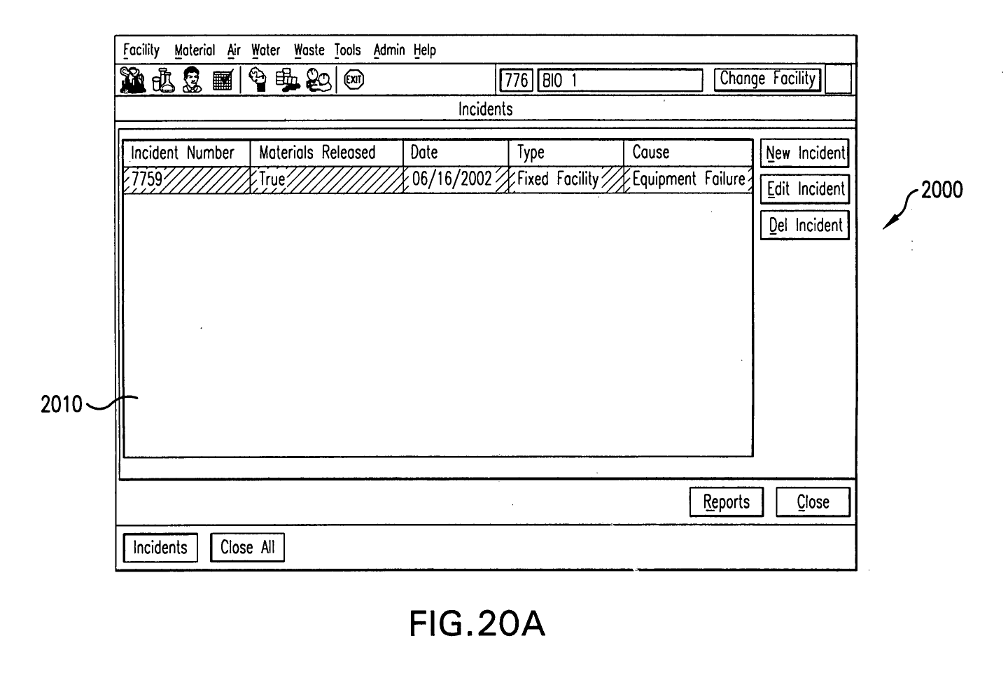

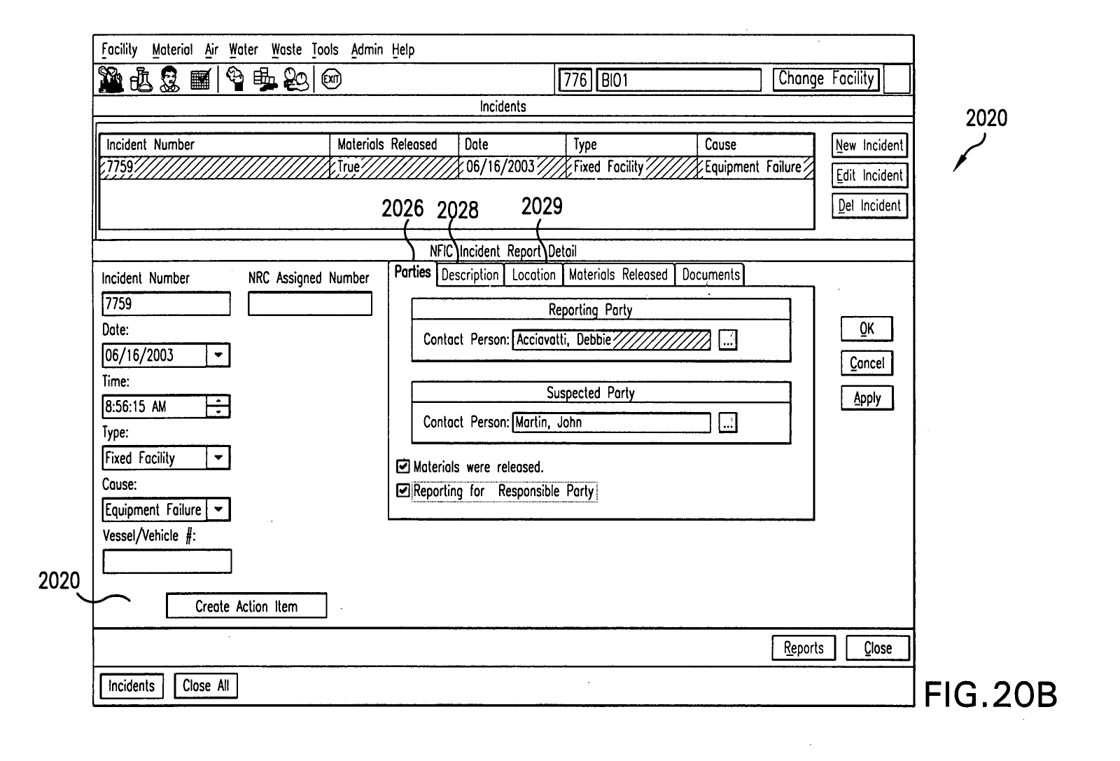

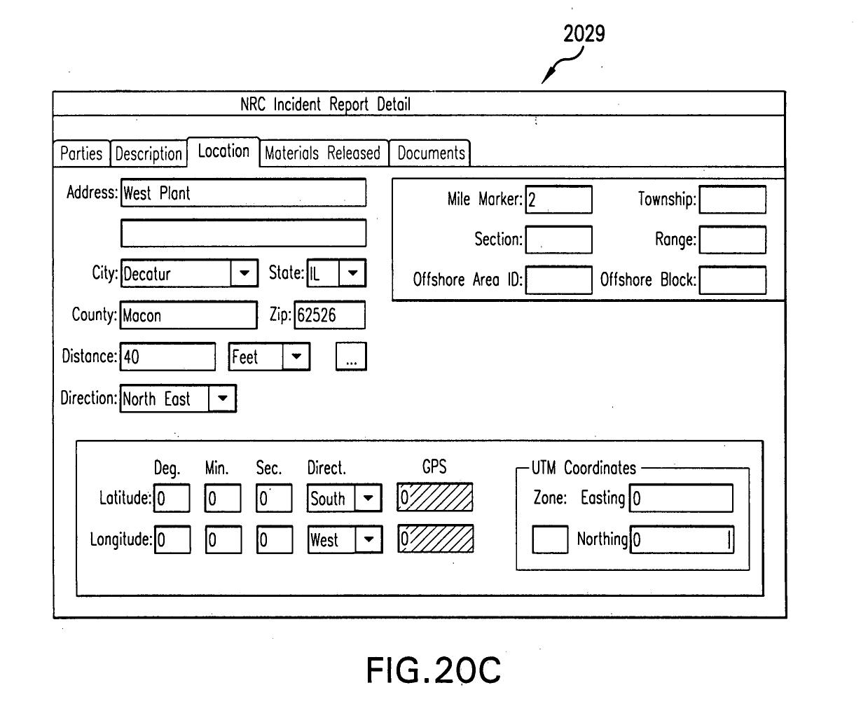

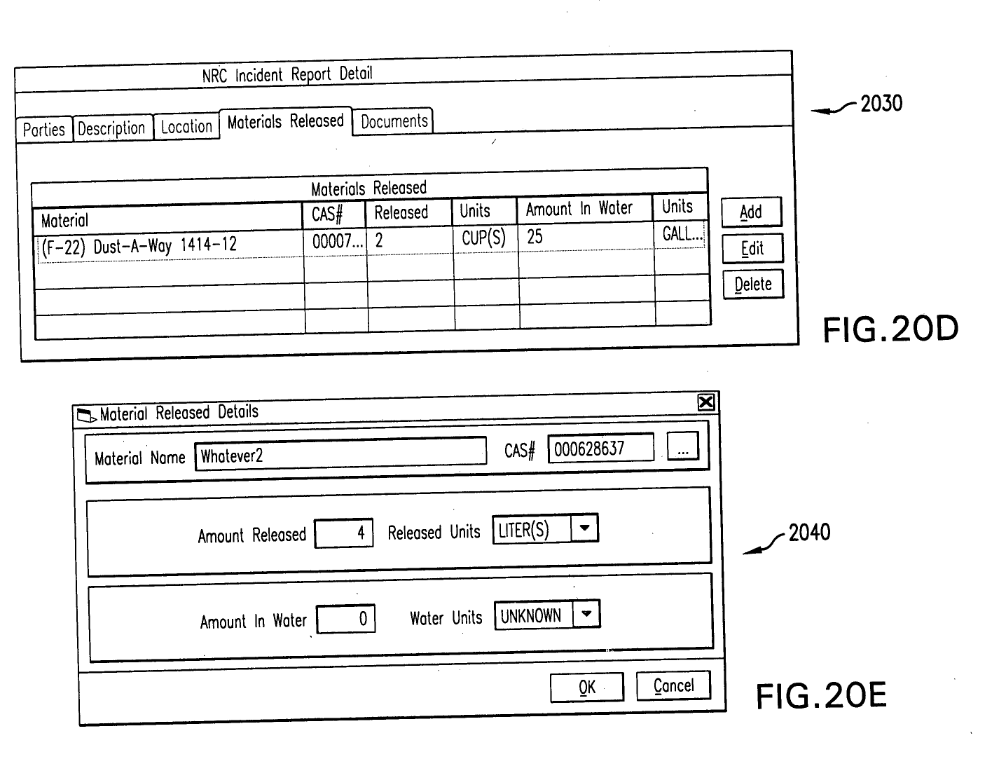

The user can access the Incidents screen 2000 shown in FIG. 20A from the main screen 1000. The Incidents screen 2000 allows the user to manage facility incidents. The Incident list 2010 includes the incident number, materials released, date, type, and cause for each listed incident. The user can edit incidents listed in the Incidents list by activating the Edit Incident button. The user can also add a new incident by activating the New Incident button. An incident is removed by highlighting the incident on the Incident list 2010 and activating the Del Incident button. When the user selects either the Edit or the Add button, the user proceeds to the Incident Detail screen 2020.

The Incident Detail screen 2020 is illustrated in FIG. 20B. The Incident Detail screen may be presented as a standalone screen or as a frame within the Incidents screen 2000. The Incident Detail screen displays details of an incident selected on the Incident screen 2000. The Incident Detail screen 2020 includes an information section 2022 and five tabs. The incident information section includes Incident Number, Date, Time, Type, Cause, Vessel/Vehicle Number and NRC Assigned Number fields. The Incident Number field is inaccessible to the user if the incident is being edited.

On the Parties tab 2026, the person assigned as the reporting party is displayed in the Reporting Party text box. The person assigned as the suspected party is displayed in the Suspected Party text box. The user can search from a contact list for each of these text boxes by activating the lookup button to the right of the text box. The Materials Were Released checkbox, if checked, shows that materials have been released. The materials released status is also displayed as an item in the Incident list 2010 for each listed incident. The Reporting for Responsible Party checkbox, if checked, indicates that the reporting party should be contacted.

The Description tab 2028 allows a user to add or update the description for the incident including details on the source and/or cause of the incident. The Location tab 2029, shown in FIG. 20C, allows the user to indicate the Location of the incident. The Location tab contains physical information related to the incident such as the address, distance, direction, longitude and latitude, and USGS coordinates. Distance and Direction data fields are populated based on the distance and direction from the facility. RMIS 130 calculates the GPS coordinates as follows:
For N: −Latitude Deg+(Latitude Mins/60)+(Latitude Sec/3600)
For S: Latitude Deg+(Latitude Mins/60)+(Latitude Sec/3600)
For E: Longitude Deg+(Longitude Mins/60)+(Longitude Sec/3600)
For W: −Longitude Deg+(Longitude Mins/60)+(Longitude Sec/3600)

The GPS coordinates are then populated by RMIS 130 into the GPS text boxes. The Location tab also includes Mile Marker, Township, Section, Range, Offshore Area ID, and Offshore Block fields.

The Released Material tab 2030, illustrated in FIG. 20D, shows released materials assigned to the incident. The tab contains a Materials list including the material, CAS number, released, released units, amount in water, and water units for each entry. The user can edit released materials listed by activating the Edit button. The user can also add a new released material by activating the Add button. A released material is removed by highlighting the material and activating the Delete button. When the user selects either the Edit button or the Add button, the user proceeds to the Material Released Details screen 2040.

The Material Released Details screen 2040 is illustrated in FIG. 20E. The screen includes Material Name, CAS Number, Amount Released, Released Units, Amount In Water, and Water Unit text boxes. The lookup button can be used to search for the material name and CAS number.

Agency Visits

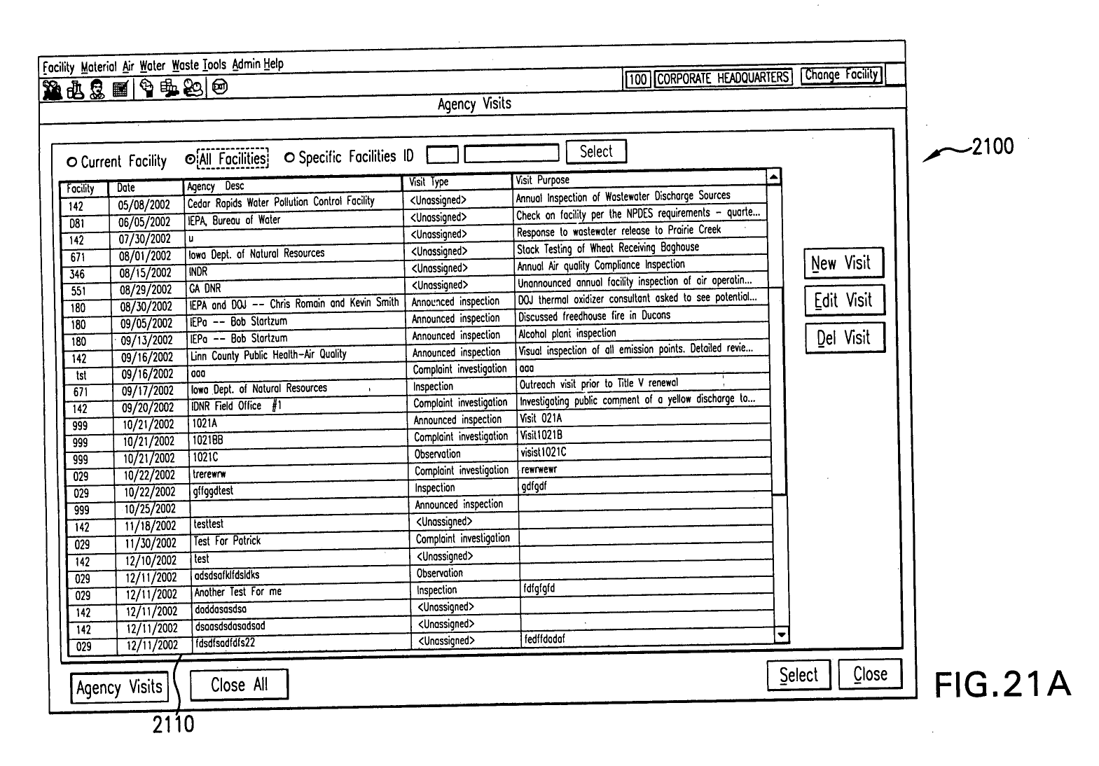

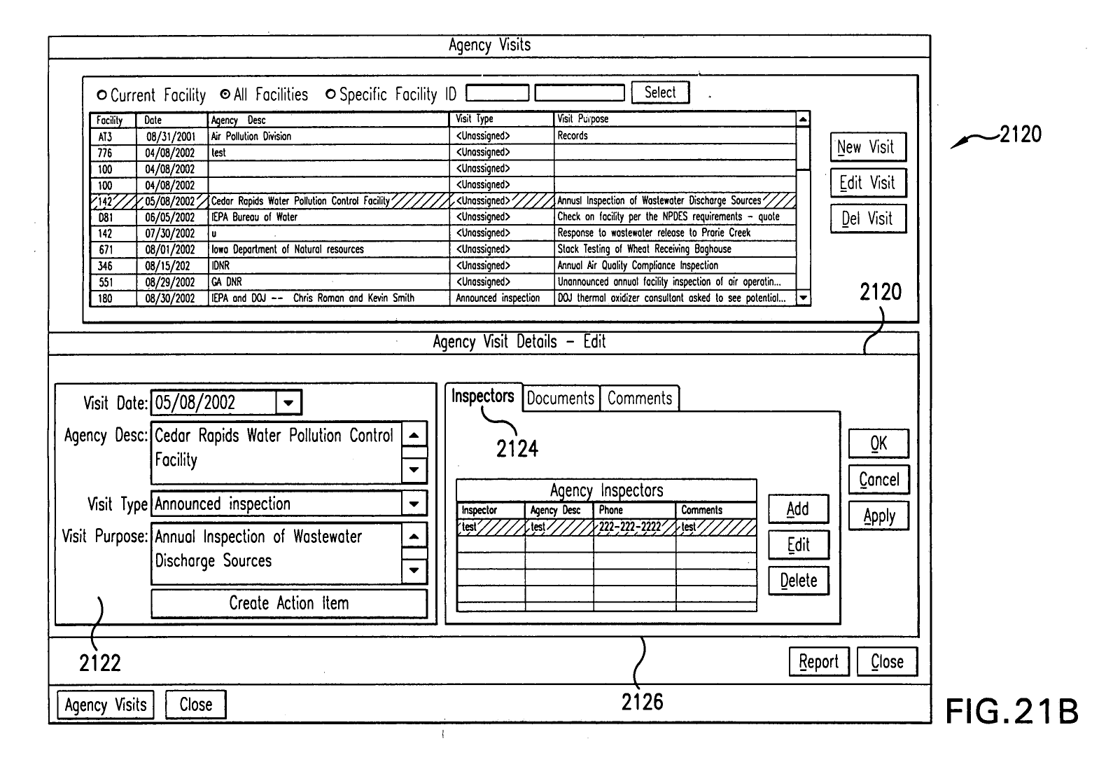

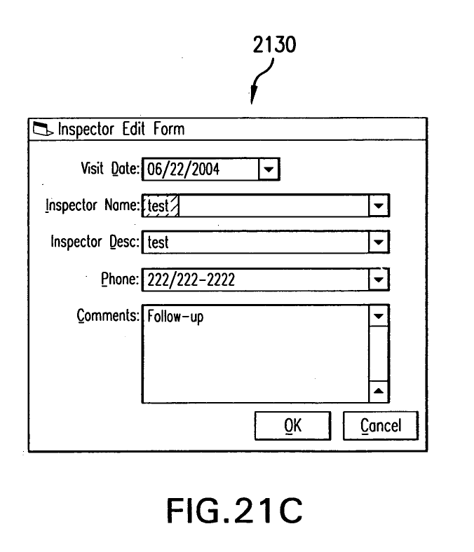

The user can access the Agency Visits screen 2100 shown in FIG. 21A from the main screen 1000. The Agency Visits screen 2100 allows the user to manage facility agency visits. The Agency Visit list 2110 includes the facility, date, agency description, visit type, and visit purpose for each listed visit. The user can a listed agency visit by activating the Edit Visit button. The user can also add a new agency visit by activating the New Visit button. An agency is removed by highlighting the agency visit on the list 2110 and activating the Delete Visit button. When the user selects either the Edit button or the Add button, the user proceeds to the Agency Visit Details screen 2120.

The Agency Visit Details screen 2120 is illustrated in FIG. 21B. The screen can be a standalone screen or a frame within the Agency Visits screen 2100. The Agency Visit Details screen 2120 includes an information section 2122 and a section with three tabs 2126. The information section includes Visit Date, Agency Description, Visit Type and Visit Purpose data fields. The Inspectors tab 2124 includes a list of agency inspectors. Each entry in the list contains the inspector's name, agency description, phone number, and comments. The user can add, edit or delete entries in the list. When the user activates either the Add or Edit button, the Inspector Edit Form screen 2130 is displayed (FIG. 21C). This screen displays Visit Date, Inspector Name, Agency Description, Phone Number, and Comments text boxes.

Printing

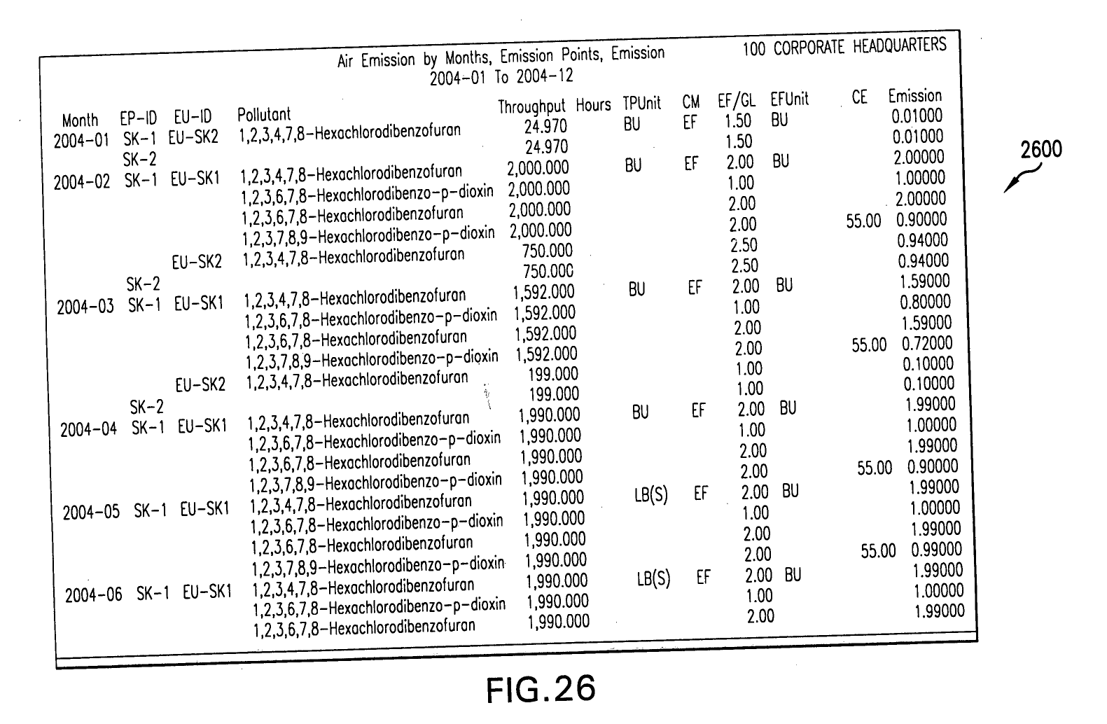

RMIS 130 uses standard printing conventions for printing RMIS reports or using the Print Screen feature. When a Report button is presented to the user, the user can activate the Report button to obtain a printout of the report. When the report button is activated, the report screen associated with the selected RMIS functionality screen will be displayed. From this screen, the user selects a printer from a menu. Alternatively, the user can opt to save the report or the screen as a file such as a MICROSOFT WINDOWS document. FIG. 26 shows an example of an Air Emission report 2600 that includes reporting variables such as month, EP-ID, EU-ID, pollutant, throughput, hours, TP unit, CM, EF/GL, EF unit, CE, and emission.

While specific embodiments of the present invention have been described above, it should be understood that they have been presented by way of example only, and not limitation. For instance, the screens provided above including the data, data fields, and functionality associated therewith, are illustrative and not intended to limit the present invention. Other types of user-interface inputs and outputs can be provided for display or control in RMIS 130 as would be apparent to a person skilled in the art given this description. In addition, RMIS 130 can be used with other types of data depending upon a particular facility or regulatory application including but not limited to federal and state regulations, or facility guidelines in the United States or any other country or region. It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined only in accordance with the following claims and their equivalents.

1. A regulatory information management system coupled between a client and a database that stores facility data including permit data relating to a facility, comprising:
a facilities compliance manager that communicates with the client, wherein said facility compliance manager enables a main screen to be displayed at the client, said main screen allowing a user to manage facility data; and
a permit manager that enables a user to configure permit data parameters and input permit data for storage in the database according to said configured permit data parameters, wherein said permit manager monitors permit events based on stored permit data for a facility in the database, and generates permit event notifications relating to compliance with federal and state regulations.

2. The system of claim 1, further comprising a message generator that sends messages identifying the generated permit event notifications.

3. The system of claim 2, wherein said messages comprise electronic mail messages, and said message generator distributes said electronic mail messages to different individuals depending upon the particular permit event notification.

4. The system of claim 3, wherein the permit event notifications include notifications of when a permit is due, past due and overdue, and wherein said message generator sends a first electronic mail message to a primary individual when the permit is due, a second electronic mail message to the primary individual and a back up individual when the permit is past due, and a third electronic mail message to the primary and back up individuals and a manager when the permit is over due.

5. The system of claim 3, wherein the permit event notifications include notifications of when a facility has emissions outside of an acceptable range.

6. The system of claim 1, wherein said permit manager enables a user to configure permit data parameters including setting limits for different types of permits at a facility including at least one of an air permit, a water permit and a waste permit.

7. The system of claim 6, wherein said permit manager provides a set of local templates to the user associated with a location of a facility to facilitate compliance with federal and state regulations governing the facility.

8. The system of claim 1, wherein the main screen includes control tabs for accessing Facility, Materials, Air, Waste, and Water management screens.

9. The system of claim 8, wherein the Air management screen includes at least one equipment inventory control panel for managing equipment inventory and potential (What If) equipment inventory.

10. The system of claim 8, wherein the Air management screen includes at least one air control panel for managing compliance with federal and state regulations pertaining to air.

11. The system of claim 10, wherein said at least one air control panel comprises a set of panels for managing for different pieces of equipment the following: air loss configuration data, air loss calculations, configuration history and what-if (WIF) scenarios.

12. The system of claim 10, further comprising a formula calculator that calculates air loss according to formulas based on user inputs at one or more air loss calculation control panels.

13. The system of claim 12, wherein the user can select standard or customized formulas.

14. The system of claim 12, wherein said one or more air loss calculation control panels includes a first control panel for setting up a calculation period, applying rounding, calculating totals by pollutant;
a second control panel for displaying totals by pollutant; and
a third control panel for displaying air emissions data including EU-ID, Month, Pollutant Name, Throughput, Calculation Method, EF, CE and Emission data.

15. The system of claim 14, further comprising an Air Throughputs control panel for enabling user to select to show actual, PTE or WIF throughputs, and to set a calculation period.

16. The system of claim 15, wherein said Air Throughputs control panel displays air throughput data including Month, Material name, Group Description, Start Inventory, End Inventory, Throughput, Mode, Ash, Sulfur, HV and Units data.

17. The system of claim 8, wherein the Air management screen enables a user to access the following control panels:
an Emission Point Edit panel;
a Monitoring Equipment Edit panel;
a Control Equipment Edit panel; and
an Emission Unit Edit panel.

18. The system of claim 2, further comprising
a process historian and lab information manager that manages data captured by at least one distributed control system at a facility and forwards the captured data to the database.

19. The system of claim 18, wherein said permit manager further generates process event notifications based on monitored process events.

20. The system of claim 1, further comprising:
a regulatory form generator that provides a set of templates associated with regulatory forms, and in response to a user selection for a completed regulatory form for a facility, queries appropriate facility data based on a template, and builds a document representing the completed regulatory form.

21. The system of claim 1, further comprising:
an environmental tool integrator that enables a user to navigate between facility data in the database and data in external regulatory databases.

22. The system of claim 21, wherein said external regulatory databases include different environmental reporter databases.

23. The system of claim 8, wherein the Waste management screen enables a user to access the following control panels:
a New Container panel;
a Manifests panel;
a Profiles panel;
a Vendors panel,
a Action Items panel, and
a Facility Waste Status panel.

24. The system of claim 8, wherein the Waste management screen includes at least one waste control panel for managing compliance with federal and state regulations pertaining to waste.

25. The system of claim 8, wherein the Waste management screen includes at least one container inventory control panel for managing container inventory.

26. The system of claim 8, wherein the Waste management screen includes at least one waste panel for managing restrictions on at least one material.

27. The system of claim 26, wherein the at least one waste panel comprises, for different materials, a set of management panels including:
characteristic hazardous waste determination, listed hazardous waste determination, and land disposal restrictions.

28. The system of claim 8, wherein the Waste management screen includes at least one shipment control panel for managing shipment information for at least one container.
